(19) United States
(12) Patent Application Publication
(10) Pub. No.: US 2012/0192965 A1
(43) Pub. Date: Aug. 2, 2012

(54) WATER SUPPLY SYSTEM WITH RECIRCULATION

(76) Inventors: Shay Popper, Kfar Yona (IL); Arie Litbak, Talmei Menashe (IL); Yaniv Petel, Kfar Yona (IL); Boris Gorelic, Kiryat Ata (IL); Aharon Carmel, Kibbutz Glil-Yam (IL); Ram Friedman, Moshav Ein Eiron (IL); Moshe Katz, Ziharon Yakov (IL); Igor Lulko, Beer Sheva (IL)

(21) Appl. No.: 13/265,881

(22) PCT Filed: Apr. 25, 2010
(86) PCT No.: PCT/IL10/00332

§ 371 Date: Apr. 19, 2012

(30) Foreign Application Priority Data
Apr. 23, 2009 (IL) IL 198341

(51) Int. Cl. E03B 5/02; E03C 1/00

(52) U.S. Cl. 137/357; 137/334

(57) ABSTRACT

A system for supplying hot and cold water to users in a building, the system comprising: a first mode for supplying water to users; a second mode for preparing to supply water at a desired temperature by recycling water from the hot water pipe into the cold pipe; a faucet having a mixing chamber; a hot water inlet; a cold water inlet; an outlet; and a mechanism for adapting the system to various types of users including humans and appliances

### PRIOR APPLICATIONS

The present application claims priority from Israel patent application 198341 filed 23 Apr. 2009, entitled Water Supply System and Method.

### FIELD OF THE INVENTION

The present invention relates to a system and method for supplying hot and cold water for domestic, commercial or industrial use, in particular for saving water and energy.

### BACKGROUND OF THE INVENTION

In a domestic, commercial or industrial environment, there are hot and cold water pipes supplying water to the various users or faucets there. The various users of water supply may include for example washing machines and a multitude of machines that need cold, hot and/or mixed water.

A problem in such systems is the waste of water while waiting for the hot water to arrive at the faucet, depending on the distance from the boiler to each user. Also, if the faucet is temporarily shut, it may take time and some adjustments to regain the water supply at the desired flow rate and temperature. To avoid these issues, people taking a shower often leave the water running for the whole duration, thus wasting water.

A further problem relates to variations in water temperature due to changes in water pressure, use of water by others, depletion of hot water in the water tank, etc. The user has to occasionally adjust the temperature of the water and, in the meantime, water is wasted.

An additional problem is water freezing in the pipes causing blockages and potentially bursting of the pipes. It may be very difficult/or expensive to replace the water piping/installation in the walls. Accordingly, an improvement in the water supply system should preferably not require changes in the existing, installed water pipes in the house or apartment.

Hot water is also used, for example, in washing machines, dish washers and other appliances.

As each user of hot water requests service daily, the system has to respond, and inevitably it may take some time to do so. There may be waste as the system responds separately to each such request from each user. It may be worthwhile for the system to learn users' habits, to adapt to their demands and even to anticipate them. This may result in further savings in energy and water.

The manual controls for faucets may have various disadvantages, for example limited reliability. It may be desirable to use non-contact control of faucets and/or showers in the present invention. Manual controls are slow. At present it takes a relatively long time for hot water to arrive, so user may accept it; however when using the present invention which allows for a fast response in supplying hot water, customers will also demand controls which respond faster allowing to set water parameters faster and more easily.

Popper et al., U.S. Pat. No. 6,895,985, “Smart device and system for improved domestic use and saving of water”, presents a system for providing a user with water at a desired temperature involving circulation of the hot water into the cold water pipe until the water temperature reaches the desired temperature.

An electronic interface may be required between the hot water controller and the various appliances which need could and/or hot water, and at a specific temperature. Preferably, the system's structure should be so devised to be usable with appliances which have their own (local) circulation pump.

It may be desirable for the system to be adaptive, to learn the users' habits, otherwise it may take time to heat water when required on short notice. It may take more time to respond efficiently to separate, unexpected requests for users. An advanced sophisticated system should also include suitable maintenance means, either locally or remote. This may achieve a reliable system with a long time between failures.

### SUMMARY OF THE INVENTION

The invention relates to an improved system for supplying hot water to some or all users in a residential building such as an apartment or house, or a non-residential building.

To prevent waste of water while waiting for hot water to arrive at the faucet, during the waiting period water from the hot water pipe is circulated into the cold water through the faucet. To achieve this effect, the present system uses a combination of three valves: one from each of the hot and cold water inlets, and one at the outlet.

With the inlet valves open and the outlet valve closed, the system performs water circulation. The circulation also requires the activation of a circulation water pump. With the inlet valves open and the outlet valve also open, the system is capable of supplying hot, cold or mixed water to a user. All the valves are controlled electronically; water is circulated until hot water at the desired temperature is available at the faucet. The system responds automatically to users' requests, using a microcontroller or microcomputer to control the operation of all its parts according to a predefined program.

The present disclosure provides several embodiments of the control hardware. The system uses a method for supplying hot water at a desired temperature, while managing micro valves in the faucet, water circulation and/or heating in the water tank/boiler. Automatic water circulation may also be used to prevent water from freezing in the pipes.

The present disclosure presents several embodiments of the control method. Whenever possible, solar water heating is used. In this case, heating is achieved at minimal cost. The water thus heated is used in lieu of heating water in various appliances, to save energy.

In a preferred embodiment, water heating means use solar heating with additional heating means such as fuel and/or electricity, to ensure a reliable supply of hot water at lower cost.

The present invention is described generally with reference to the following particular features:

1. System adapted to various types of users—humans and also appliances such as washing machines, dishwashers and the like. Each type of user has his/her/its different requirements and characteristics. The present system includes the flexibility, adaptability and smart methods of operation to adapt to any and all types of users, and/or multitude thereof.

2. An electronic interface between the hot water controller and various appliances which need cold and/or hot water, and at a specific temperature.

3. A system structure including optional appliances which have their own (local) circulation pump.

4. Method of operation of the systems in (1-3).

Smart, adaptive algorithms learn the topology of the system with the time delays to hot water supply to the various users; the habits of the various users (when they need hot water, how much water, and what temperature and flow rate, etc.) and device smart strategies for water heating and supply.

This while achieving savings in energy and water.

5. Adaptive system and method learns users' habits, to anticipate the need for hot water and act accordingly to heat water in advance.

6. System control for diagnostics and maintenance purposes—to activate each valve, measure its status and performance; to monitor the operation of the system. The system included means for its operation within the smart house environment.

7. Remote control and maintenance. The system control and monitoring may be performed either locally or from a remote location. Wired and/or wireless links may be used.

8. An integrated control unit may include the controller, communication means, the circulation pump and optional valves, optionally temperature sensors, all in one unit which can be installed in close proximity to the water boiler for example.

9. Wireless communications between the system's components to transfer commands, data, information etc. Faucet or water output means with means for generating electrical energy locally, so there is no need to install wiring between the system components.

The above aspects may be combined with the following features:

A. A micro valve including three activated electronically, and easily installable in standard diameter faucets.

B. Human—machine interface, using effective means for allowing the user to control the water temperature and flow rate, as well as various additional parameters.

C. A device for mixing fluids from a plurality of sources. For example, people may desire to use either potable water or sea water, then to mix hot and cold water.

D. Protecting users from scalding due to exposure to hot water—safety standards typically require limiting the temperature of the hot water supply, to protect users from accidental scalding if exposed to hot water only, for example Israeli standard No. 5463 and Australian standard No. 4032.2. The temperature of hot water supply should be limited to a predetermined value, as defined by the relevant standard.

E. Hot/cold water control and programming for future supply using non-contact reliable means, using a dual sensor unit.

Accordingly, the present invention provides a system for supplying hot and cold water to users in a building, the system comprising: a first mode for supplying water to users; a second mode for preparing to supply water at a desired temperature by recycling water from the hot water pipe into the cold pipe; a faucet having a mixing chamber; a hot water inlet; a cold water inlet; an outlet; and a mechanism for adapting the system to various types of users including humans and appliances.

According to some embodiments, the system further includes an adaptive system with means for learning users' habits, to anticipate the need for hot water and act accordingly to heat water in advance and bring hot water to users' faucet while circulation water into the cold water pipe.

According to some embodiments, the system further includes a temperature sensor located in the mixing chamber in the faucet, to measure the temperature of the output water and/or a temperature sensor located at the hot water inlet or two temperature sensors, one located at the hot water inlet and the other at the cold water inlet and/or a temperature sensor in the mixing chamber and/or three temperature sensors, one located at the mixing chamber, one at the hot water inlet and one at the cold water inlet. According to some embodiments, the temperature sensor comprises a solid state semiconductor sensor.

According to some embodiments, the appliance(s) includes a local circulation pump. According to other embodiments, the system further includes three electronically activated valves.

According to some embodiments, the system further includes a hot/cold water controller and programming using non-contact reliable means, using a dual sensor unit; and in some of those embodiments an electronic interface between the hot/cold water controller and various appliances which need cold and/or hot water, and at a specific temperature; and/or means for inputting commands from a user and for activating the appliance at a required temperature of water supply; and/or means for requesting hot water at a required temperature responsive to received commands from a user; and/or separate hot and cold water inlets for the appliance and a circulation valve between and hot and cold water inlets, and means for activating the valves responsive to received commands from a user; and/or a system control for diagnostics for maintenance purposes including means for activating each valve and monitoring the status and performance of each valve; and in some of those embodiments, means for performing diagnostics under remote control and reporting to a remote location.

### BRIEF DESCRIPTION OF THE DRAWINGS

FIG. 1 illustrates a prior art system for supplying hot and cold water

FIG. 2 illustrates a system for saving water by circulating hot water into the cold water pipe

FIG. 3 illustrates a system with various types of users

FIG. 4 illustrates an electronic interface between a hot water controller and an appliance controller

FIG. 5 illustrates an appliance with local pump

FIG. 6 illustrates a user interface method—simple, immediate activation

FIG. 7 illustrates another user interface method—personalized, programmed immediate activation

FIG. 8 illustrates an adaptive user interface method

FIG. 9 adaptive method for water heating for people

FIG. 10 shows an adaptive method for heating water for people and appliances

FIG. 11 shows graphs for Flow rate FR, Temperature and Remaining Time RT

FIG. 12 illustrates a diagnostics method

FIG. 13 illustrates a remote diagnostics method

FIG. 14 illustrates a multi-faucet distributed system for saving water by circulating hot water into the cold water pipe

FIG. 15 illustrates a multi-faucet centralized system for saving water by circulating hot water into the cold water pipe

FIG. 16 illustrates the propagation of hot water front toward the faucet in the circulation mode of operation

FIG. 17 illustrates a method of operation of the system

FIG. 18 illustrates the water temperature at the faucet during the circulation stage

FIG. 19 illustrates a method for inputting user's order to supply hot water

FIG. 20 illustrates a method for activating water circulation in the system

FIG. 21 illustrates a method for stopping the water circulation in the system

FIG. 22A, 22B, 22C illustrates three possible methods for controlling water circulation

FIG. 23 illustrates a method for starting to supply water

FIG. 24 illustrates a method for supplying water at faucet

FIG. 25 illustrates one embodiment of a faucet

FIG. 26 illustrates two cross-sectional longitudinal views of another embodiment of the present faucet

FIG. 27 shows a valve structure of the present invention

FIG. 28 illustrates a functional cross-sectional of a micro valve of the present invention.

FIG. 29 illustrates a functional cross-sectional view of a device for mixing water from a plurality of sources

FIG. 30 illustrates two cross-sectional longitudinal views of yet another embodiment of the valve

FIG. 31 illustrates a top view of the faucet

FIG. 32 illustrates one embodiment of a human-machine interface

FIG. 33 illustrates another embodiment of a control panel

FIG. 34 illustrates yet another embodiment of the control panel

FIG. 35 illustrates yet another embodiment of the control panel

FIG. 36 illustrates a system for delivering hot water at a safe temperature

FIG. 37 shows another embodiment of the valve structure

FIG. 38 illustrates a faucet with dual sensor means including capacitive and IR cone sensors

FIG. 39 illustrates a faucet with dual sensor means including capacitive and IR hollow cone sensors

FIG. 40 depicts a pull-out faucet with a central IR sensor

FIG. 41 depicts a pull-out faucet with a peripheral IR sensors array

FIG. 42 depicts a regular faucet with a peripheral IR sensors array

FIG. 43 is a block diagram of a dual sensor automatic faucet

FIG. 44 is a block diagram of a dual sensor automatic faucet with manual override

FIG. 45 is a block diagram of another embodiment of a dual sensor automatic faucet with manual override

FIG. 46 is a flow chart of a dual sensor automatic faucet with separate ON/OFF criteria

FIG. 47 is a flow chart of an adaptive automatic faucet with manual override

FIG. 48 is a data flow diagram of an adaptive automatic faucet with manual override

FIG. 49 shows a shower device with dual sensor means including capacitive and IR cone sensors

FIG. 50 illustrates a shower device with dual sensor means including capacitive and IR hollow cone sensors

FIG. 51 illustrates a shower system with multiple sensor means including capacitive and IR cone sensors

FIG. 52 is a flow chart of a dual/multiple sensor automatic faucet with separate ON/OFF criteria manual override

FIG. 53 illustrates a user interface method with hot water indication

FIG. 54 depicts a method for multiple users' circulation

FIG. 55 depicts a method/mode of operation for servicing appliances

FIG. 56 depicts a method for measuring the amount of hot water used

FIG. 57 depicts another method for measuring the amount of hot water used

FIG. 58 depicts another method for measuring the amount of hot water used

FIG. 59 depicts a method for estimating the amount of remaining hot water in the boiler

FIG. 60 shows a faucet or water flow control device with an internal power source

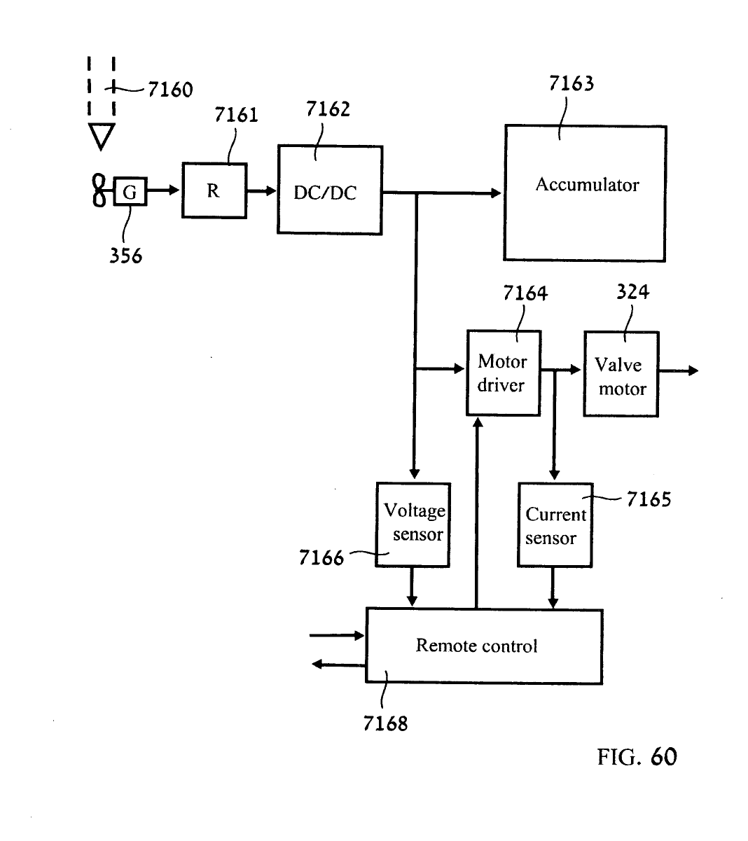

FIG. 61 shows the method of operation of a faucet or water control device with an internal power source

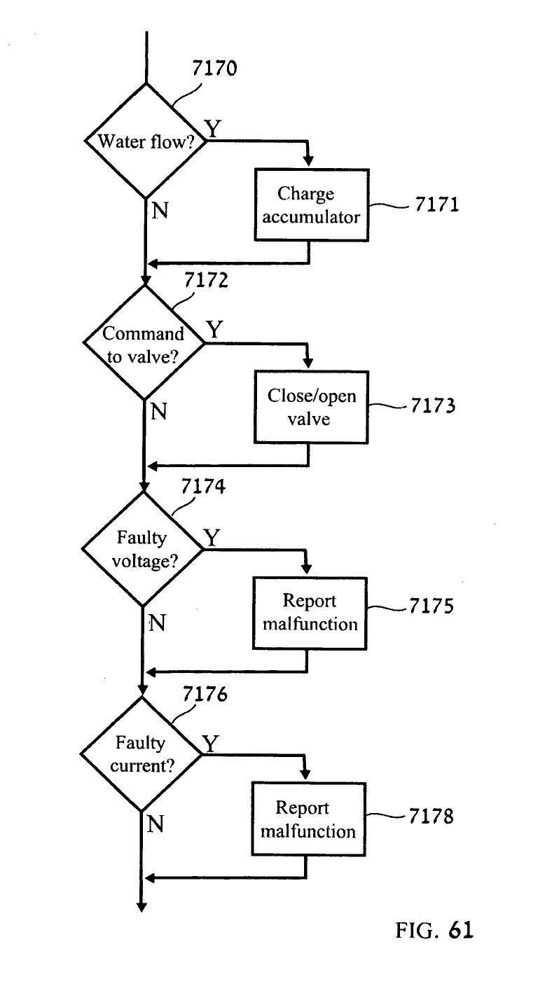

FIG. 62 illustrates modes of starting to supply water in an integrated activation method

FIG. 63 illustrates a stop water delivery strategy

FIG. 64 depicts a method for preventing water from freezing in pipes

FIG. 65 method for stopping the circulation

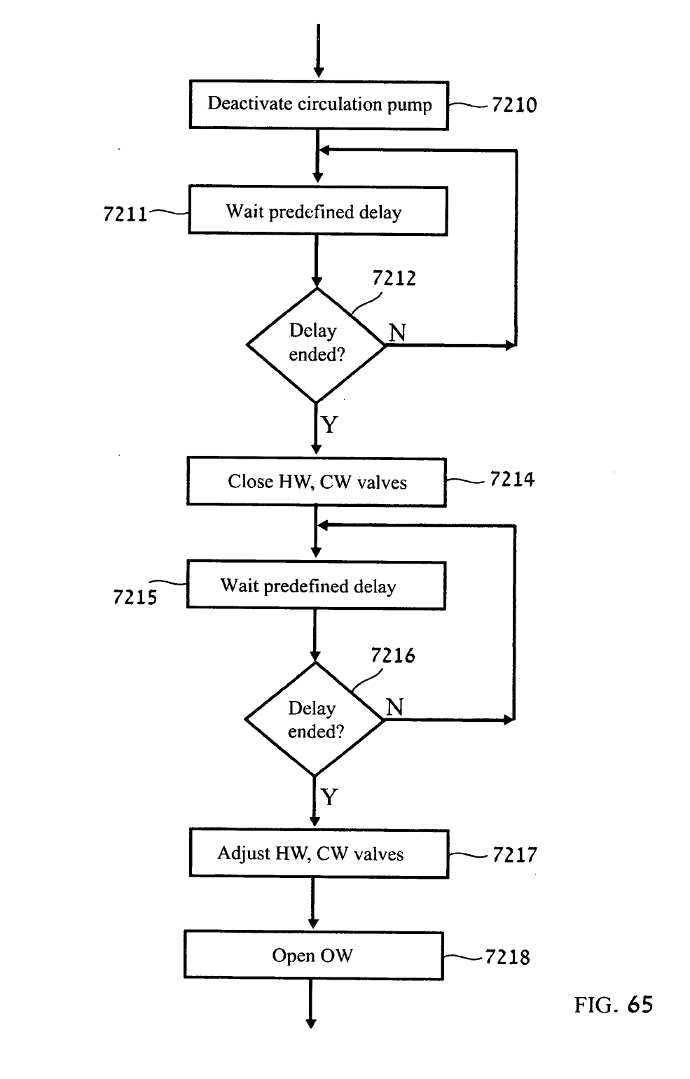

FIG. 66 Method of multi-user water circulation control and performance

FIG. 67 depicts a Method 1B for water circulation using one FR value

FIG. 68 depicts a Method 2B for water circulation using two FR values

FIG. 69 depicts a Method 3B for optimal control of the water circulation

FIG. 70 depicts a method for hot/cold water activation using one pushbutton

FIG. 71 depicts a method of control of the output water supply

FIG. 72 is a block diagram of the present water control system

FIG. 73 is a hot/cold water mains subsystem

FIG. 74A-74C shows a high flow rate valve device valve having two plungers

FIG. 75 illustrates controlling liquid flow rate by a plunger device

FIG. 76 is an exploded side view of a valve system

FIG. 77 is an exploded front view of a valve system

FIG. 78 is an exploded isometric view of valve system

FIG. 79 is a cross-sectional side view of a valve system

FIG. 80 is a cross-sectional rear view of a valve system

FIG. 81 is an isometric view of a valve system

FIG. 82 is a cross-sectional front view of a valve system

FIG. 83 is an isometric view of a plunger

FIG. 84 is a cross-sectional side view of a plunger

FIG. 85 is a cross-sectional side view of a plunger

FIG. 86 is a block diagram of high flow valve system with external controller

FIG. 87 is a block diagram of high flow multiple faucet valve systems with external controller

### DETAILED DESCRIPTION OF PREFERRED EMBODIMENTS

Systems and methods for supplying hot and cold water to users in a domestic, commercial or industrial establishment are provided.

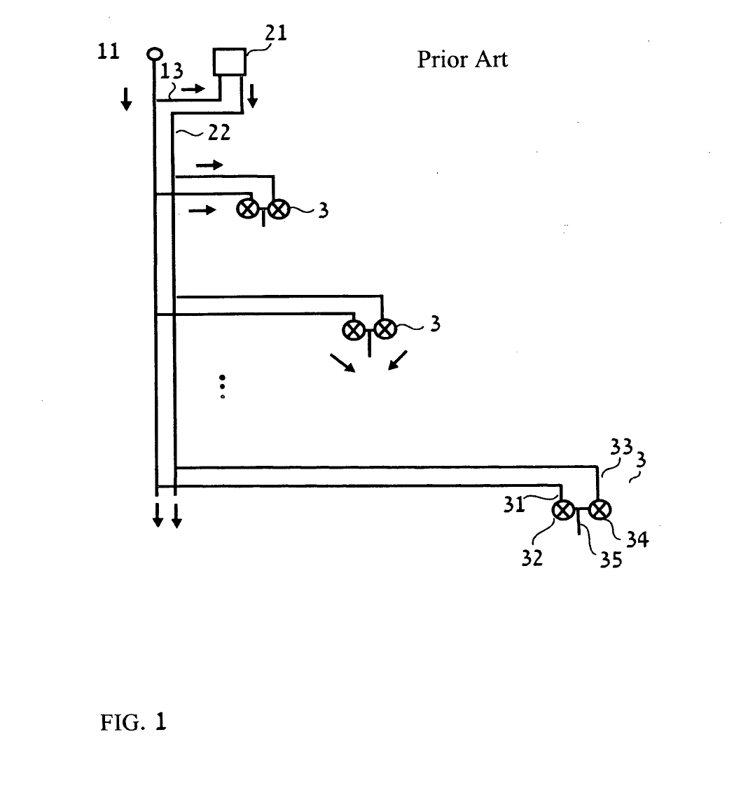

FIG. 1 illustrates a prior art system for supplying hot and cold water. Water from a water supply inlet to the house 11 is supplied as cold water, through a cold water supply pipe 12 and its ramifications, to all the users in the house. There is also cold water supply through pipe 13 for the hot water subsystem, using the water tank 21 to heat the water. The hot water is supplied to users in the house through hot water supply pipe 22 and its ramifications.

The present invention may be used where there is no water tank 21, for example using instant gas heating devices to heat water flowing in a pipe. Various water heating means may be used, for example using solar energy, gas heating etc.

Each user may have a hot/cold water faucet 3. At the faucet 3, there is cold water inlet 31 with a cold water valve 32 controlling the supply of cold water, and hot water inlet 33 with a hot water valve 34. Water is supplied to users through a water outlet 35. Usually, the valves 32 and 34 are mechanically controlled by the user. A faucet may service several users, each having his/her special needs.

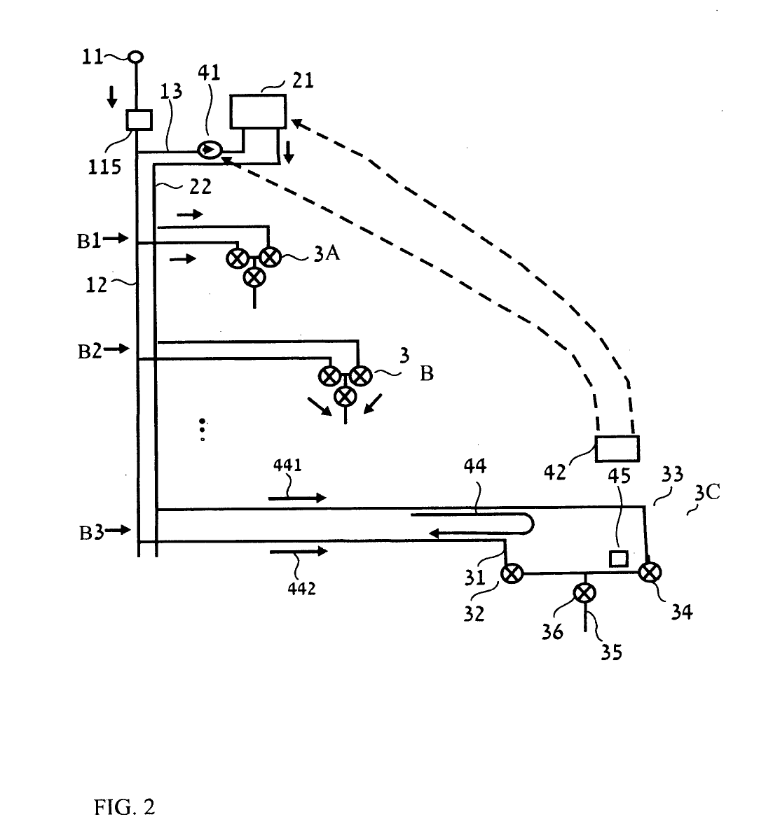

FIG. 2 illustrates a system for saving water by circulating water from the hot water pipe into the cold water pipe. Water is circulated prior to supply to user, so water supply to the output will occur only with hot water, not cold water in the pipe.

In this embodiment, the valves 32, 34 and 36 are electrically controlled. The present faucet has also an outlet valve 36. When valve 36 is closed and both valves 32, 34 are open, the circulation is possible, wherein water from the hot watering pipe can flow into the cold water pipe.

A circulation pump 41 pushes water along the closed circuit comprising the water tank 21, hot water supply pipe 22, valves 34 and 32, cold water supply pipe 12, pump 41 and back to the tank 21. See direction of water flow 44.

A unidirectional valve 115 may be installed at the mains supply entrance to the house. The valve allows to flow into the house water system, but prevents water from flowing back out of the house.

A temperature sensor 452 measures the water temperature in the faucet, in case only one temperature sensor is used. Preferably sensor 452 is located in the mixing camber in the faucet, to measure the temperature of the output water.

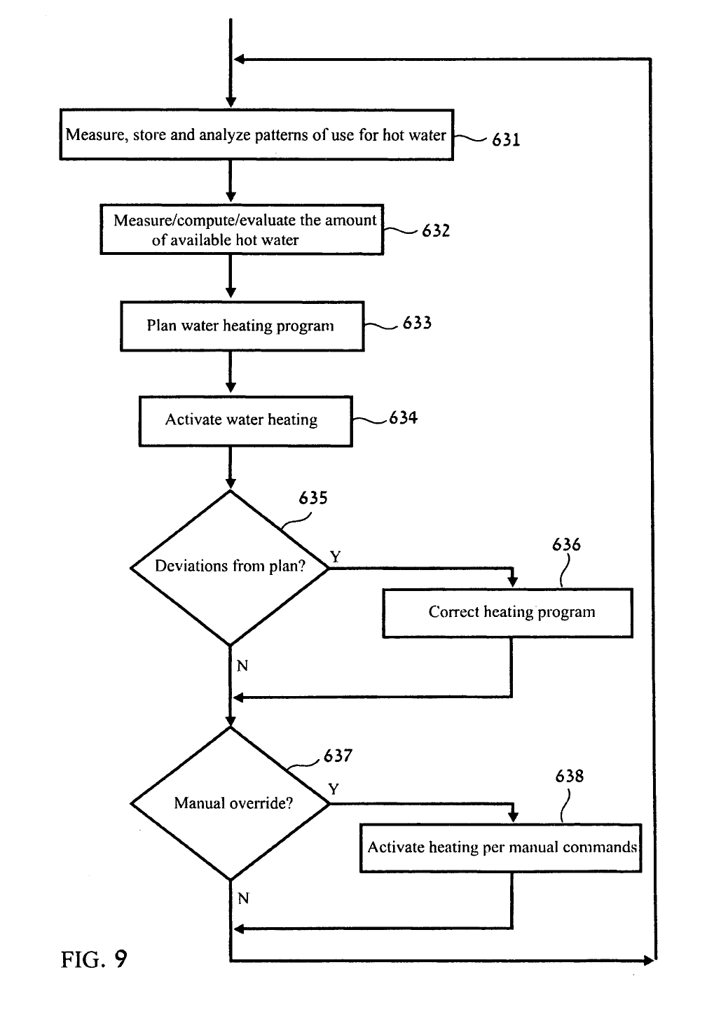

If one temperature sensor is used in the system—this is the output sensor 452 (FIG. 9), at the output of the faucet or in the mixing chamber. If two sensors are used, then the second sensor is that at the hot water inlet, sensor 45; If three sensors are used, then the third sensor is the temperature sensor 451 at the cold water inlet.

Using more than one sensor allows the controller to measure the temperature of hot and cold water supplied to the faucet, in addition of the temperature of the output (supplied) water. This info may be advantageously used by the control algorithm.

For controlling the temperature of the delivered water, only one sensor in the mixing chamber is enough. This is the preferred embodiment where a cost effective solution is desired.

In a preferred embodiment, the software calculates a temperature gradient vs. time, possible also using the rate of flow, to better control the supply of water, to achieve a regulated supply of controlled temperature and flow rate.

The faucet control unit 42 controls the operation of the valves 32, 34, 36 and the circulation pump 41.

Optionally, it also controls the hot water tank 21, to heat the water when necessary.

The circulation pump 41 is preferably mounted in the hot water pipe.

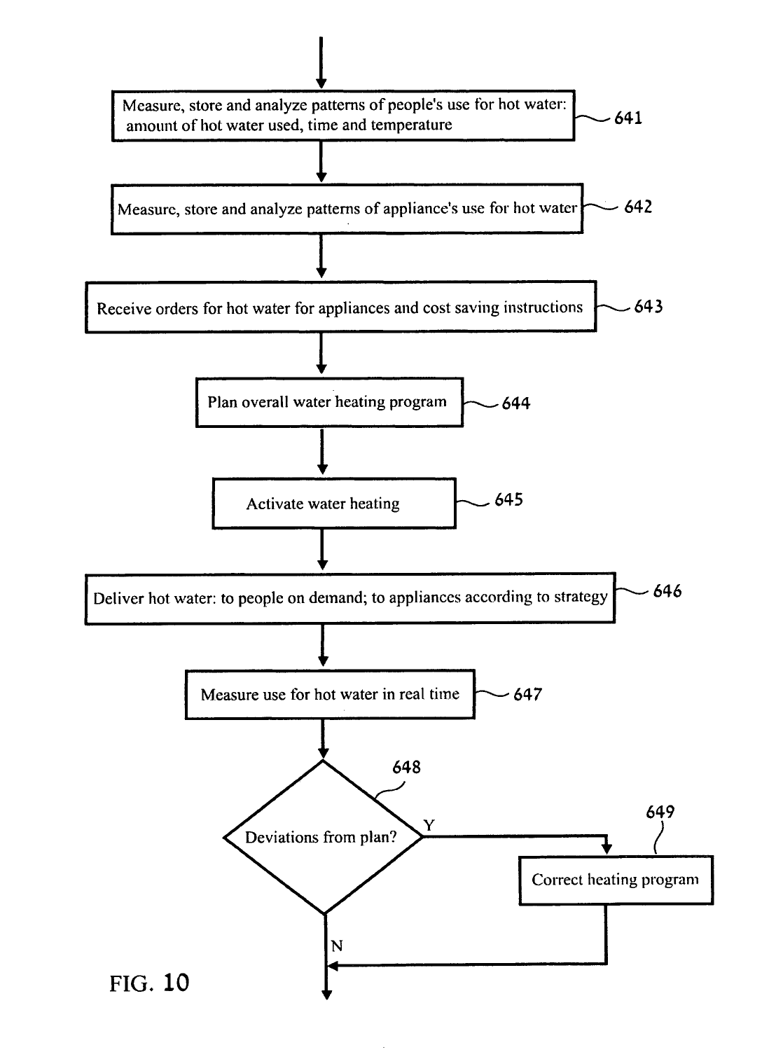

In a preferred embodiment, where only one temperature sensor is used, then it is the sensor 452 in the mixing chamber, see FIG. 10.

In another preferred embodiment, the only temperature sensor being used is the sensor 452 at the output 35 of the faucet (at the water supply to user), see FIG. 9.

In a preferred embodiment, the temperature sensor comprises a solid state sensor, for example a device manufactured by Analog Device Inc., whose output current is directly proportional to temperature.

Various embodiments are possible, for example:

The adapting means for appliances may include separate hot and cold water valves for the appliance and a circulation valve between the hot and cold water inlets.

The adapting means may further include a temperature sensor located in the mixing chamber in the faucet, to measure the temperature of the output water.

The adapting means my further include a temperature sensor located at the hot water inlet. A high flow valve may be used for also achieving a control over flow rate in a wide dynamic range.

The adapting means may include two temperature sensors, one located at the hot water inlet and the other and the cold water inlet.

The adapting means may be used with, and so devise as to interface with, an appliance which includes a local circulation pump.

The adapting means may further include three valves activated electronically, and easily installable in standard diameter faucets.

The adapting means may include hot/cold water control and programming using non-contact reliable means, using a dual sensor unit, as detailed below.

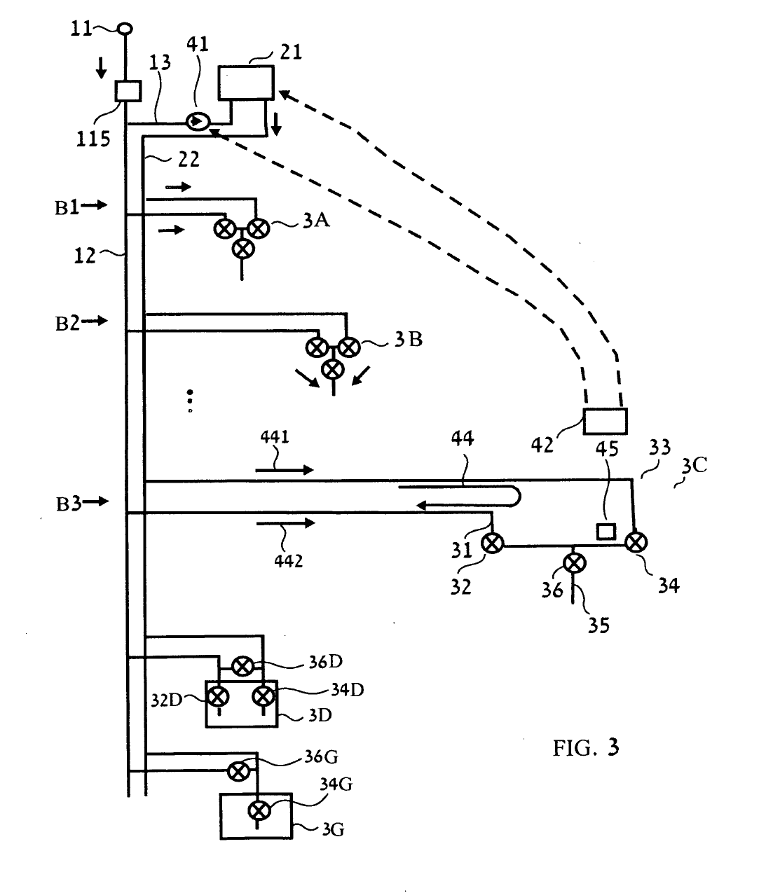

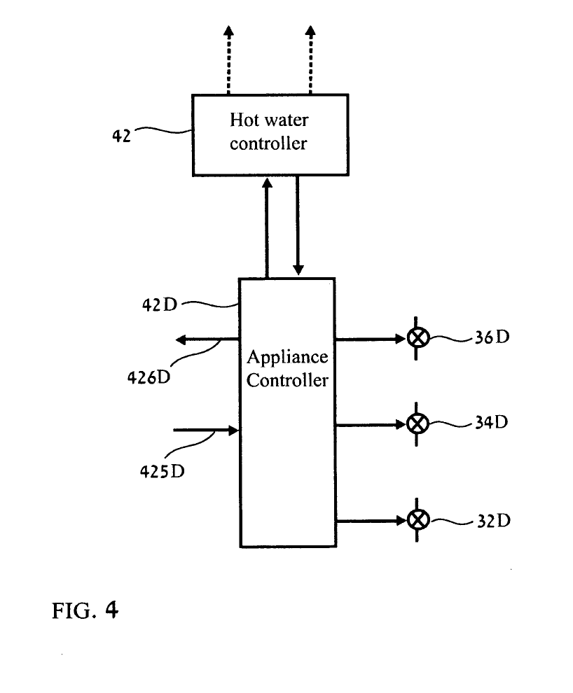

FIG. 3 illustrates a system with various types of users. The users may include for example a washing machine 3D which receives separate hot and cold water, and external circulation value 36D. It is possible that the hot and cold inlet valves are disposed in the appliance itself. The faucet control unit 42 controls the operation of the valves 32, 34, 36. The washing machine 3G receives hot water, and uses an external circulation valve 36D; see also FIG. 4. The hot inlet valve 34G may be located in the appliance itself.

The operation of the appliance is according to input commands from user 425D. The unit may further include display means 426D for presenting information to the user regarding the water temperature and other parameters. Other indicator means may also be used.

In the present system, by anticipating requests for hot water from a plurality of users, a more efficient overall strategy can be planned to service them all.

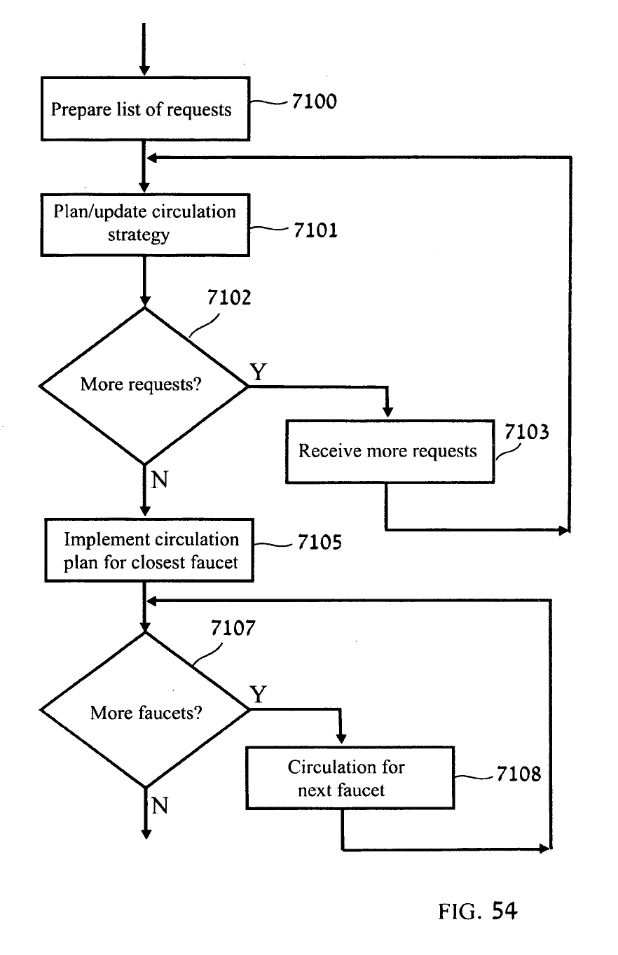

The method, with reference to FIG. 54, may be used with the system illustrated in FIG. 3 and includes:

a. preparing a list of requests for hot water supply for various users. The list may include, for each faucet such as 3A, 3B, 3C, etc. the expected time hot water is required, water temperature, flow rate and flow time.

Prepare list of requests 7100.

b. planning a common, system-wide overall circulation strategy responsive to all the requests.

Plan/update circulation strategy 7101.

c. receiving more requests for hot water from users in real time and adapting the plan accordingly. A user, for example, may request hot water at a time different than anticipated; another user may unexpectedly request hot water—this user should be serviced as well.

more requests? 7102

receive more requests 7103

d. implementing the overall circulation plan. At any given time, perform circulation for the faucet closest to the boiler 21 first, the next faucet next, etc., unit performing circulation for the faucet most remote from the boiler 21.

Implement circulation plan for closest faucet 7105;

the timing and parameters of circulation may be defined according to system design data and constraints.

e. repeat the above stages if necessary:

more faucets? 7107

circulation for next faucet 7108

FIG. 4 illustrates an electronic interface between a hot water controller 42 and an appliance controller 42D. The appliance controller 42D may include user controls 425D and user display 426D.

The appliance controller 42D may control the circulation valve 36D, as well as the valves 32D and 34D.

The interface may include commands to the hot water system (request for hot water supply); the water supply may be immediate or delayed, see details of methods of operation elsewhere in this disclosure.

The electronic interface may be so connected as to transfer signals between the hot water controller and various appliances which need cold and/or hot water, and at a specific temperature.

The interface unit may include means for imputing commands from a user and for activating the appliance at the required temperature of water supply, accordingly.

The interface unit may include means for requesting hot water at a required temperature responsive to received commands from a user.

The interface unit may include separate hot and cold water valves for the appliance and a circulation valve between the hot and cold water inlets, and means for activating the valves responsive to received commands from a user.

The interface unit may include a temperature sensor located in the mixing chamber in the faucet, to measure the temperature of the output water. It may also include a temperature sensor located at the hot water inlet.

In another embodiment, the interface unit may include two temperature sensors, one located at the hot water inlet and the other and the cold water inlet.

The temperature sensor may comprise a solid state semiconductor sensor. The appliance may also include a local circulation pump.

The interface unit may include three valves activated electronically, and easily installable in the standard diameter faucets. It may further include hot/cold water control and programming using non-contact reliable means, using a dual sensor unit.

The unit may include:

1. water flow through the circulation pump to the house—when not activated, the pump allows water passage through it.

2. a hot water temperature limitation unit to prevent scalding, see details elsewhere in the present invention.

3. passage of water from the hot outlet directly to the cold inlet of the boiler; the passage being located near the boiler; see details elsewhere in the present invention.

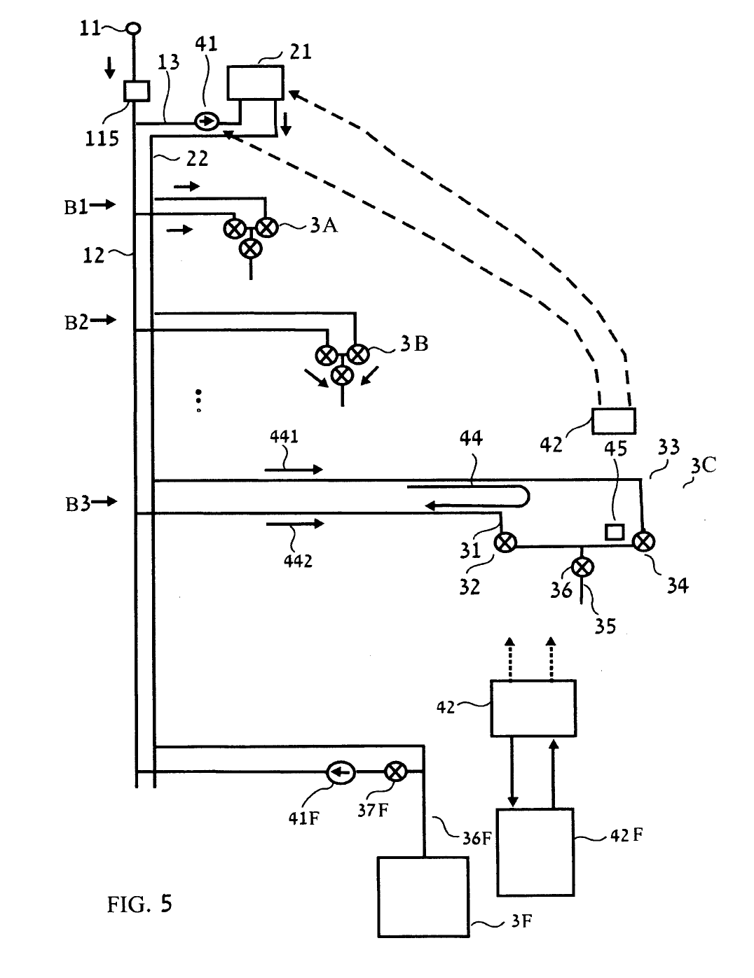

FIG. 5 illustrates an appliance 3F with a local circulation pump 41F.

The appliance may further include a circulation enable valve 37F, an appliance supply valve 36F and appliance controller 42F.

The appliance controller 42F may be connected (can communicate) with the hot water controller 42.

Embodiments of the interface with users.

Interface with users—several faucets, possibly several users in each.

The present invention allows various embodiments, including for example (see detailed methods below):

1. simple, immediate activation with preset parameters—flow rate, temperature.

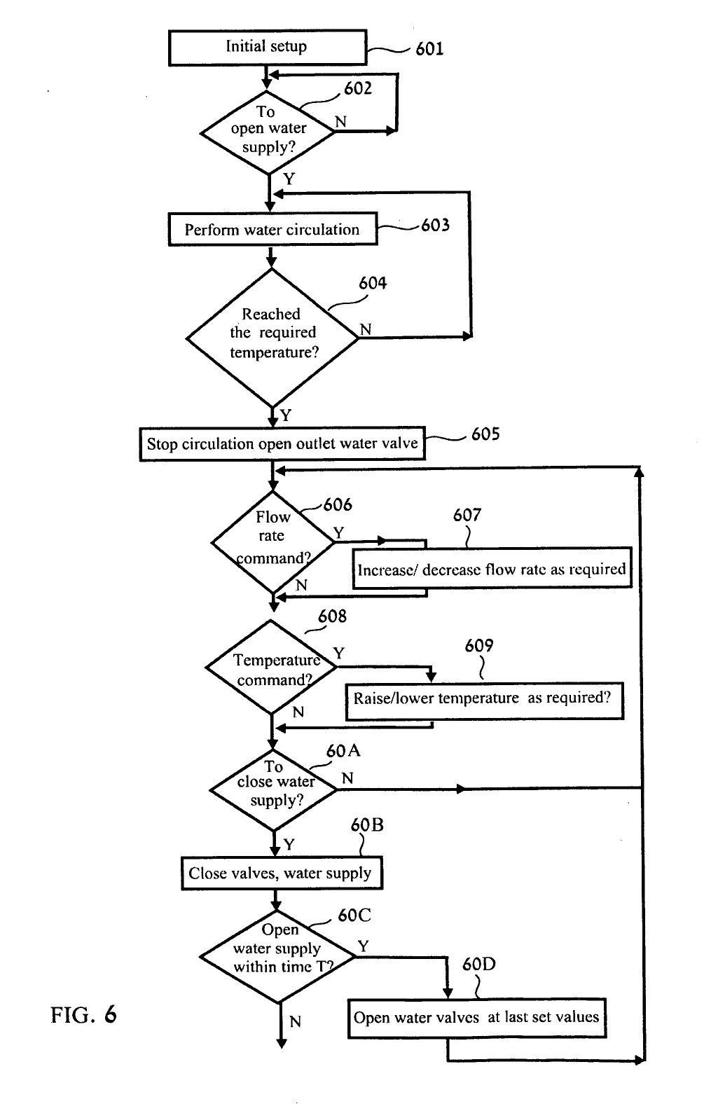

Adjust in real time: flow rate increase/decrease, temperature up/down on/off control, see FIG. 6.

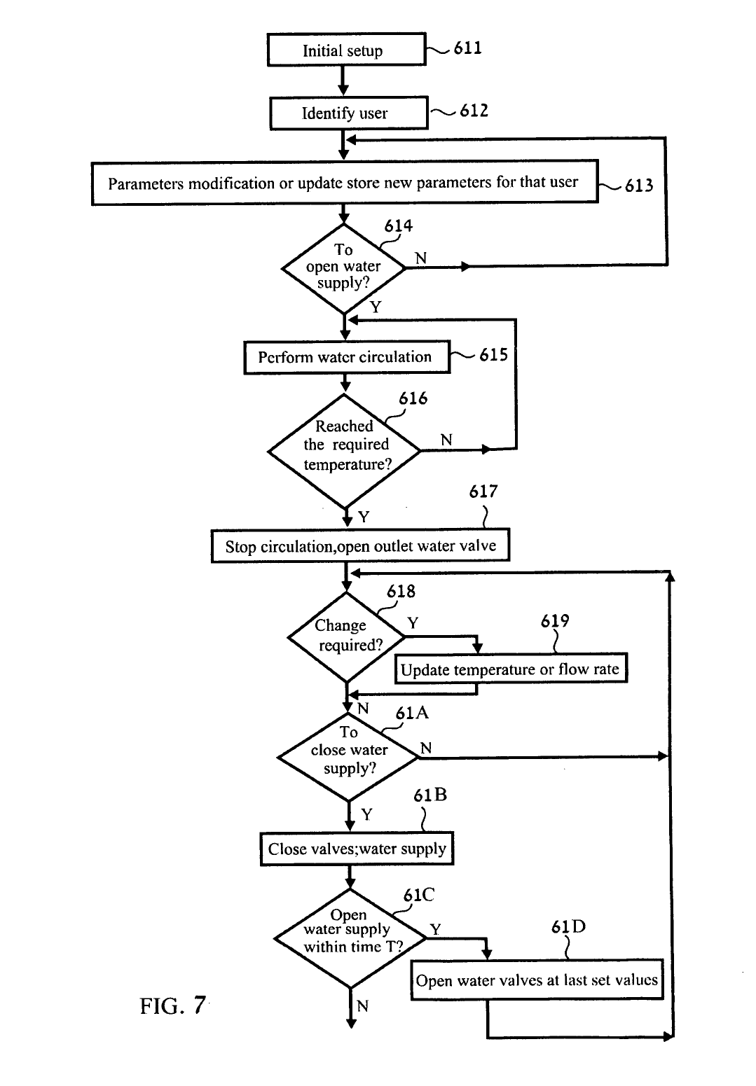

2. user programs (stores) into system his/her preferences; when activating faucet and identifying the user, it will deliver water according to the stored variables, see FIG. 7 user interface method—personalized, programmed immediate activation.

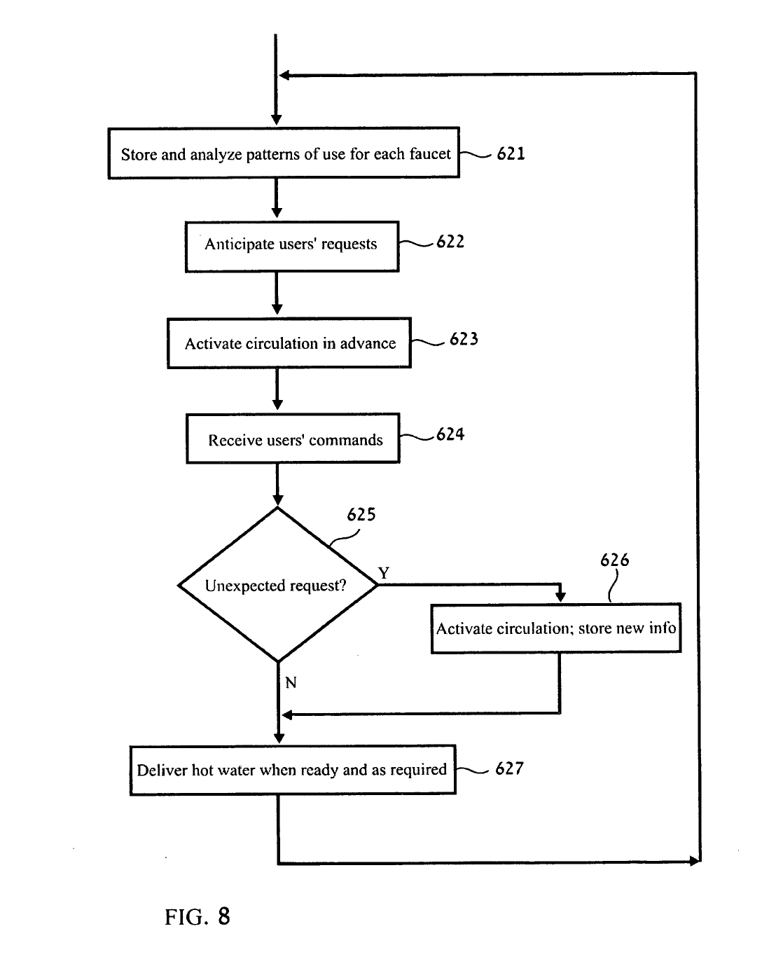

3. adaptive system—learns patterns of use at each faucet, statistics prepares hot water ready in advance, at the tap—a short time before use. The time advance—depending on variance of time of use. See FIG. 8 for an adaptive system, which learns patterns of use for each faucet and applies them.

FIG. 6 illustrates and user interface method—simple, immediate activation including:

a. Initial setup 601 default temperature, flow rate, water quantity or activation time

b. to open water supply? 602

c. perform water circulation 603

d. reached the required temperature? 604

e. stop circulation 605

open outlet water valve

f. flow rate command? 606

g. increase/decrease flow rate as required 607

h. temperature command? 608

i. raise/lower temperature as required 609

j. to close water supply? 60A

k. close valves, water supply 60B

l. open water supply within time T? 60C

m. open water valves at last set valves 60D

FIG. 7 illustrates another user interface method—personalized, programmed immediate activation, including:

a. Initial setup 611

b. identify user 612

c. parameters modification or update 613

store new parameters for that user

d. to open water supply? 614

e. perform water circulation 615

f. reached the required temperature? 616

g. stop circulation 617

open outlet water valve

h. change required? 618

i. update temperature or flow rate 619

j. to close water supply? 61A

k. close valves, water supply 61B

l. open water supply within time T? 61C

m. open water valves at last set valves 61D

FIG. 8 illustrates an adaptive user interface method. This is an adaptive system, which learns patterns of use for each faucet and anticipates users' requests. The method includes:

a. store and analyze patterns of use for each faucet 621

b. anticipate users' requests 622

c. activate circulation in advance 623

d. receive users' commands 624

e. unexpected request? 625

f. activate circulation; 626

store new info

g. deliver hot water when ready 627, and as required.

Method for human/appliance multi-user service:

a. mapping of system—location of each faucet relative to boiler; time for water to arrive. Cross-correlation between users (common pipe with hot water; can serve both users. or several users).

b. adaptive—learn patterns of use: which user requires hot water, at what location; time; temperature; amount of water; flow rate.

c. activate boiler to heat water as necessary, when required

d. anticipate future use at various faucets; prepare water at each in advance; circulation, starting from closest to boiler.

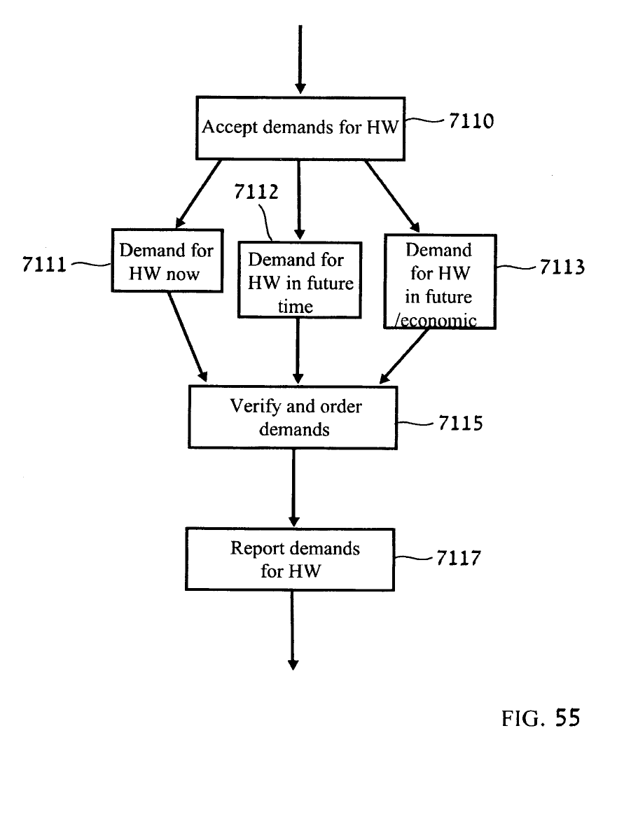

FIG. 55 shows a method/mode of operation for servicing appliances. At each appliance, one of the following modes can be programmed. Each mode may require a corresponding hardware for its implementation:

a. accept demands for hot water HW 7110

b. like a human user—demands water now at desired temperature demand for HW now 7111.

c. demands hot water in the future. The appliance is programmed as request water at some time in the future. This embodiment is transparent for the water controller.

Demand for HW in a future time 7112.

d. requests delayed supply of hot water;

waits until the system controller finds it practical to deliver:
after all users finished bathing.
late at night, no one is expected to require hot water—uses remains of hot water
heats water at reduced rates at night

demand for HW in future/economic 7113

e. verify and order demands 7115

f. report demands for HW 7117

The appliance may be activated when it is supplied with hot water.

FIG. 9 shows an adaptive method for water heating for people, including:

a. measure, store and analyze patterns of use hot water; 631, measures amount of hot water used.

b. measure amount of available hot water 632

This can be done, for example, using water circulation in a shore circuit near the boiler—using a pump with a bypass path, to enter hot water back into the cold water inlet. Prior to using this solution, one should verify that the inlet part of the boiler can withstand a hot water inflow; moreover, sometimes mixing the water in the boiler may be undesirable, for example when water is heated gradually and has different temperatures in different parts of the boiler. Water at the highest temperature are supplied to user; in the meantime, other volumes of water are being heated toward that temperature.

c. plan water heating program 633

d. activate water heating 634

e. deviations from plan? 635

f. correct heating program 636

g. manual override? 637

h. activate heating per manual commands 638

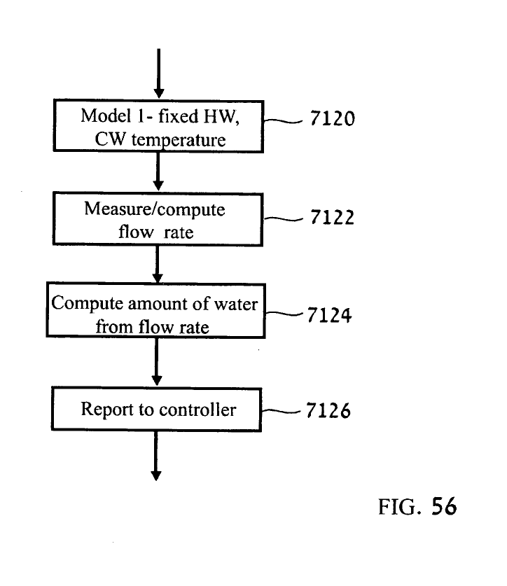

FIG. 56 shows a method 1 for measuring the amount of hot water used wherein one preferred embodiment of step (631) above is: to measure, store and analyze patterns of use for hot water; and measure the amount of hot water used, including:

a. Model 1: The model assumes fixed temperatures of hot and cold water supply.

Model 1—fixed HW, CW temperature 7120

b. The amount of hot water from hot water supply—boiler and solar heater or a combination of both; can be computed from the water supply rate, integrated over time.

Measure/compute flow rate 7122

c. the water supply rate can be computed from the opening of the hot water valve; actually the process is done the other way around: the user defines the desire flow rate; this is implemented by a specific opening of the valve; the flow rate, multiplied by time, gives the total water volume delivered.

Vw=F.R.×time (1)

Vw—volume of water from boiler, liter

F.R.—flow rate, liter/sec

Time—in seconds

Computer amount of water from flow rate 7124

d. report to controller 7126

Method 2 for measuring the amount of hot water used

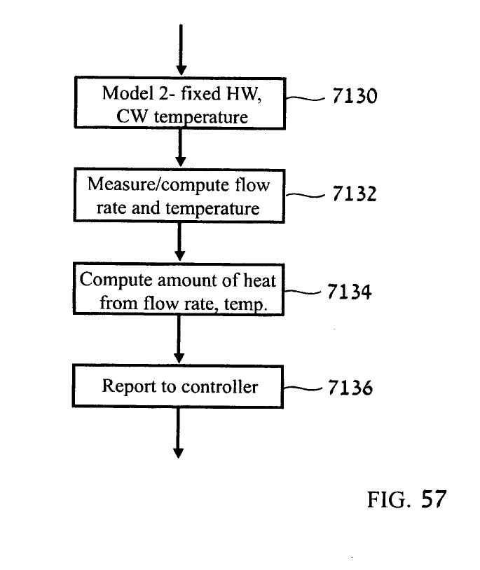

The method, see FIG. 57, is another preferred embodiment of step (631) above:

a. Model 2: The model allows for different temperatures of hot and cold water each time, but the temperature is fixed during water supply to a user.

Model 2—fixed HW, CW temperature 7130

b. measure the amount of both hot and cold water supplied, and the temperature of each; and the temperature of water at the outlet;

measure/compute flow rate and temperature 7132

c. then, at another time for another temperature of hot water and cold water:

it is possible to compute the required amount of hot water from the boiler, to deliver a specific volume of output water at a desired temperature.

criterion: not the same amount of hot water from boiler/heater, but possibly a different amount of hot water to deliver the same amount of water to the output at the same output temperature.

compute amount of heat from flow rate, temp. 7134

Vh*Th+Vc*Tc=Vo*To (2)

Vo=Vh+Vc (3)

Vh, Vc, Vo—volume of water: hot and cold in, warm out

Th, Th, To—temperature of water: hot and cold in, warm out

The known variables are the input temperatures, and the output volume Vo;

The input volume of hot and cold water are the two unknown values to compute, and we have two equations to do that.

d. The flow rate of hot and cold water are determined from the total input volume of each and the required output flow rate.

Report to controller 7136

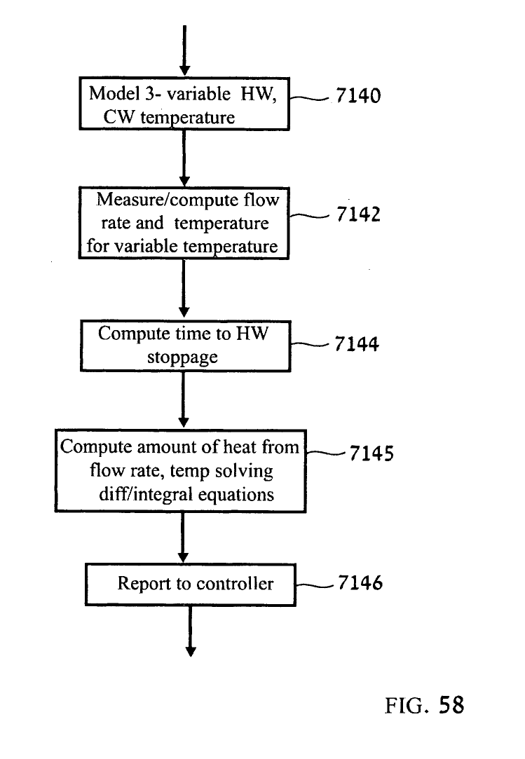

FIG. 58 illustrates a method 3 for measuring the amount of hot water used, which is another preferred embodiment of step (631) above:

a. Model 3: The model allows for different temperatures of hot and cold water each time, and the temperature of hot water is decreasing at fixed rate during water supply to a user. This model takes into hot water being depleted in the boiler.

Model 3—variable HW, CW temperature 7140

b. The equations now can take into account the cooling of hot water in the boiler, until no more hot water can be delivered. The time until such an event may be calculated from the above data.

Measure/compute flow rate and temperature 7142

For variable temperature

c. The calculus involves solving a set differential/integral equations, based on the same principles as those for Embodiment 2.

Compute time to HW stoppage 7144

d. compute amount of heat from flow rate, temp. 7145

solving diff/integral equations

e. report to controller 7146

Method for estimating the amount of remaining hot water in the boiler:

a. An estimate of the amount of remaining hot water in the boiler can be computed from measuring the temperature at the boiler outlet as water is supplied to users at a known flow rate.

measure temperature at outlet vs. time 7150

b. The temperature vs. time variable can be extrapolated into the future, to compute the time when the temperature decreases to some Tmin value. Tmin may be the temperature of water to be delivered to the user. It may take into account the drop in temperature from the boiler outlet to the faucet or shower of that user.

compute time to HW stoppage using extrapolation 7153

c. Using the known flow rate, the amount of hot water available can be computed.

compute amount of HW also using flow rate 7155

d. choose linear/nonlinear model for calculus 7157

continue according to the model in use.

e. The calculus takes into account the total flow rate of hot water, and can be normalized as such to allow measurement and calculus over a longer time. Normalized results for variable flow rate 7158

f. The model may use a linear (fixed rate of temperature decrease vs. time) on a nonlinear model, using for example Taylor series.

g. the method may be used to predict either the amount of remaining hot water in the boiler, or the time until there is no more hot water (see b above) or both.

h. in case there are several users, or as the number of concurrent users changes, the system may compute in real time an estimate of amount of water and time to depletion using the above method. Compute amount of HW/time to HW stoppage in a multi-user environment 7159.

FIG. 10 shows an adaptive method for heating water for people and appliances, including:

Measure, store and analyze patterns of people's use for hot water: 641

Amount of hot water used, time and temperature.

Measure, store analyze patterns of appliance's use for hot water 642

Receive orders for hot water for appliances and cost saving instruction 643

Plan overall water heating program 644

activate water heating 645

deliver hot water: to people on demand; 646

to appliances according to strategy

measure use of hot water in real time 647

deviations from plan? 648

correct heating program 649

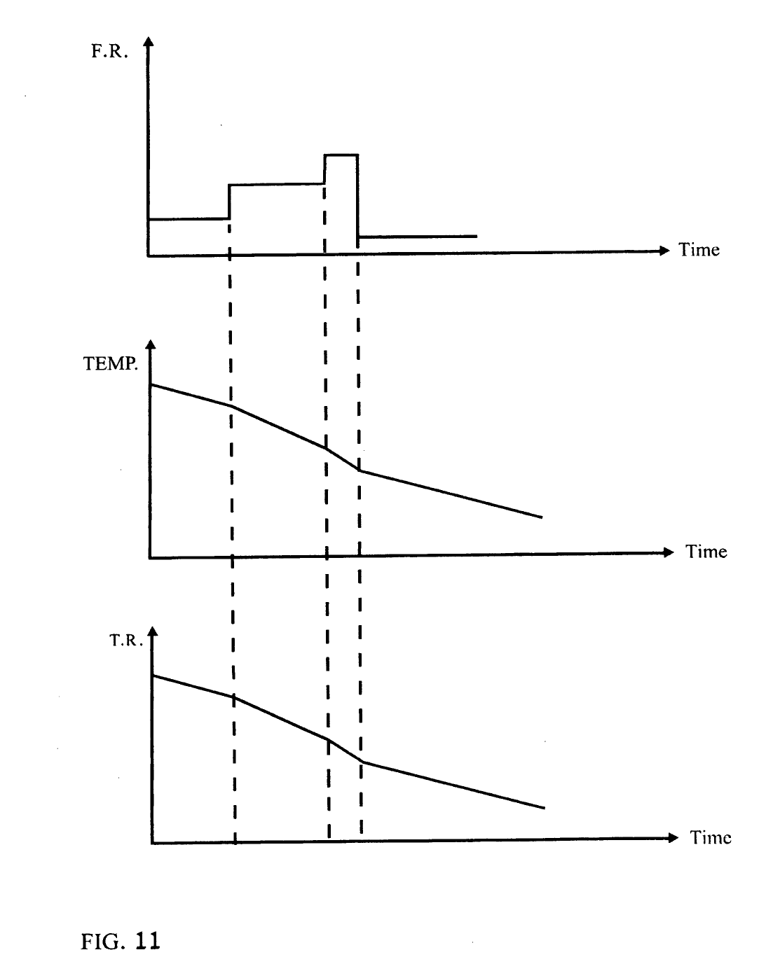

FIG. 11 illustrates graphs of Flow rate FR, Temperature and Remaining Time RT by way of example, for a specific sequence of events: first a low rate of flow, then a higher rate (possibly a second user starts using water), then a still higher flow rate, then a low flow rate. As can be seen in the second graph, the rate of descent of the Temperature is higher as the Flow Rate is higher. The Time Remaining for hot water decreases at a steeper rate when the flow rate is higher.

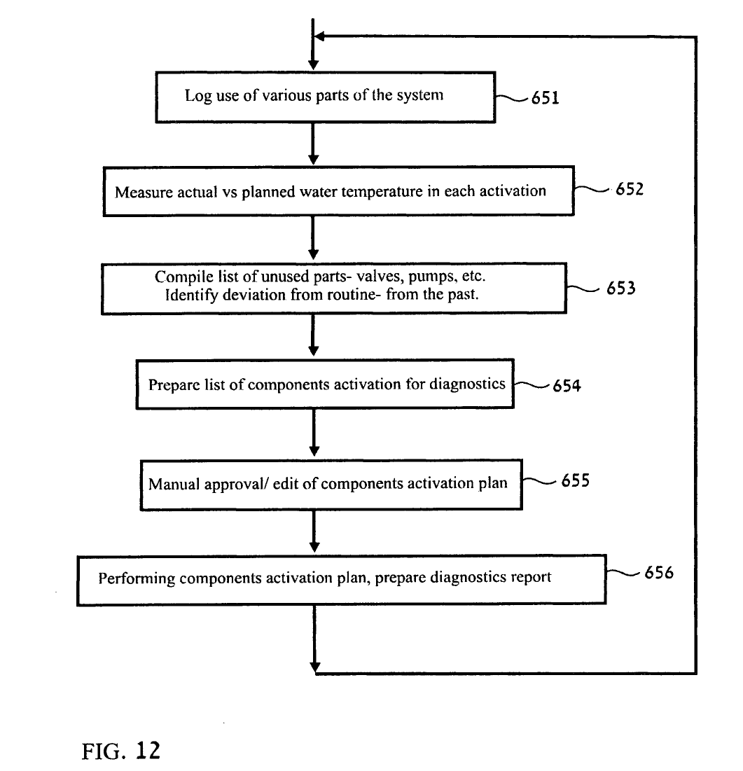

Method of system control for maintenance and diagnostics, the method includes (see FIG. 12):

a. log use of various parts of the system 651

b. measure actual vs. planned water temperature in each activation 652

c. compile list of unused parts—valves, pumps, etc. 653

identify deviation from routine—from the past.

d. prepare list of components activation for diagnostics 654

e. manual approval/edit of components activation plan 655

f. performing components activation plan 656

prepare diagnostics report

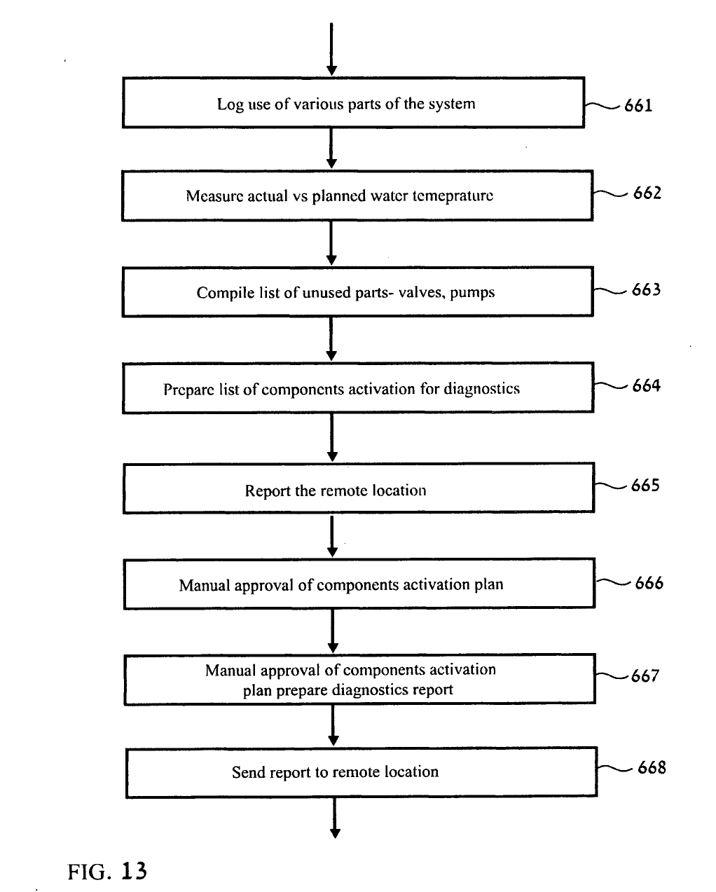

FIG. 13 illustrates a Method of remote system control for maintenance and diagnostics, including:

a. log use of various parts of the system 661

b. measure actual vs. planned water temperature in each activation 662

c. compile list of unused parts—valves, pumps, etc. 663

identify deviation from routine—from the past.

d. prepare list of components activation for diagnostics 664

e. report to remote location 665

f. manual approval/edit of components activation plan 666

g. performing components activation plan 667

prepare diagnostics report

h. send report to remote location 668

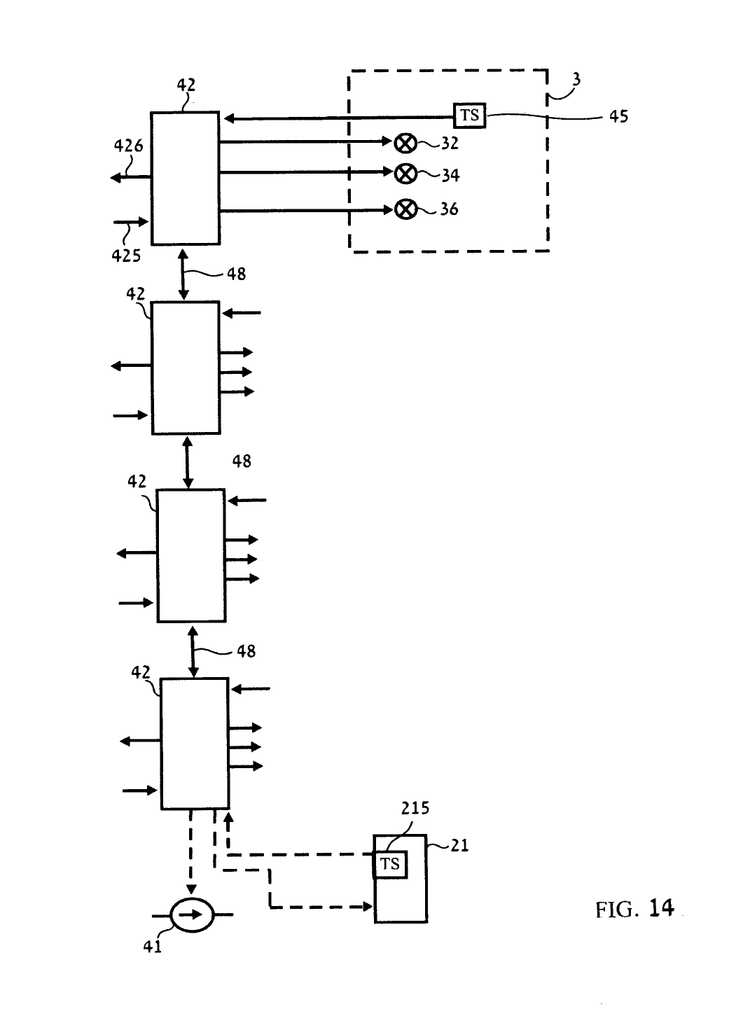

FIG. 14 illustrates a multi-faucet distributed system for saving water by circulating hot water into the cold water pipe. There are faucet control units 42, each controlling the operation of valves 32, 34, 36 for one faucet 3. The operation of the faucet is according to input commands from user 425.

The unit further includes display means 426 for presenting information to the user regarding the water temperature and other parameters. Other indicator means may be used in lieu of or in addition to the display means 426, for example audio indicator means.

In this distributed system, a request to activate the circulation pump 41 is transferred to another control unit 42 through a communication channel 48, the process is repeated until request reaches one of the units 42 which actually controls the pump 41 and optionally the heating in the tank 21, responsive to hot water requests from all the control units 42.

Preferably, each controller in a faucet has the capability to communicate with other such units and to control the pump 41 and the heating unit in the tank 21. The controlled in each faucet may include bi-directional communication links with other faucets, to transfer commands and status info between the units.

The controller may use existing integrated circuit controllers which connect to each other automatically, recognize the topology of a network and transfer information between the nodes of the network. The communication channel 48 may be implemented using radio frequency communications, wired links, ultrasound, infrared and/or other communication means.

The water temperature in the tank 21 may be measured using a temperature sensor 215 (or several sensors) mounted there. The result may be transferred to a unit 42, and from it—to the rest of the unit 42. The information regarding the tank water temperature may be used in the control method/algorithm to better control the circulation and the supply of hot water to the users. Optionally, the water temperature may be displayed on the faucet display.

For example: When the temperature of hot water is high, a lower circulation speed may be used, so the faucet will not be suddenly awash in very hot water. When the hot water temperature drops below a threshold, heating may be activated. The threshold may depend on expected hot water use: if a heavy usage is expected, the water may be kept at a higher temperature.

There may be variations in water temperature in the tank; using readings from several sensors, a better estimate of the total quantity of hot water is achieved. For example, the average of the various readings may be computed, or a weighted average, to assign the correct importance to each sensor.

It is possible to install a plurality of temperature sensors in the tank, for example, at the top, middle and bottom of the tank. Other means may be used to measure the temperature of water in the tank, for example water circulation in the tank. A plurality of such sensors may better evaluate the remaining hot water in the tank, to warn of an imminent shortage of hot water.

In another embodiment, readings from only one temperature sensor vs. time may be used, with a suitable method/algorithm, to evaluate the remaining hot water in the tank and to warn of a imminent shortage of hot water. Optionally, the units 42 also control the hot water tank 21, to heat the water when necessary.

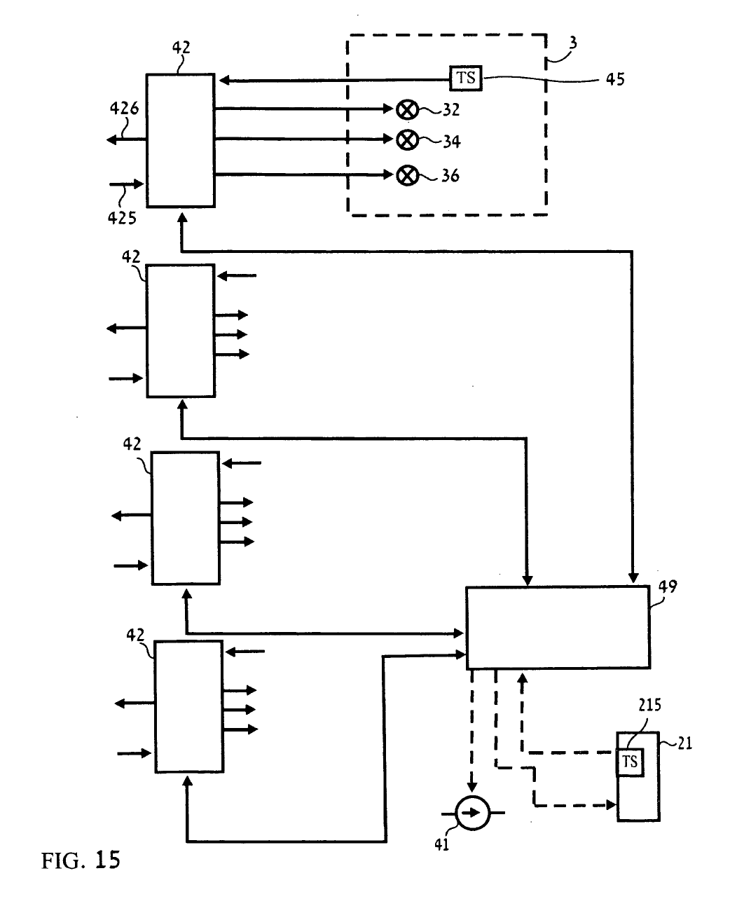

FIG. 15 illustrates a multi-faucet centralized system for saving water by circulating hot water into the cold water pipe. The faucet control units 42, each controls the operation of valves 32, 34, 36 for one faucet 3. There is a channel for input commands from user 425, and display means 426.

In this embodiment, there are three temperature sensors 45, 451 and 452 (see FIG. 9) attached to the hot water inlet 33, cold water inlet 31 and water outlet 35, respectively. It is important for the sensor 452 to have a fast response and measure the temperature in the water. A request to activate the circulation pump 41, from the unit 42, is transferred to a central computer 49. Other unit 42 can also transfer their requests to the computer 49. The computer 49 controls the pump 41 and optionally the heating in the tank 21, responsive to hot water requests from all the unit 42.

The water temperature in the tank 21 may be measured using a temperature sensor 215 (or a plurality of sensors) and an optional prediction algorithm. The result is transferred to the computer 49 for better control of the system. The prediction algorithm/method may use temperature readings as a function of time, and information about the rate of flow of water, to estimate the temperature of water in the tank and/or the amount of available hot water. Optionally, the computer 49 also controls the hot water tank 21, heat the water when necessary.

Method for supplying hot water, while managing micro valves and/or water circulation.

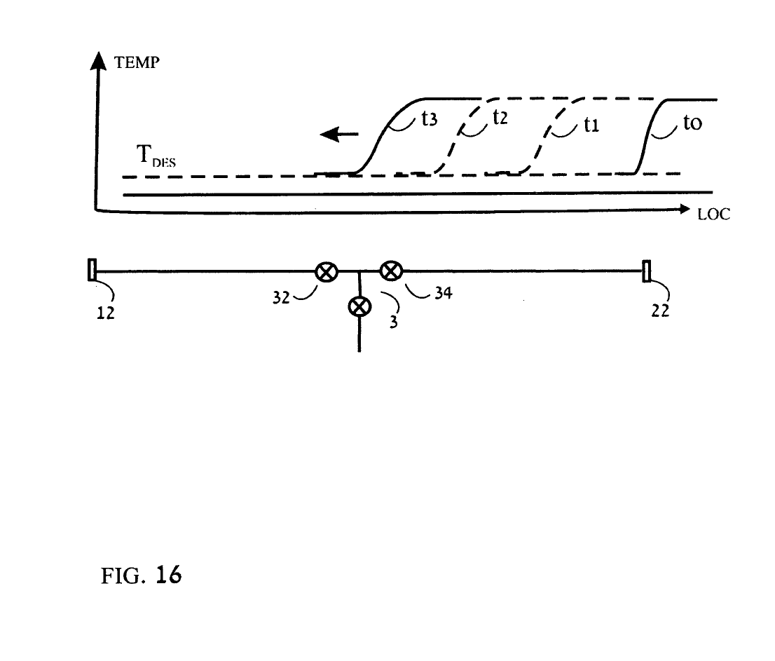

a. FIG. 16 illustrates the propagation of hot water front toward the faucet in the circulation mode of operation, in a time—location graph, for various values of the Time parameter.

b. Initially, at time t0, the water throughout the pipes is at a low temperature (the ambient temperature); only the water near the hot pipe 22 are hot. When the circulation is activated, a hot water front advances toward the faucet 3 and the cold water pipe 12, as illustrated with temperature profiles at consecutive time periods t0, t1, t2, t3 . . . .

c. At time t5, the hot wave arrives at the faucet, with the temperature of the water there being just the desired temperature Tdes. Circulation is stopped at that moment, and water can be supplied to the user.

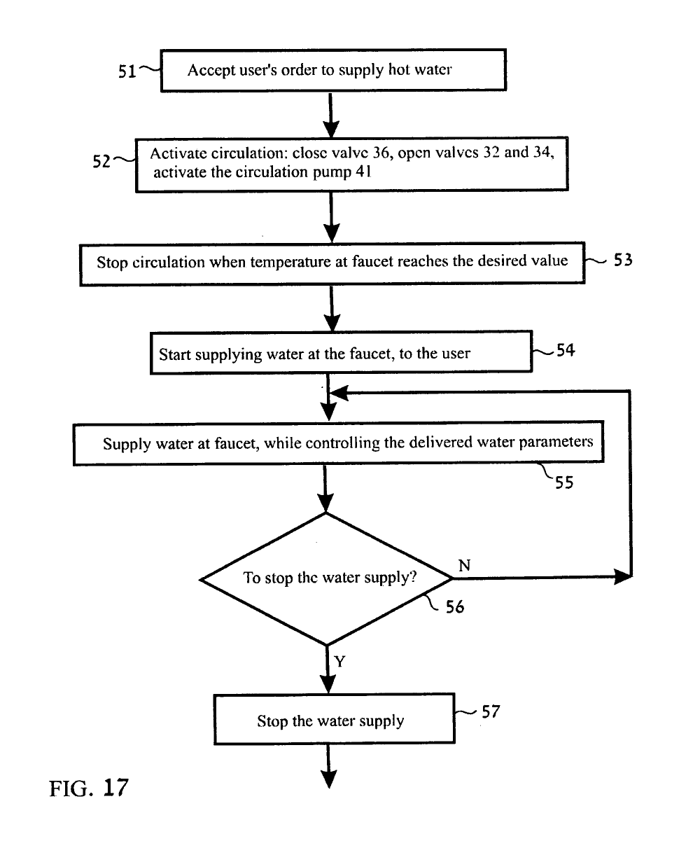

FIG. 17 shows a method of operation of the system, including:

1. accept user's order to supply hot water 51

2. activate circulation 52: close valve 36, open valves 32 and 34, activate the circulation pump 41

3. stop circulation when temperature at faucet reaches the desired value 53

4. start supplying water at the faucet, to the user 54

Water supply starts either when ready, or only after a prompt from the user, see notes below.

5. supply water at faucet, while controlling the delivered water parameters 55

6. Check: to stop the water supply? 56

If not—go to (5)

There may be various criteria for stopping the water supply, see notes below.

7. stop the water supply 57

The faucet may have one of the methods in (1) embodied therein, or the method may be programmed by the user—one user may prefer to activate the water supply as soon a possible, another may prefer to activate it at the right time.

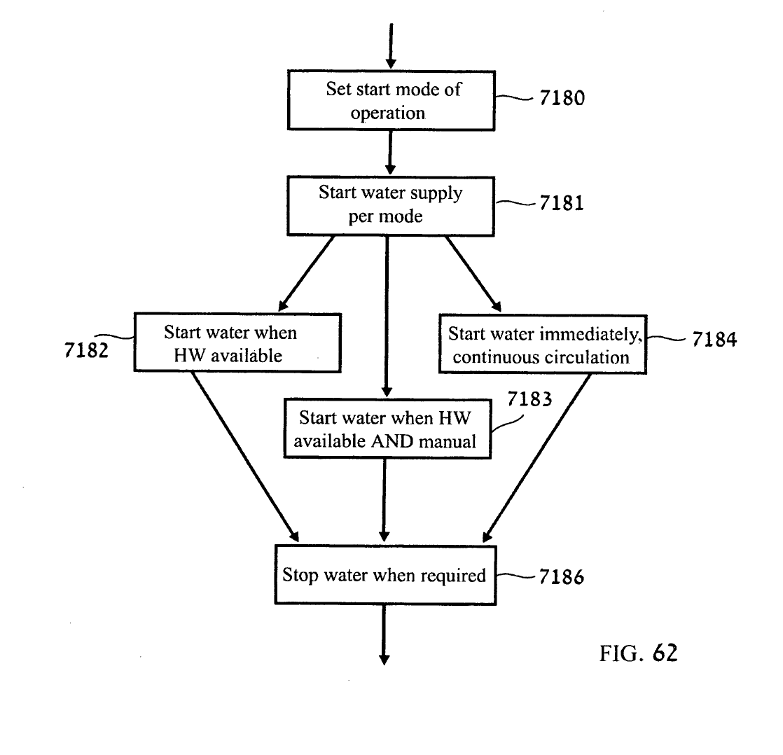

FIG. 62 illustrates possible modes of starting to supply water in an integrated activation method, including:

a. set Start mode of operation 7180

There are three possible embodiments for starting to supply water to the user in the above method, step (4), as detailed below. Initially, one of these may be selected.

b. start water supply per mode 7181 when a faucet, for example, is activated by the user.

start water when HW available 7185

start water when HW available AND manual 7183

start water immediately, continuous circulation 7184

stop water when required 7186

a. As soon as water at the desired temperature is available at the faucet, the system will start the water flow out of the faucet, to the user;

b. When water is available at the desired temperature, the system will activate a READY indicator; the user may press a button to start the water supply when so desired. The READY indicator may be visual, audible and/or using other means.

c. Water now—the system performs circulation all the time, or intermittently as the need be, to keep hot water close at hand at the faucet. When the user requires hot water, the system may respond immediately. If there are faucets requiring immediately response, then the system may perform circulation to bring hot water to the first faucet, then circulation to bring hot water to the second, third, etc.

When the system senses (using temperature sensors) that the water at some faucet gets cold, circulation is again initiated to bring hot water that faucet, by opening the first and second valves there.

3. There are various criteria for deciding when to stop the water supply in step (6), for example:

a. The system detects the hot water supply is expected to be depleted soon therefore the desired temperature cannot be maintained for long; a suitable indication is issued, to warn the user to hurry finish before the water gets cold. Preferably, the system may include a display to indicate the time remaining for washing, using a countdown method for example: 9 minutes to finish, 8 minutes, 7, 6 . . . etc.

In time, the system learns the characteristics of water supply and use, and may use the measured time variables to estimate the remaining hot water supply.

b. The water is stopped immediately when the user so commands the system.

c. Pre-programmed mode—the system is programmed in advance to supply water for a predefined time period. When the time period ends, the water is closed. Preferably, a warning is given to user that the water will be shut up. The warning may precede the action by a predefined time interval, for example one minute, 5 minutes, etc., any combination of the above (a-c).

This mode may be practical for hotels or where there is a water shortage and it is required to save on water. This mode in optional and should be used with caution, so as not to irritate customers by its application when not really necessary or justified.

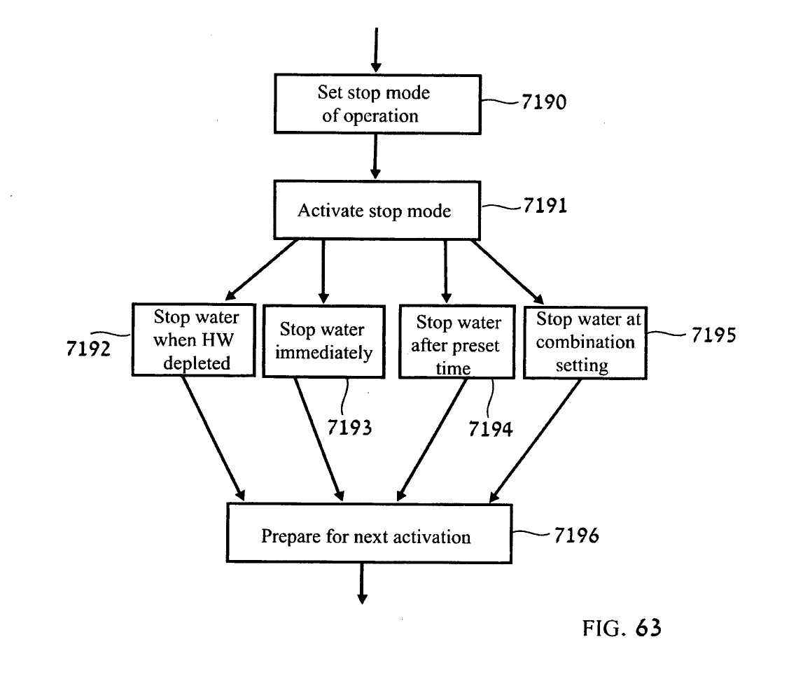

FIG. 63 illustrates a stop water delivery strategy corresponding to the present step (3), including:

set Stop mode of operation 7190

activate stop mode 7191

stop water when HW depleted 7192

stop water immediately 7193

stop water after present time 7194

stop water at combination settings 7195

prepare for next activation 7196

4. In a preferred embodiment, when there is circulation, then all the users are shut off—there is no water supply to any user. Water supply to users only commences when circulation stops.

5. Close the water supply if the temperature is too high, to protect the user from possible injury.

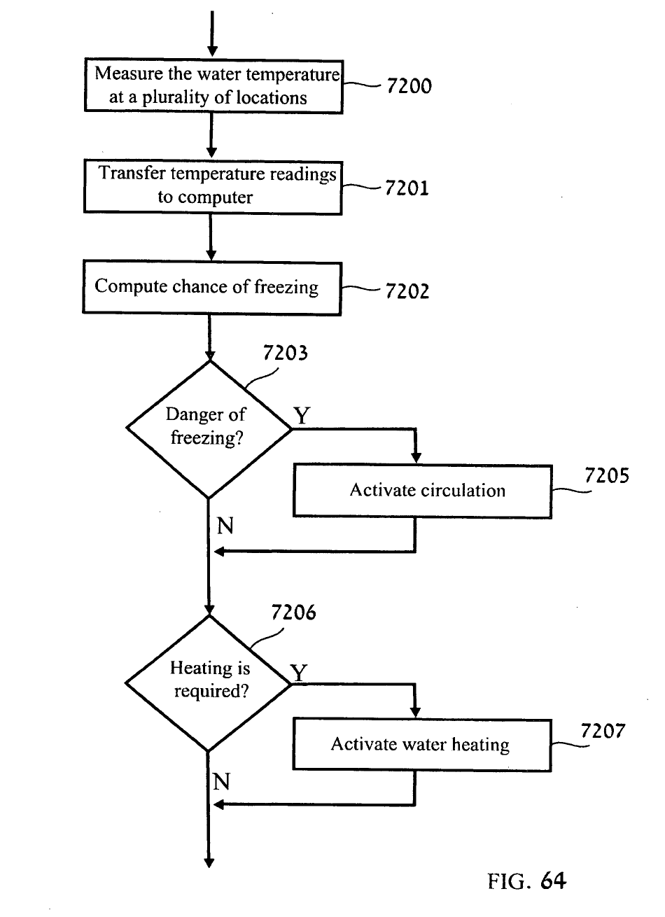

A method for preventing water from freezing in pipes is illustrated in FIG. 64. The method may use the system with water temperature measurement and water circulation as detailed in the present disclosure, in its various structures. Additional temperature sensors may be installed in the water pipe in location prone to freezing, these being connected to controller means or other automatic decision means.

The method includes:

1. Measuring the water temperature in a plurality of locations in the water pipes of a domestic, industrial or commercial establishment. The temperature readings are transferred to controller, computer or other automatic decision means.

Measure the water temperature at a plurality of locations, 7200

Transfer temperature readings to computer, 7201

2. If there is an imminent danger of water freezing apparent in the temperature readings from a specific location, water circulation is activated in that specific location.

Optionally, heating is also applied. Often, just causing a movement in the water will suffice to prevent from freezing, even if the temperature is close to freezing point.

Compute chance of freezing 7202

3. danger of freezing? 7203

4. activate circulation 7205

5. heating is required? 7206

6. activate water heating 7207

Automatic water circulation means may also be used responsive to a low water temperature or to a rapid reduction in temperature, to prevent water from freezing in the pipes. The water circulation may be applied selectively, to locations prone to freezing, for example using the valves as detailed herein to form a water circulation loop while preventing water from flowing out.

It is a particular feature of the systems structure that additional temperature sensors can be installed in the water pipes in locations prone to freezing, with the additional proviso that these locations are within the domestic water system—that is a circulation pump can be activated to circulate the water in these locations. Additional water loops may be created in difficult locations, k as will be apparent to a person skilled in the art. This structure helps prevent water freezing using circulation in the pipe.

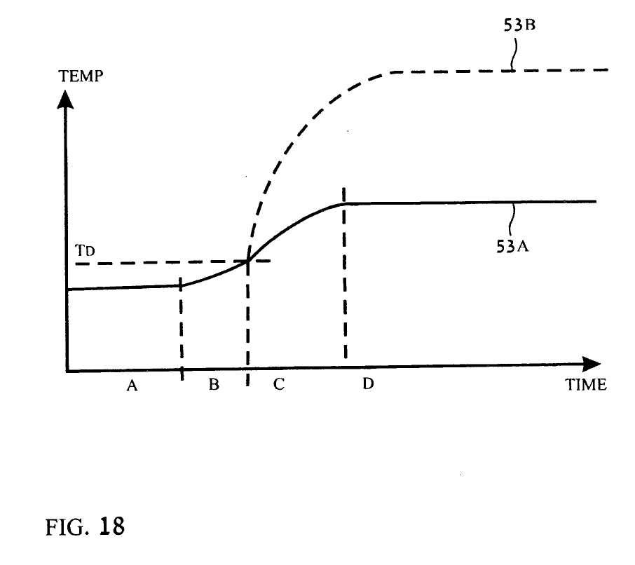

FIG. 18 illustrates the water temperature at the faucet during the circulation stage:

Stage A—water temperature is that of cold water, the hot water front did not arrive at the faucet yet.

Stage B—water temperature is rising.

Stage C—circulation is slowed down or stopped, temperature is rising at a slower rate

Stage D—circulation stopped, water delivery at constant temperature to user

This shows the importance of stopping the circulation on time, so as not to exceed the desired temperature.

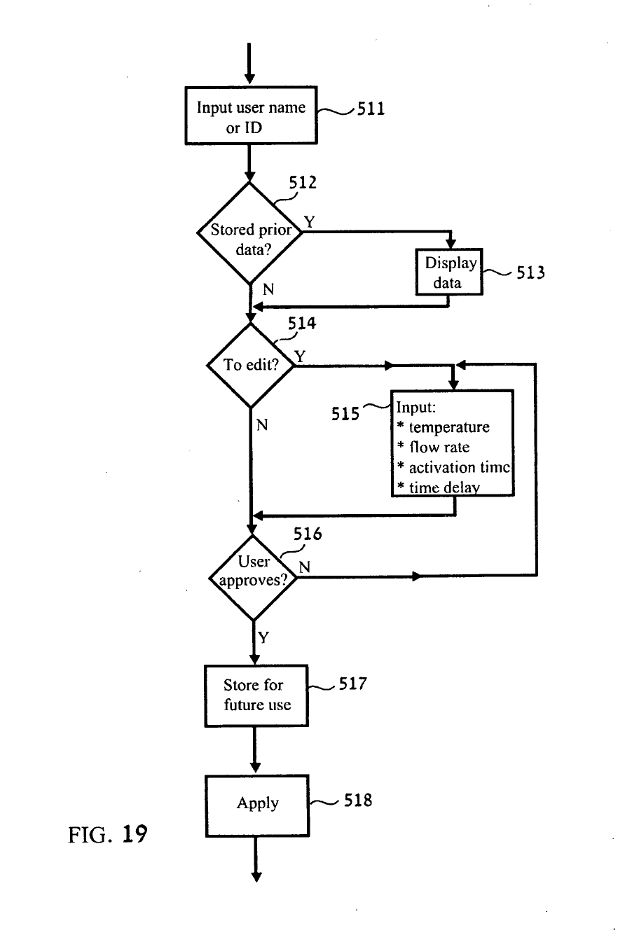

FIG. 19 illustrates a method for inputting user's order to supply hot water

This is part of the overall method illustrated in FIG. 17.

The method may be used for manual faucet or shower control with stored parameters.

Input user's name or ID 511

Stored prior data? 512

Display data 513

To edit? 514

Input: 515
temperature
flow rate
activation time
time delay

User approves? 516

Store for future use 517

Apply 518

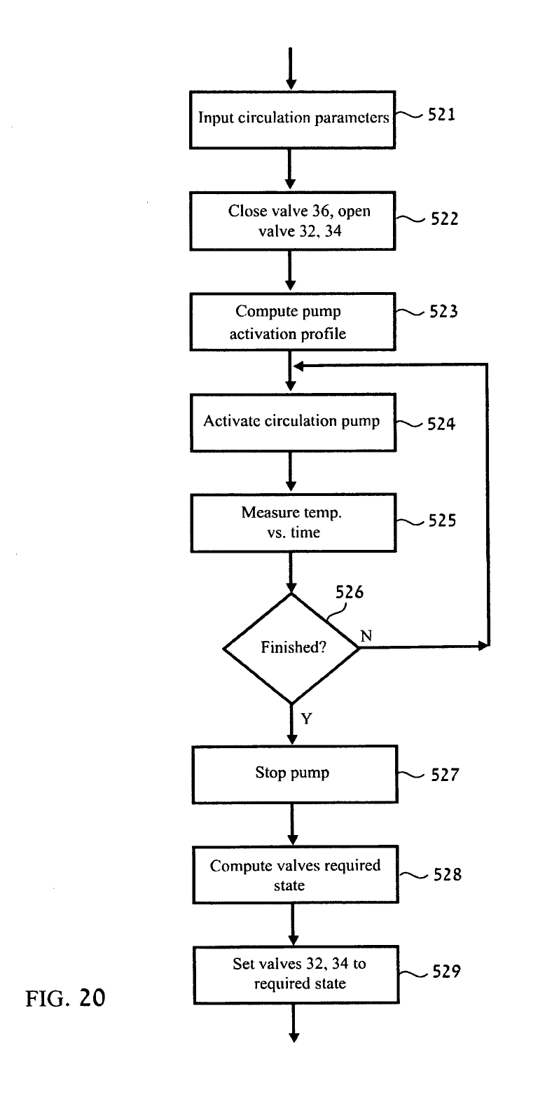

FIG. 20 illustrates a method for activating water circulation in the system, for delivering hot water while implementing the user's commands, including:

Input circulation parameters 521

Close valve 36, open valves 32, 34; step 522

Compute pump activation profile 523

Activate circulation pump 524

Measure temperature versus time 525

Finished ? 526

Stop pump 527

Computer valves required state 528

Set valves 32, 34 to required state 529

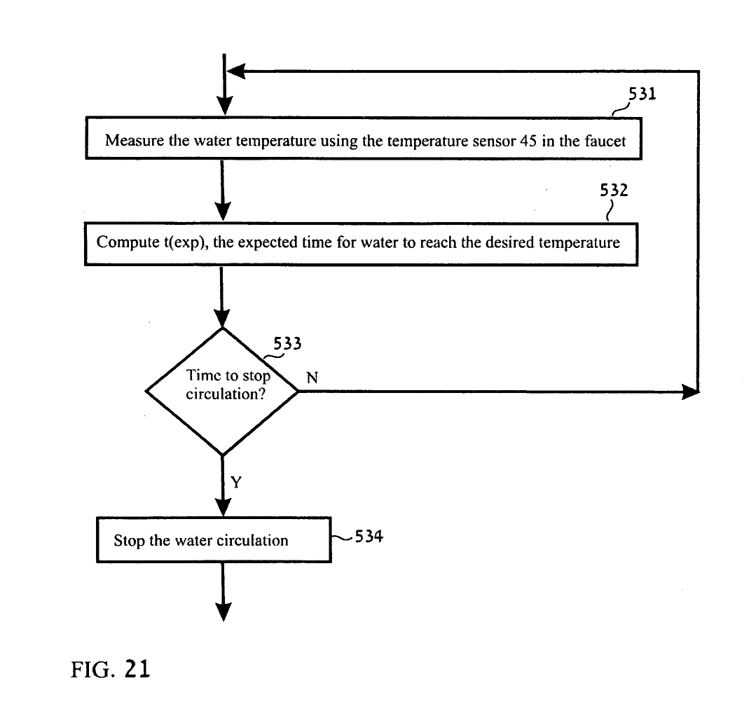

FIG. 21 shows the water circulation stopping process/method, comprising:

1. measuring the water temperature 531, using the temperature sensor 45 in the faucet, if two temperature sensors are used in the faucet (one at the hot water inlet, the other at the cold water inlet), then their readings may be advantageously used to better measure the temperature gradient in time and space.

The system may display the time remaining until water is ready and available to the user, for example based on prior experience. The system may measure the time required until hot water arrive to each faucet. When a user requires hot water, this value may be presented.

2. compute (exp) 532, which is the expected time for water to reach the desired temperature.

In a first embodiment, first order estimation: compute the rate of temperature change over time, dT/dt, the slope of the graph T=f(time) in FIG. 5.

In other embodiments, higher derivatives of the T−f(time) function may also be used. This may achieve better performance, since the graph T=f(time) may not be linear.

3. time to stop circulation? 533

In a simple embodiment, check whether water a faucet reached the desired temperature, then it is time to stop the circulation.

In a more advanced embodiment, there is a parameter in the system.

T(stop)=the time required to stop the water circulation, taking into consideration the inertia of the moving (flowing) mass of water and the response time of the circulation pump and the valves.

When the Expected time t(exp) equals the stopping time t(stop), it is time to stop circulation.

the goal is to stop the circulation in time, so that the water temperature at the faucet 3 will not exceed the desired temperature.

4. stop the water circulation 534

In one embodiment, the circulation is stopped abruptly, to allow the use of a simple, low cost circulation pump and simple control means. A simple ON/OFF control in used. In another embodiment, the circulation is not stopped abruptly, as this may cause excess pressure or stress in the pipes and on the system components. If necessary, the circulation pump and/or the circulation valves 32, 34 are so activated as to gradually stop the circulation, at a desired rate according to engineering consideration.

Another consideration is the temperature rate of change, dT/dt. If the rate is high, stopping the circulation suddenly may cause an error in the faucet temperature—a small error or variation in the timing causes a large error in temperature. Gradually slowing down the rate of circulation provides better control over the final water temperature at the faucet when the circulation stops.

Preferably, the system uses a circulation pump 41 of a type which allows water to flow there through when the pump in not activated. This is an important functional and engineering consideration, as it will allow cold water to flow into the tank and thence to supply hot water even when the pump is not activated—the system working in the usual way. This in the mode of operation after hot water reaches the faucet and circulation is no longer necessary. One preferred embodiment for the circulation pump 41 is a centrifugal pump.

FIG. 64 illustrates an embodiment of the method of the invention for stopping circulation, including:

a. The circulation pump 41 is deactivated—deactivate circulation pump 7210

b. after a time delay—close the valves 32 and 34 to gradually stop the water circulation. In another embodiment, it may be desirable to optimize the use of energy (to save energy). In this case, valves activation (opening and closing valves) is minimized. For example, to stop circulation—stop the circulating pump and wait for water to stop moving, without changing the settings of the valves.

Then set the valves to the desired setting to supply water to the outlet, at the desired flow and temperature as in (c). The point is not to close the valves, in order to save energy.

wait predefined delay 7211

delay ended? 7212

close HW, CW valves 7214

c. after a time delay—adjust the valves 32 and 34 to the desired output flow and temperature wait predefined delay 7215

delay ended? 7216

adjust HW, CW valves 7217

d. open the output valve 36, only after the valves 32 and 34 settle at their desired settings and (optionally) after the user approves to open the water supply.

Open OW 7218

In another embodiment of the method, circulation is stopped by deactivating the pump 41; the valves 32 and 34 are then directly set to the desired output flow and temperature, skipping the step (b) of closing them.

In a preferred embodiment, valves 32 and 34 can be continuously adjusted, whereas valve 36 is ON/OFF (ON to supply water to user, OFF for water circulation). In another preferred embodiment, valves 32 and 34 are adjusted almost continuously, that is in fine steps, using a stepper motor for each valve, for example.

The above variations in the apparatus structure and method of operation may be used in various combinations, as will become apparent to people skilled in the art, to activate the benefits of each such embodiment as necessary.

The choice affects both performance and cost.

A method for taking into account prior orders and also occasional users comprises:

a. taking orders, learning habits of use of hot water.

b. activating the heater in the hot water tank to heat the water as required (optional). Various means may be used to heat the water: solar energy, gas, electricity or a combination thereof.

c. hot water supply, stage 1—preparation
opening circulation valves in the faucet and then activating the circulation pump, where desired.
stopping the circulation
Optional: activating a READY indicator, when hot water at the desire temperature is available for immediate use.

d. hot water supply, stage 2—delivery
adjusting circulation valves to required rate of outflow and temperature
opening the output valve
continuous, automatic adjustment of the valves to keep flow at desired rate and temperature, despite disturbances in the system—changes in water pressure, us of water by other customers, changes in hot/cold water temperature, etc.
changing flow parameters as requested by customer: flow rate, temperature
stopping the water delivery (closing the faucet).

optionally, a display or an audio warning may be presented before water supply begins.

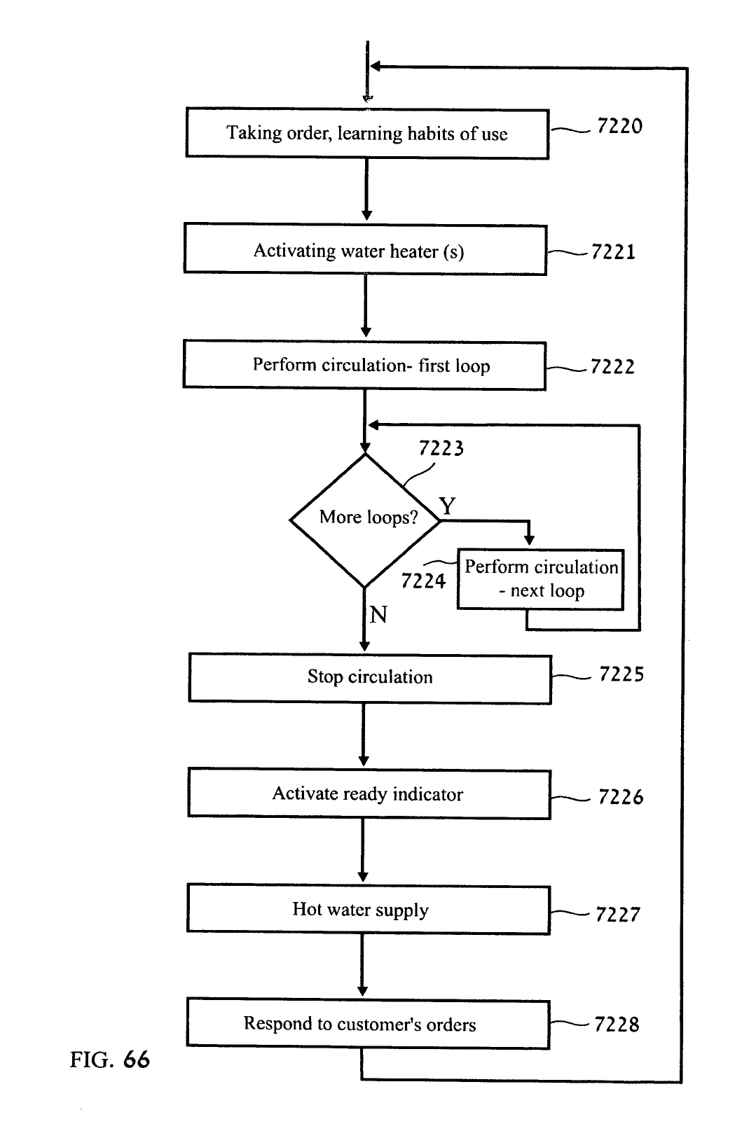

FIG. 66 shows a method of multi-user water circulation control and performance, including:

a. taking order, learning habits of use 7220

b. activating water heater(s) 7221

c. perform circulation—first loop 7222

d. more loops? 7223

e. perform circulation—next loop 7224

f. stop circulation 7225

g. activate Ready indicator 7226

h. hot water supply 7227
adjust valves to rate of flow and temperature
open output valve
automatic adjustment of water flow

i. respond to customer's orders 7228
change flow rate, temperature
stop water supply
display info

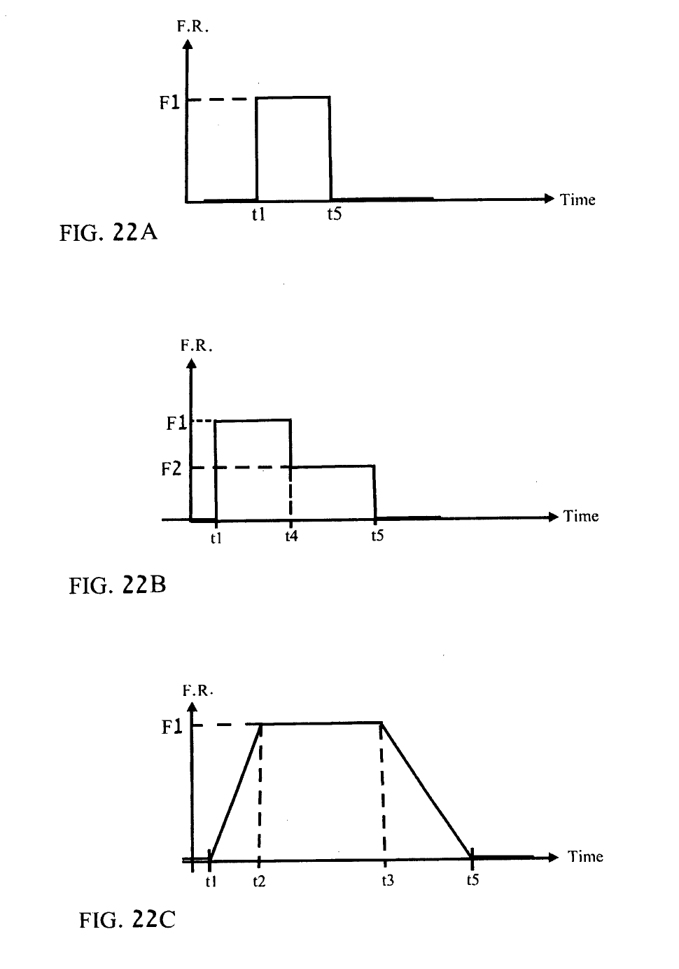

FIGS. 22A, 22B, 22C illustrate three possible methods for controlling water circulation. A problem in prior art is time a user has to wait until hot water arrives at the faucet; in the present invention, a possible issue to be addressed is the water circulation time until hot water arrives.

There is a tradeoff to make: the higher the Flow Rate FR during circulation, the shorter the time of the circulation stage. However, for a higher Flow Rate, it is more difficult to stop the circulation on time, when the water at the faucet is at the desired temperature.

It may be undesirable to start/stop suddenly a column of water at a high value of flow rate; this may cause a shock wave in the water which may damage pipes or components of the installation. Still, an ON/OFF (bang-bang) controller of the circulation pump may be used where practical from technical/engineering consideration in view of the system requirements.

Method 1 for water circulation using one FR value

a. FIG. 22A illustrates a system with one value F1 of flow rate; a high FR in applied at time t1, by activating a circulation pump for example;

b. at time t5, when hot water arrives at the tap, FR is cut off.

In one embodiment, t5 is the expected time for hot water to reach that faucet.

In another embodiment, t5 is the time when the measured hot water temperature at the faucet reaches the desire temperature.

In yet another embodiment, t5 is the time when the measured hot water temperature t the faucet starts to rise, where the faucet's parameters in real time may be used to decide, when to stop circulation taking into consideration the time elapsing the tap temperature reaches the desired temperature.

Because of the relatively slow reaction of tap water flow control and the inertia of the column of water there, it may take some time for water to reach that point; therefore the time t5 is set to a smaller value than the time it takes for the hot water to reach the tap; circulation can be stopped before the hot water temperature reaches the desired value, anticipatory of further temperature raising because of the above factors.

Thus, the value of time t5 may be set by calculus, measurements or a combination of both. Various degrees of algorithm complexity may be employed.

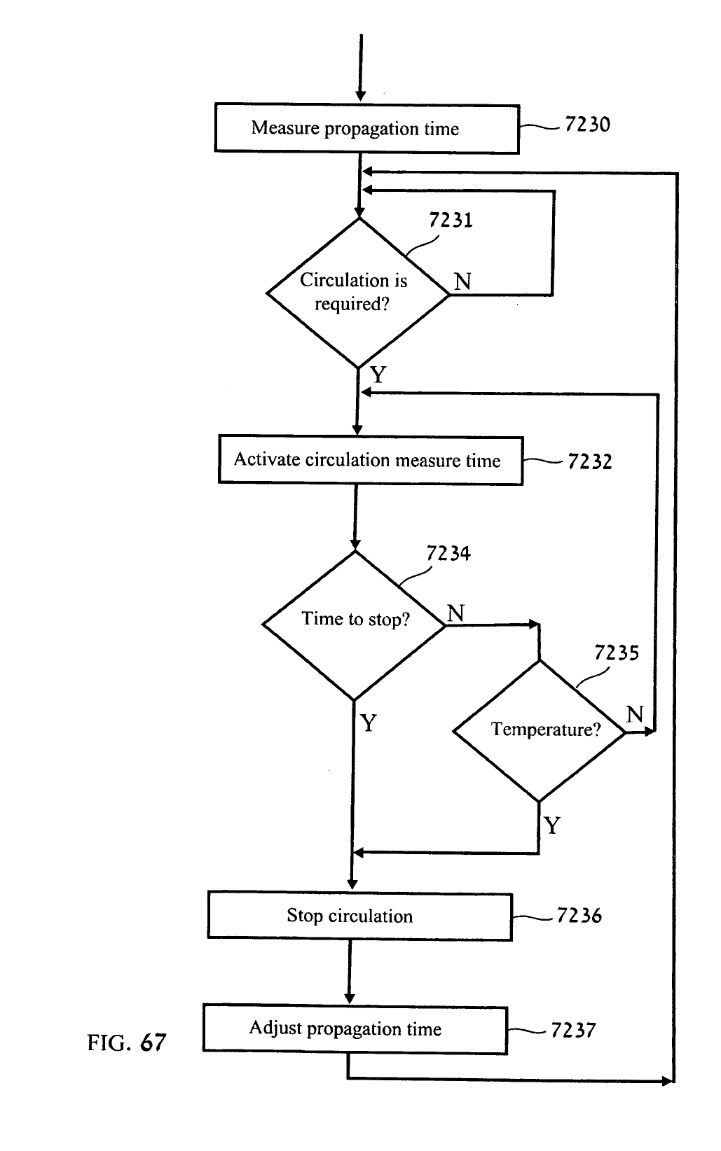

FIG. 67 depicts a method 1B for water circulation using one FR value, which can be advantageously used for controlling circulation flow rate using ON/OFF control. The method includes:

Measure propagation time 7230

compute t5

circulation is required? 7231

activate circulation 7232

measure time

time to stop? 7234

t=t5?

temperature? 7235

stop circulation 7236

adjust propagation time 7237

Notes:

1. time to stop t5 may be different than that of arrival of hot water front; this because to time transients; which can also be measured in the initial stage 7230—it may take an additional time.

2. stop on temperature—it may raise faster than anticipated or than usual;

In any case the circulation should be stopped so as not to exceed the desired temperature at the outlet.

3. take into account the rate or temperature raising (differential of temperature vs. time).

4. in a multi-user environment, t5 time value may take into account previous circulation activations and the installation topography—there may already be hot water in the pipes, so a shorter circulation time period may be required. This may be taken into account by the control system while performing circulation for the present faucet or device requiring hot water.

Method 2 for water circulation using two FR values

a. FIG. 22B illustrates a system with two values F1, F2 of the flow rate of the circulation pump. The system may be implemented, for example, with the pump's motor having input controls for setting the velocity to one of the values, and the electronic controller for activating one of the two values F1, F2 or none, as required.

Preferably, the values F1, F2 should be set according to system considerations to save energy, to bring hot water the faster to a faucet, to reduce costs or a combination of these considerations.

b. Initially, a high flow rate F1 is activated starting at time t1 (when the system initiates water circulation), in order to bring faster the hot water to the tap.

c. When the system expects that circulation will end shortly, the flow rate is reduced to a lower value F2, at time t4.

Again, various algorithms and/or measurements may be used to determine the value of the time t4.

d. Stopping the circulation at time t5.

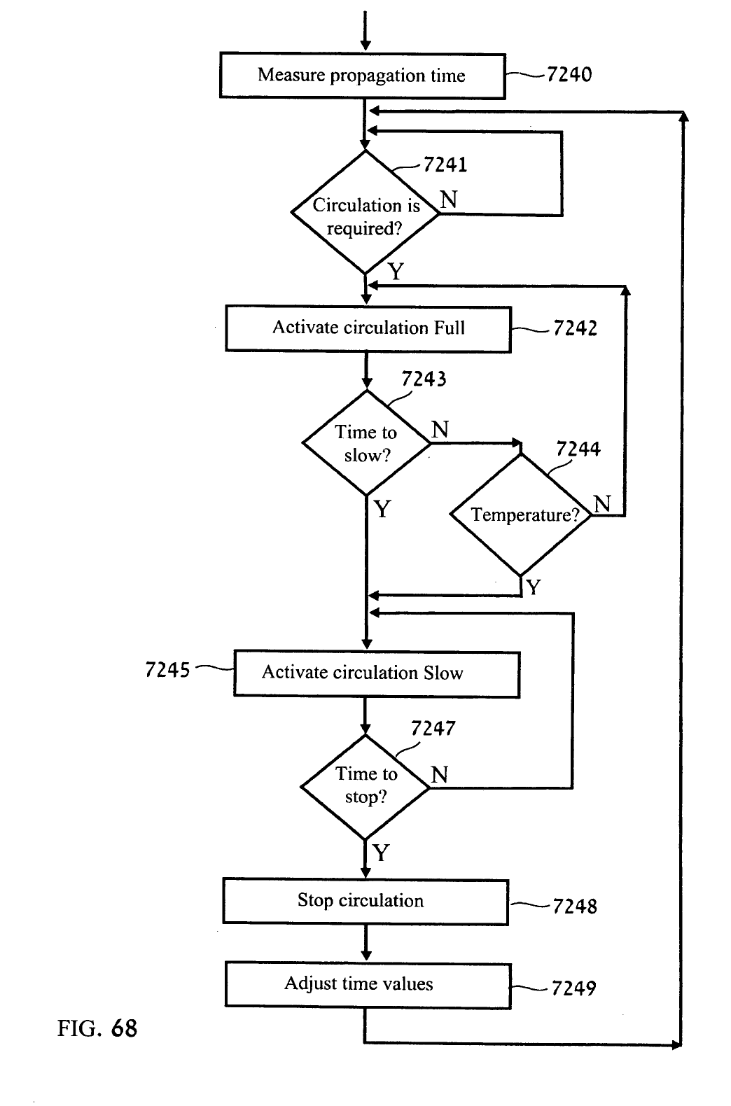

FIG. 68 depicts a Method 2B for water circulation using two FR values. The method is used for controlling circulation flow rate using Full ON/Slower/OFF control values.

measure propagation time 7240

compute t4, t5

circulation is required? 7241

activate circulation full 7242

measure time

time to Slow? 7243

t=t4 ?

temperature ? 7244

activate circulation Slow 7245

measure time

time to stop? 7247

t=t5 ?

stop circulation 7248

adjust time values 7249

optional

Method 3 for optional control of the water circulation:

a. FIG. 22C illustrates a system with continuous control of the flow rate of the circulation pump. The control approach can bring hot water to the tap in the shortest time, at high precision—circulation stops when water at the desired temperature reaches the tap/faucet/shower.

b. Initially, the flow rate is increased fast, starting at time t 1 (when the system initiates water circulation), until time t2 when the maximal value of FR in reached. Optionally FR is increased gradually at a controlled rate; alternatively, the pump is set to maximal FR, ant the time t1 to t2 is just due to the inertia of the pump and water column to move.

c. Maximal FR in maintained for just the required time, from t2 to t3, to achieve the required circulation while allowing for the subsequent gradual stopping of the flow in the next stage.

d. Stopping gradually the circulation, from t3 to t4. The law of the function FR=f(time) if controlled by optimal control considerations as known in the art, to address requirements of desired electrical power dissipation on the pump, maximal temperature error and total circulation time, under the constraints of pump characteristics and maximal FR value, and as required based on technical/engineering consideration.

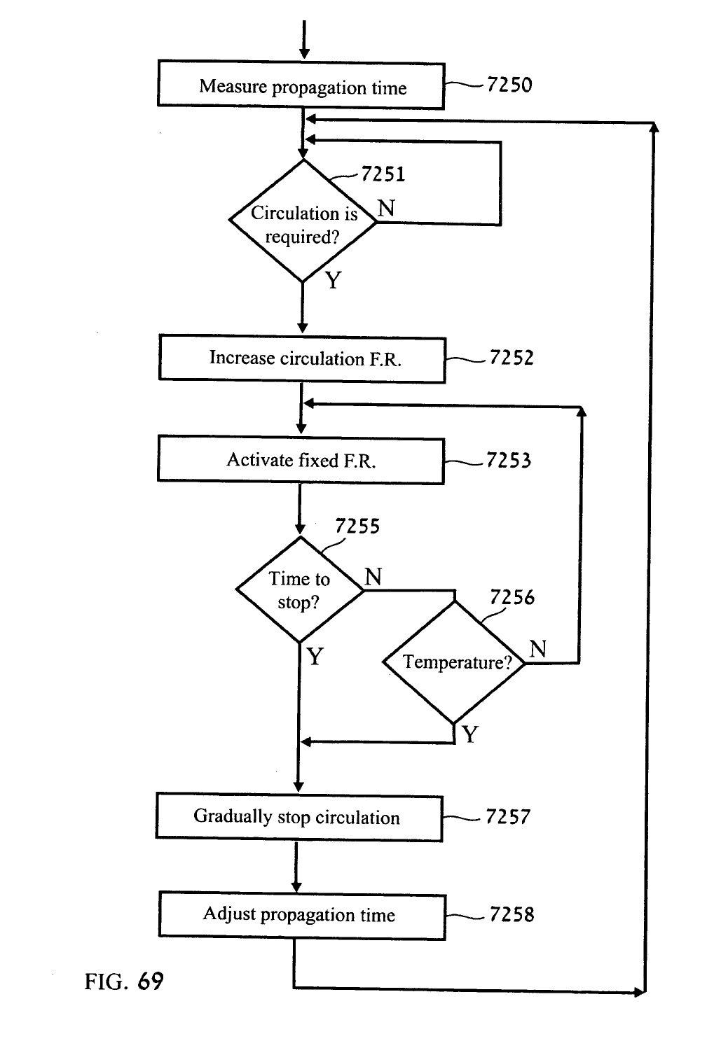

FIG. 69 depicts the Method 3B for optimal control of the water circulation. The method can be used for controlling circulation flow rate using Smart flow control.

Measure propagation time 7250

the time for the hot water front to travel through the hot water pipe, from the boiler to a specific faucet or outlet.

circulation in required? 7251

increase circulation F.R. 7252

gradually, according to plan

activate fixed F.R. 7253

full rate

time to stop? 7255

temperature? 7256

gradually stop circulation 7257

also taking into account measured temperature

adjust propagation time 7258

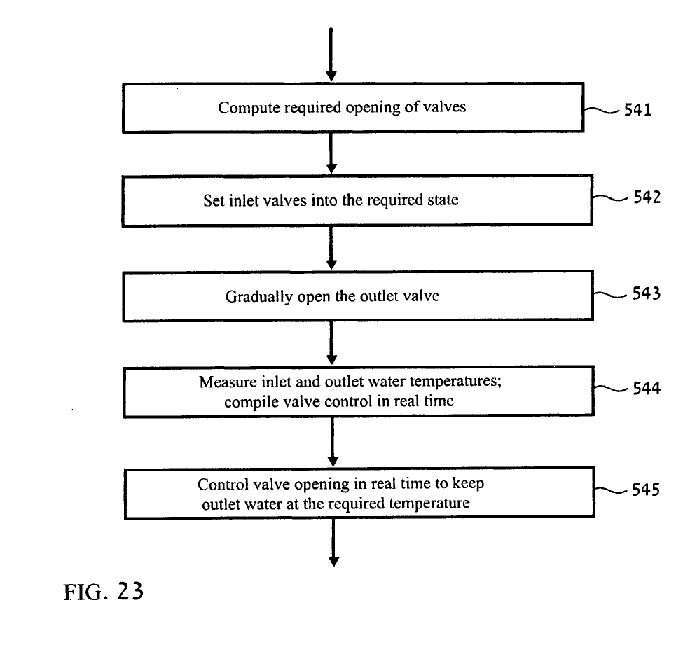

FIG. 23 illustrates a Method for starting to supply water, comprising:

compute required opening of hot and cold inlet valves; 541

required opening of outlet valve

set inlet valves into the required state 542

gradually open the outlet valve 543

measure inlet and outlet water temperatures; 544

compile valve control in real time

control valve opening in real time to keep outlet 545

water at the required temperature

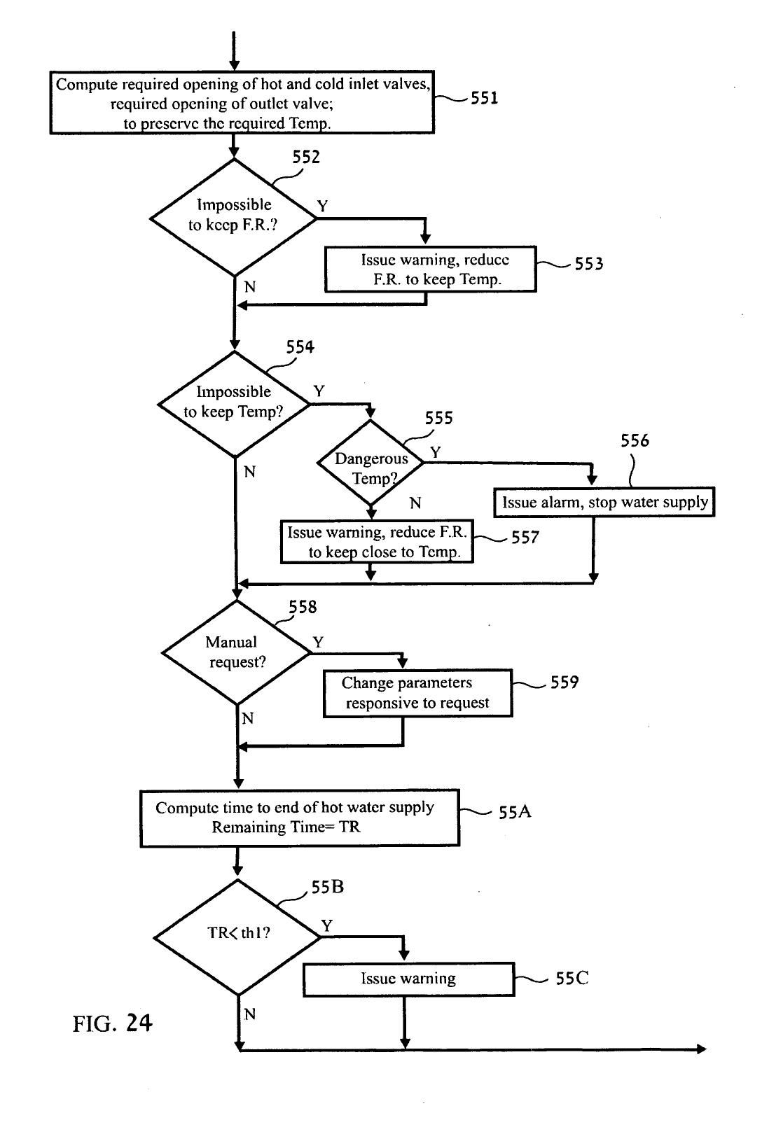

FIG. 24 illustrates a method for supplying water at faucet, comprising:

compute required opening of hot and cold inlet valves, 551

required opening of outlet valve;

to preserve the required Temp, F.R.

impossible to keep F.R.? 552

issue warning, reduce F.R. to keep Temp. 553

impossible to keep Temp. ? 554

dangerous Temp? 555

issue alarm, stop water supply 556

issue warning, reduce F.R. to keep close to temp. 557

manual request? 558

change parameters responsive to request 559

compute time to end of hot water supply 55A

Remaining Time=TR

TR<th1? 55B

Issue warning 55C

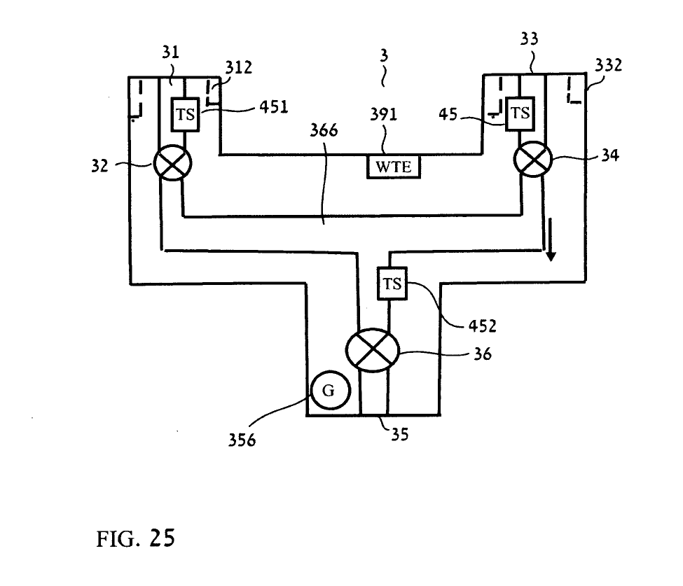

One embodiment of the present micro valve of faucet 3 is illustrated in FIG. 25. The control unit (not shown) is connected to, and controls the operation of, the cold water valve 32, hot water valve 34 and output water valve 36. The control unit may also receive signals indicative of the measured temperature from the temperature sensors 45, 451 and 452.

Preferably, the sensor 45 is immersed in water, to achieve a fast response and to measure the temperature in the water, preferably the incoming hot water; a sensor mounted in the structure of the faucet itself may not be satisfactory, as it may have a time delay in the measurement. The other sensors 451, 452 may also be immersed in water. The cold water inlet 31 and hot water inlet 33 each has thread 312 and 332, respectively to connect to the cold and hot water pipes. Other connecting means may be used rather than a threaded pipe, for example a snap-on connection. Water is supplied through the water outlet 35.

Optionally, an electricity generator 356 may be mounted at the water outlet 35 or in another location in the faucet, to convert water flow energy into electrical energy. The energy thus generated is used at the faucet to supply it with electrical energy. The energy thus the generated may be used to charge secondary (rechargeable) batteries there, which are the source of the unit 42 and the other electronic means there.

Other energy generation means may be use, for example based on Peltier-Seebeck effect (hot/cold water temperature differential) or other type of generator.

Alternately, low voltage wiring within the walls may be used to supply each faucet with electrical energy. If such wiring is used, it may also be use to transfer information from the sensors, as well as various data and commands between the components of the system. A low voltage is preferable as it may not pose a danger to users, in case of malfunction.

The system may use wireless communications between the faucets or other water flow control means and other parts of the system, as presented by way of example in the present disclosure.

This description includes a wireless communications system for information or data, and electric power generating means in the faucet for providing the power for operating device.

In a preferred embodiment, the only temperature sensor being used is sensor 452 at the output 35 of the faucet (at the water supply to user).

In a preferred embodiment, the valves 32 and 34 have variable rate of flow, which may be controllably by the control unit through control signals. The output valve 36 is preferably of an ON/OFF type—it is turned OFF when the faucet is not used or during water circulation; it is turned ON to supply water to the user.

The valves 32, 34 are further detailed with reference to FIG. 10-13; the valve 36 may be installed at the water outlet 35 of the unit in FIG. 10. The valves 32, 34 may be implemented as two plungers active in the mixing chamber 366. The valve unit may include one to three sensors. The valve unit may include various sensors, besides the temperature sensors. These sensors include pressure, water flow rate, etc. In a preferred embodiment, a micro valve unit includes valves 32 and 34, for controlling the cold and hot water inflow, see FIGS. 10 and 14.

Preferably, the unit in FIGS. 10 and 14 does not include valve 36, which is attached at the output unit there. Preferably, the unit has a standard diameter, to fit in existing faucet infrastructure, for example a battery faucet, a wall-mount faucet or a deck-mounted faucet.

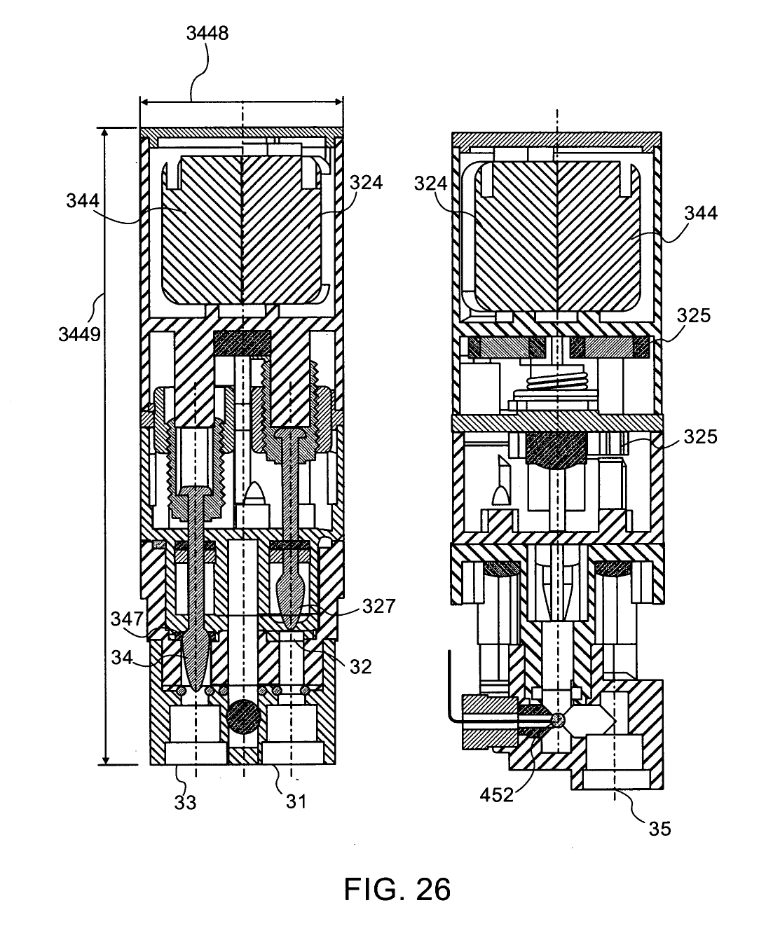

FIG. 26 illustrates two cross-sectional longitudinal views of a preferred embodiment of the micro valve, detailing the cold water inlet 31 and hot water inlet 33, and the water outlet 35. The hot water valve 34 is shown in its fully closed state, and the cold water valve 32 is shown in its fully opened state. A temperature sensor 452 may be mounted at the output of the device.

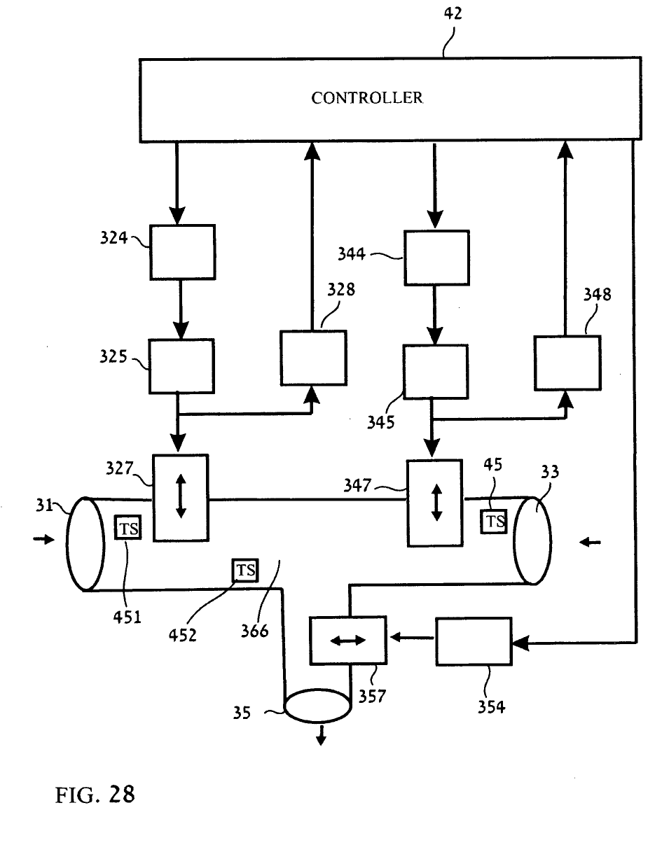

The device uses plunger means 327, 347 and electrical motors 324 and 344 with optional transmission means 325 and 345 to control the water flow, see also FIG. 11. A particular feature of this structure is the use of plungers with a mixing chamber 366, see FIG. 28.

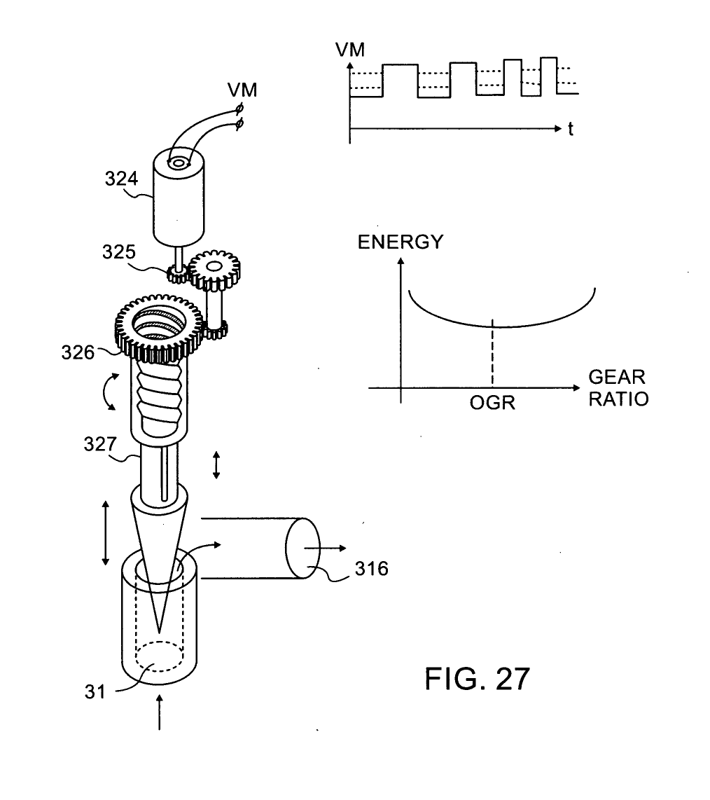

FIG. 27 depicts an exploded view of a valve structure. This valve may be used, for example, in the faucet structures of FIG. 9, 10 or 12. Electrical motor 324 acts upon the transmission means (gear) 325 to rotate the part with inner thread 326. This rotation causes the plunger 327 to move up (to open the valve) or down (to close it). Also shown are the cold water inlet 31 (in this example; the same structure may be implemented for the hot water), and the valve outlet 316 toward the mixing chamber 366, see FIG. 28.

The electrical motor 324 may be pulse activated as illustrated with the graph of Vm versus time. The duty cycle of the voltage may change. The polarity may be reserved to reverse the direction of movement. In another embodiment, a stepper motor may be used. The gear ratio of the gear between motor 324 and plunger 327 may be so devised as to minimize the mechanical energy required to move the plunger 327. As illustrated in the graph, there may be an optimal gear ratio for maximal performance, where there is optimal matching between the impedance of the source and the load, also taking into account the water pressure in inlet 31.

A possible issue with this embodiment is the water pressure in inlet 31, which opposes a down movement of plunger 327. A possible solution may be a loaded spring to always push the plunger 327 down, to counter the force of the water pressure; the motor 324 then only has to provide the differential force (a lower value force) to move the plunger 327 up or down.

Another solution is illustrated in FIG. 21, which depicts an embodiment wherein the water flows in the opposite direction, from 316 toward 31; in this case, water pressure will not oppose the closing of the valve.

FIG. 28 illustrates a functional cross-sectional view of a preferred embodiment of the present micro valve, depicting the cold water inlet 31 and hot water inlet 33, and the water outlet 35.

In one embodiment, the temperature sensors (TS) located as illustrated: TS 451 near the cold water inlet 31, TS 452 in the mixing chamber 366 and TS 45 located near the hot water inlet 33. The sensors are connected to the controller 42. In another embodiment, only the sensor 452 is used.

The electrical motor 324 acts upon the optional transmission means (gear) 325 to move the plunger 327, which controls the cold water supply from the cold water inlet 31. Similarly, the electrical motor 344 acts upon the optional transmission means 345 to move the plunger 347, which controls the hot water supply from the hot water inlet 33. Water from the hot and cold inlets will mix in the mixing chamber 366, the result being water at the desired temperature which flows out outlet 35.

Flow to the outlet 35 is controlled by means 357 comprising water flow control means as known in the art. The means 357 in moved by an actuator means 354, for example a solenoid. In a preferred embodiment, means 357 has only two positions, ON or OFF. A possible ON/OFF valve may use a membrane valve.

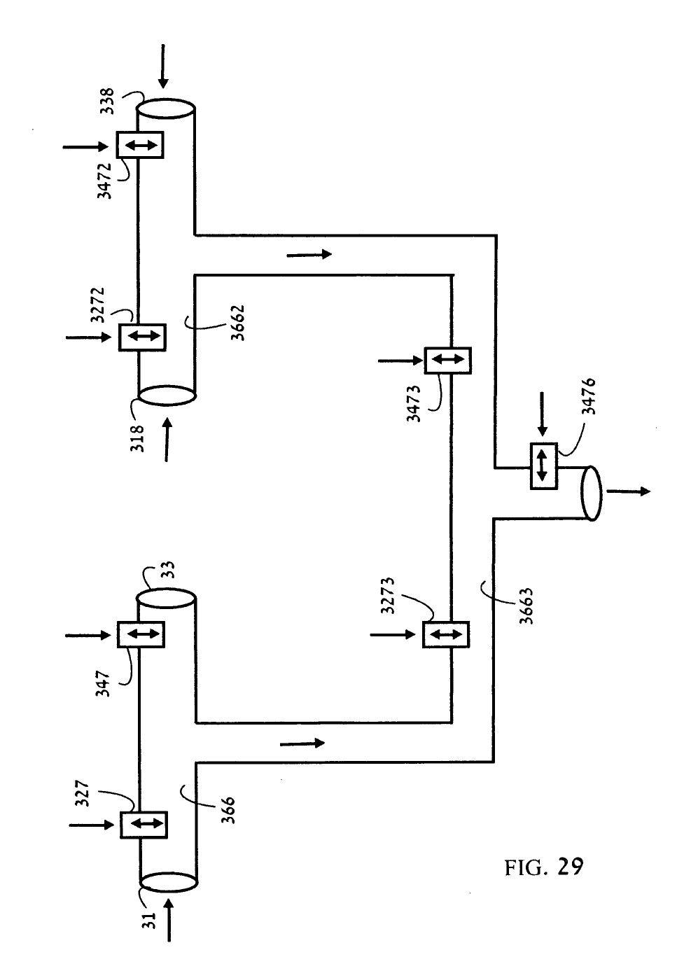

FIG. 29 illustrates a cross-sectional view of a device for mixing fluids from a plurality of sources. For example, people may desire to use either potable water or sea water, then to mix hot and cold water. In this embodiment, hot water may use a fast heater on the pipe, such as an instantaneous gas heating device. For example, a sea water (cold) inlet 318 and (hot) inlet 338, with plungers 3272 and 3472 controlling the inflow of fluids to mixing chamber 3662; a third unit with plungers and 3473, with the fluids being mixed in mixing chamber 3663. The output flow may be controlled with the plunger 3476 at the outlet of the device, as illustrated.

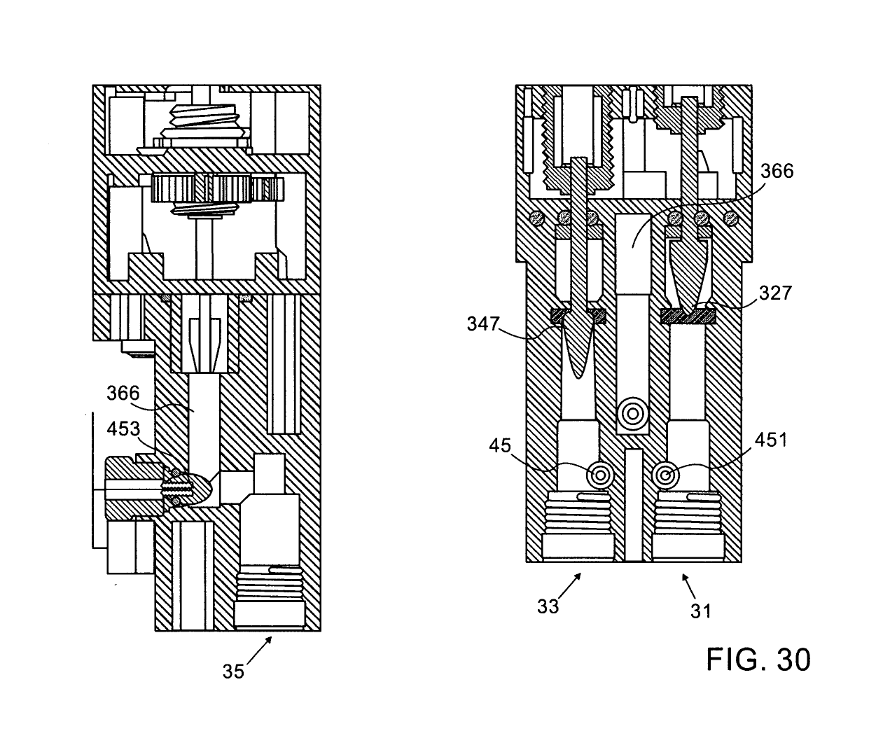

FIG. 30 illustrates two cross-sectional longitudinal views of yet another embodiment of the present micro valve depicting the cold water inlet 31 and hot water inlet 33. Also illustrated is the mixing chamber 366, where hot water is mixed with cold water when water is supplied to the user through the water outlet 35. In this figure, the hot water valve plunger 347 is shown in its fully closed state, and the cold water valve plunger 327 is shown in its fully opened state. Also illustrated are the temperature sensors 45, 451, 453 for the hot and cold water inlets, and the mixing chamber, respectively.

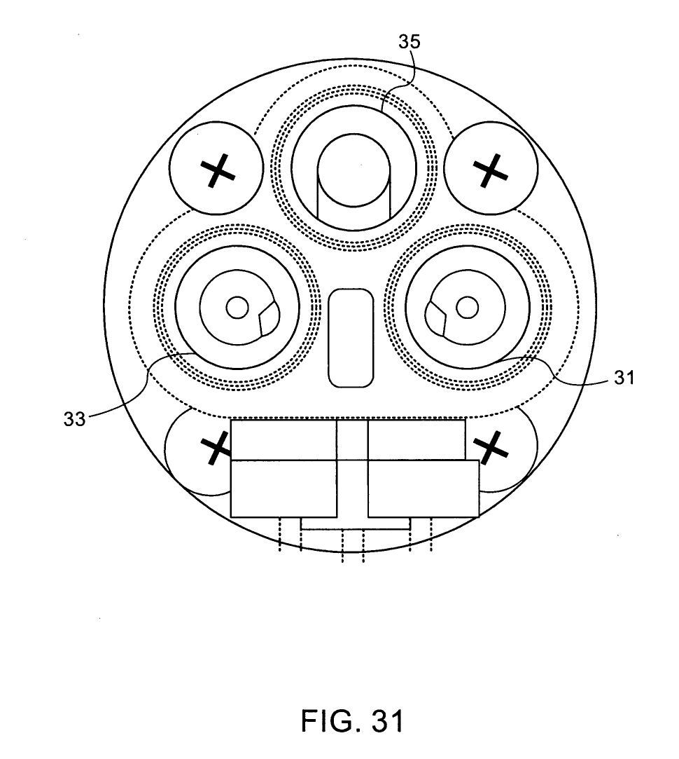

FIG. 31 shows a bottom view of the faucet, illustrating the cold water inlet 31, the hot water inlet 33 and the water outlet 35. Human-Machine Interface (HM)

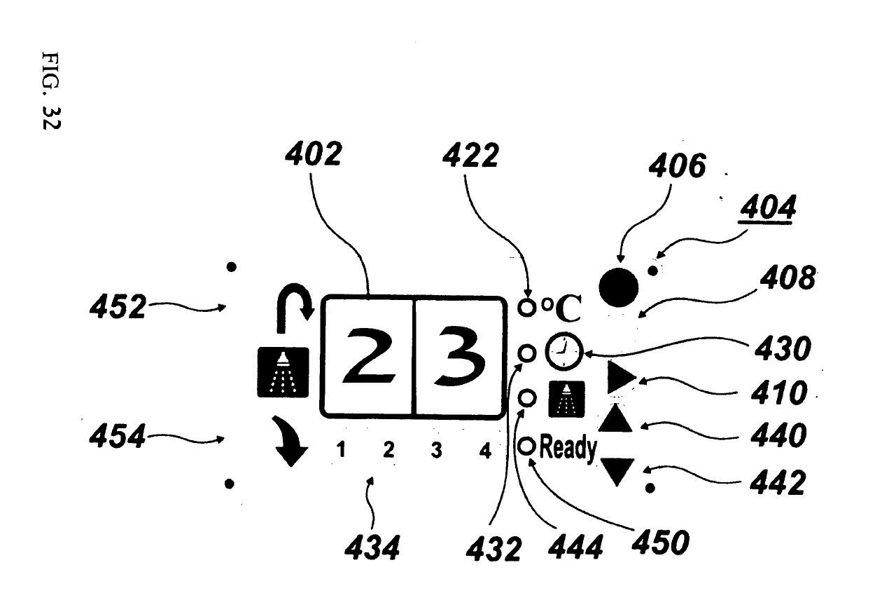

FIG. 32 illustrates an embodiment of a human-machine interface, more specifically a control and display panel usable for the unit 42 for controlling a hot/cold water tap of faucet. The panel may include a temperature readout 402, and hot and cold water selection buttons 406 and 408. If cold water is desired, pressing button 406 opens the cold water inlet valve. If hot water is desired, pressing button 408 will activate the cycling mechanism followed by the water delivery mechanism as detailed elsewhere in the present disclosure.

The temperature of hot water may be set using the function selection mechanism 410 and optional buttons. The temperature of hot water may be set using the function selection mechanism 410 and optional buttons. Optional buttons may include: a function selection mechanism 410 for selecting between different functions such as “temperature”, “time”, “flow”, etc; each function selected may be indicated by appropriate indicators 422, 432, 444, respectively; “Up” and “Down” buttons 440 and 442 used for changing up and down (setting) the value of a chosen function; a timer 430 for setting a desired water use time, a “time” indicator 432, memory means 434 for storing set temperatures and/or times, and outlet selection buttons 452 and 454 for selection one of two outlets.

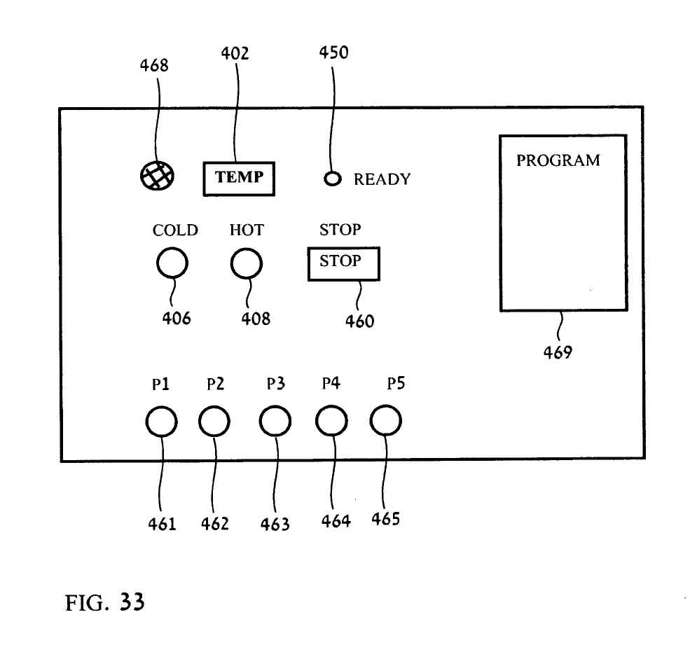

FIG. 33 illustrates another embodiment of the control panel. The panel includes a temperature readout 402, Ready indicator 450, hot water selection button 408 to supply water at a desired temperature, and cold water button 406 for selecting cold water. A stop button 460 may be used to immediately stop the water flow if activated. The programmed buttons 461, 462, 463, 464, 465, etc.—each will supply water with pre-programmed parameters including for example temperature. Flow rate, time of operation (optional—if to shut up the faucet automatically), etc. Thus, each user may program a button (or several buttons) with the programs they may use. The faucet is thus personalized for each user. A programming area 469 includes various buttons to program the faucet, for immediate or delayed delivery. The panel includes a temperature readout 402, Ready indicator 450, hot water selection 408 to supply water at a desired temperature, and cold water.

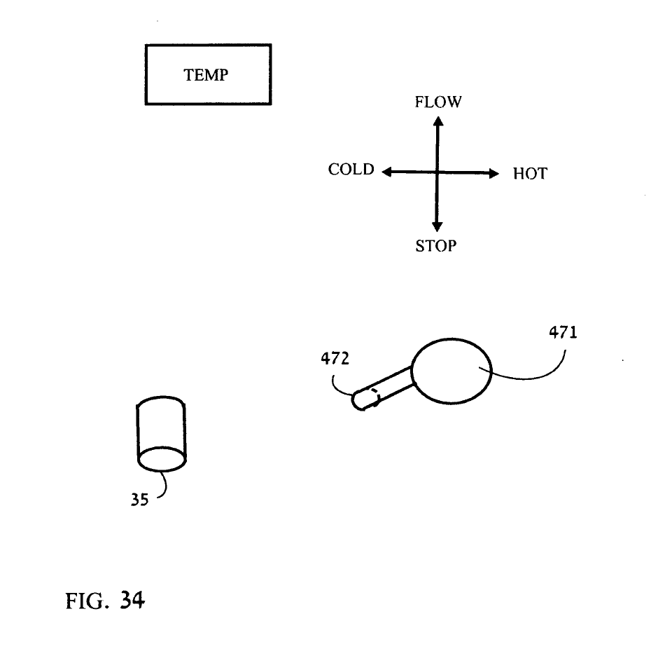

FIG. 34 illustrates yet another embodiment of the control panel, using a control level 471 with a rotary joint 472. Moving the lever Left-Right controls the temperature—more hot to the right. Moving the lever Up-Down controls the water flow, from fully stopped (down) to full rate flow (up).

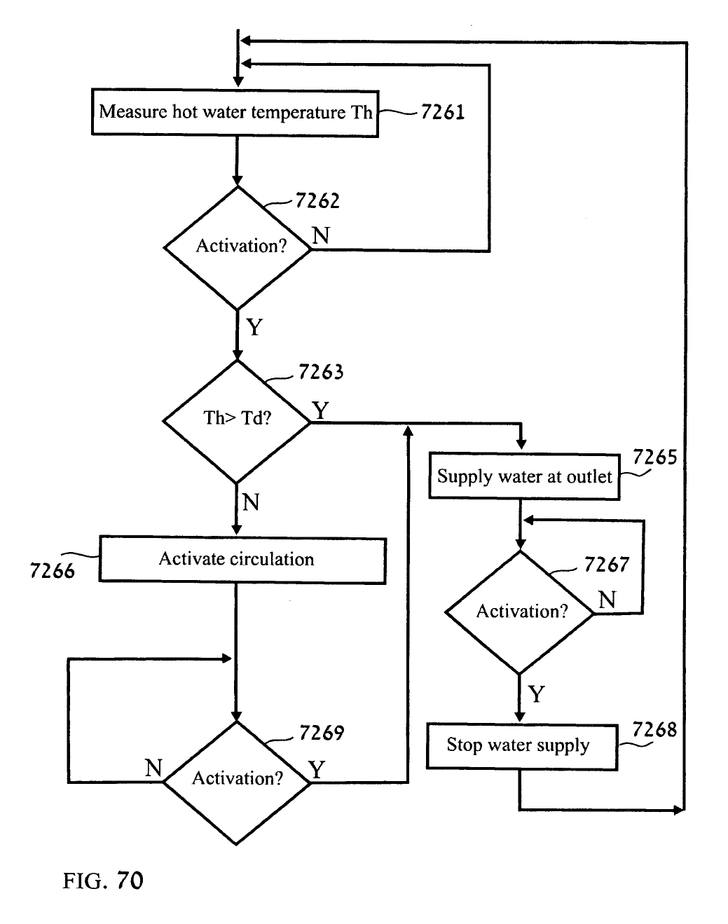

FIG. 70 depicts a method for hot/cold water activation using one pushbutton including:

measure hot water temperature Th 7261 at the water inlet

Activation? 7262

Th>Td? 7263

the hot water inlet is not enough?

supply water at outlet 7265

activate circulation 7266 until hot water arrive at faucet

Activation? 7267

stop water supply 7268

Activation? 7269

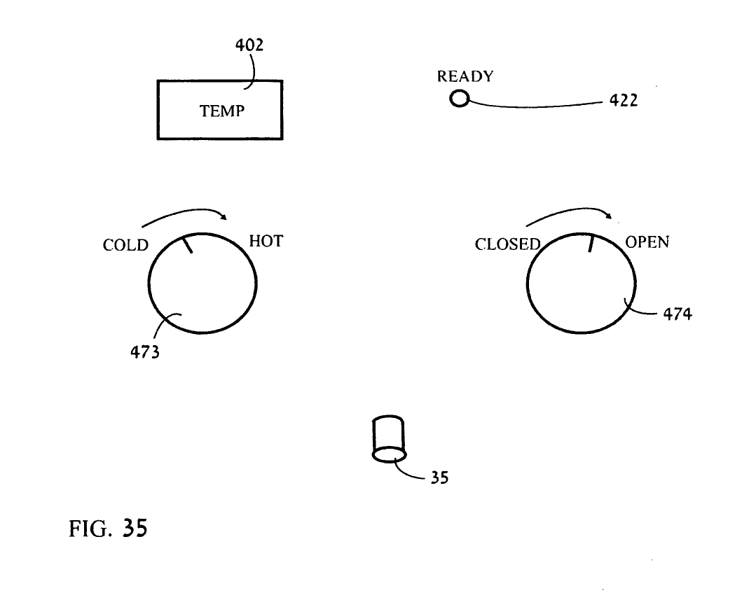

FIG. 35 illustrates yet another embodiment of the control panel, using two rotary controls: a temperature control knob 473 for setting the temperature to a desired value; a flow control knob 474 for controlling the rate of flow of supplied water. Push buttons may be used to replace the knob 474. A first touch or push may activate circulation and the second touch—water flow. The same knob can be used both to be rotated and pushed, to achieve faster operation of the control and to save space costs.

Method of Operation

a. the user selects a desired temperature using knob 473

b. the system activates water circulation, until hot water is ready at the faucet

c. the system sets the READY indicator 422, to signal that hot water is available.

d. When the flow knot 474 is rotated clockwise, water begins to flow.

The control input 474 may be a knob to be rotated, or push buttons to be pressed.

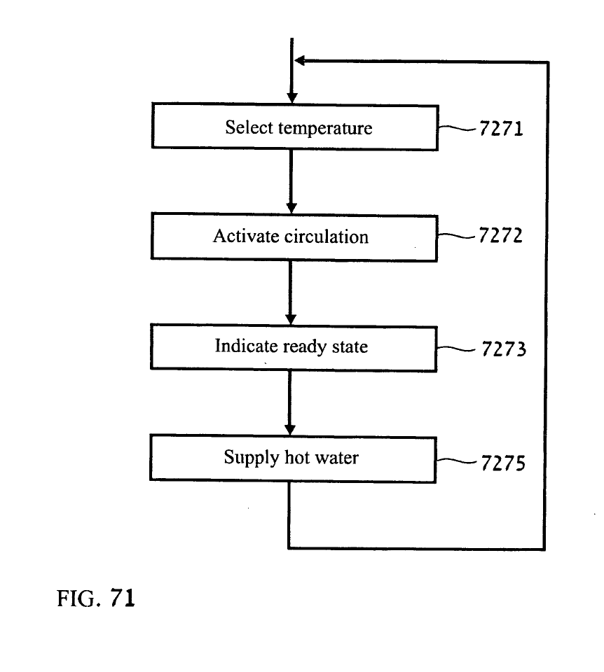

FIG. 71 depicts a method of control of the output water supply

Select temperature 7271

Activate circulation 7272 if necessary

Indicate Ready state 7273 To user

supply hot water 7275 as desired

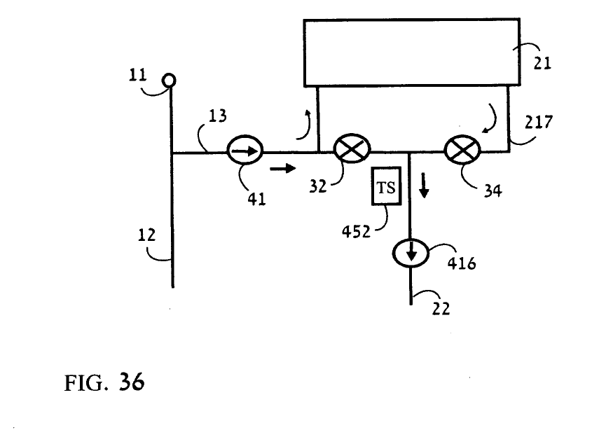

FIG. 36 illustrates a system for overall control of the temperature of the hot water supply to an apartment or house. Safety standards typically require limiting the temperature of the hot water supply, to protect users from accidental scalding if exposed to hot water only. The temperature of hot water supply should be limited to a predetermined value, for example 45 degrees Celsius. The structure in FIG. 36 may be used to achieve compliance with such safety standards.

FIG. 36 illustrates a system for limiting the maximum temperature of hot water supplied to a house or apartment. It is possible to limit the temperature of the hot water delivered from the tank to a safe value as permitted by standard and/or law. See an embodiment below, with reference to High Flow valves. If the water in the tank itself can be heated to a higher temperature, then the heat capacity is increased, more water may be used before the supply ends. (Of course the temperature may be reduced for economy reasons where less use in to be expected). If the water in the tank is heated to a higher temperature, however, there is the danger of a user's injury, in case of exposure to hot water.

The approach taken in the present invention is to heat the water in the tank 21 to a higher temperature, to increase the heat capacity of the system. At the same time, limiting the maximum temperature of water supplied to the apartment by mixing with cold water, in such a proportion of hot/cold water as to ensure the temperature of hot water to the apartment is kept within safe margins.

The present invention can provide two separate mechanisms for limiting the maximal hot water temperature:

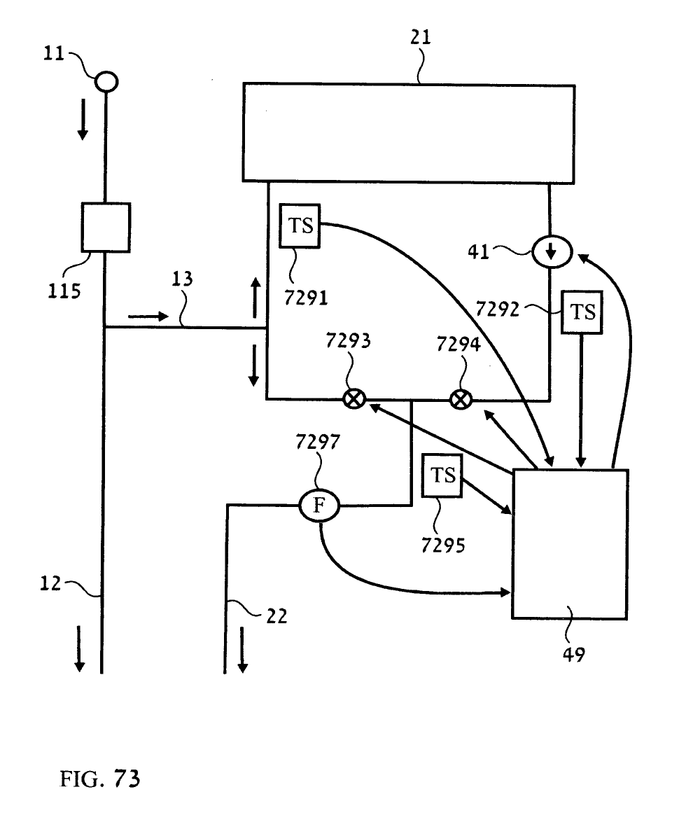

1. near the boiler—mixing hot water with cold, see below for example with reference to FIG. 73.

2. At the faucet—temperature sensors in the faucet will limit the temperature using a reliable, fast sensor and valve control unit.

As illustrated in FIG. 36, the valves 32 and 34 are electrically controlled. The valves 32 and 34 control the rate of flow of cold and hot water, respectively. The temperature of the water, preferably in a mixing chamber, is measured with temperature sensor 452. The valves 32 and 34 are so controlled as to achieve a desired temperature at the output of the system in pipe 22. Pipe 22 is the hot water supply to the apartment. Either a circulating pump 41 in the cold water piping, or a circulating pump 416 in the hot water piping, may be used.

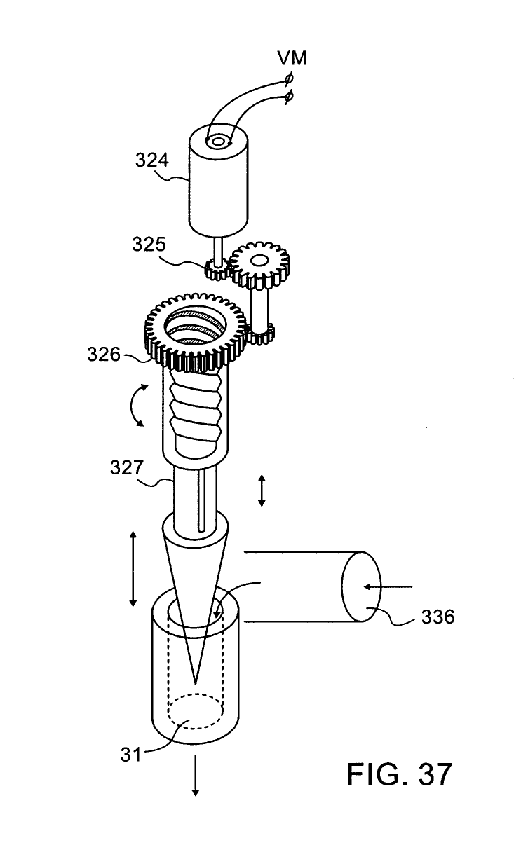

FIG. 37 depicts a valve structure which may be adapted to be used with the system of FIG. 36, for the valves 32 and 34 there. The electrical motor 324 should be insulated from water in the valve and from extreme temperatures of hot water. The transmission means 325 may engage the rotating part with inner thread 326, which converts the motor rotary movement to a linear movement of plunger 327.

A major benefit of a non-contact activation mechanism of faucets and showers is the savings in water and energy which may be achieved by its use. Manually activated faucets and showers take time to adjust to the required values. In prior art systems this was not so important because it took so much time for hot water to arrive, that users were used to, and accepted, slow controls. In the present system, however, hot water is supplied rapidly—it is ready and waiting to flow out the faucet when it is desired by the user. Thus, users are more aware of, and less tolerant to, mechanical obsolete controls having delays in setting the water temperature and flow rate to the desire values.

Thus, this smart interface means with the user is important in, and synergetic with, the present invention and provides a system with quick response to user's demands for water at desired parameters.

There are additional advantages, for example: automatically operated faucets may save water, by automatically closing a faucet which was left open by a user; there is hygienic benefit in users being spared the need to touch the faucet; non-contact reliable means, using a dual sensor unit, may be advantageously used for hot/cold water supply control and programming for future supply. Further, an important aspect of the present faucet is its reliable operation, due to its structure as detailed below.

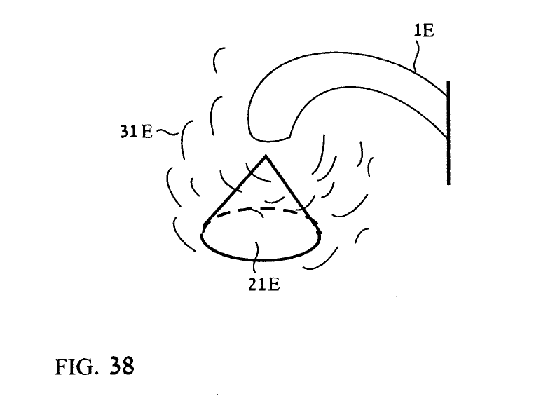

FIG. 38 illustrates a faucet 1E with dual sensor means including capacitive and IR cone sensors, an IR sensor cone 21E is formed under the faucet 1E. Additionally, a capacitive sensor field 31 is formed around the faucet 1E. The capacitive sensor may use any of the presently commercially available such sensors. The readings from both sensors are correlated to enhance the reliability of the automatic activation of the faucet. The IR sensor beam in this embodiment may be easier to implement, such as illustrated in FIG. 3. It may be effective in detecting a request to activate the faucet (turn water ON). However, flowing water may interfere with its operation, and the turn off may also relay on a time delay means.

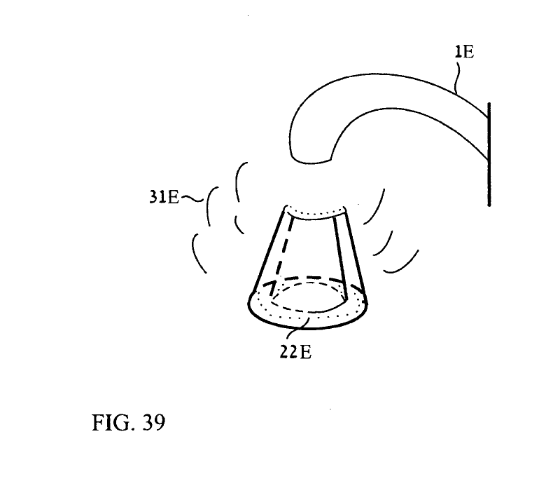

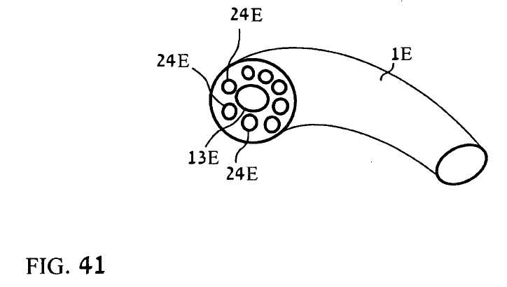

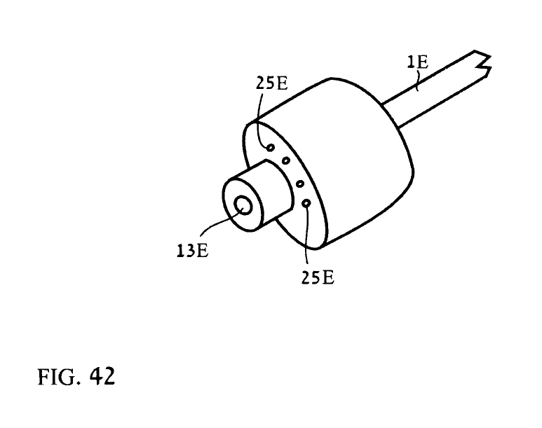

FIG. 39 illustrates a faucet 1E with dual sensor means including a capacitive sensor field 31E around the faucet 1 and an IR sensor hollow cone 22E under the faucet 1E. The IR sensor beam in this embodiment may be somewhat more difficult to implement, such as illustrated in FIGS. 41 and 42. It may be more effective in detecting a request to activate the faucet (turn water ON or OFF). Flowing water may interfere to a lesser extent with its operation.

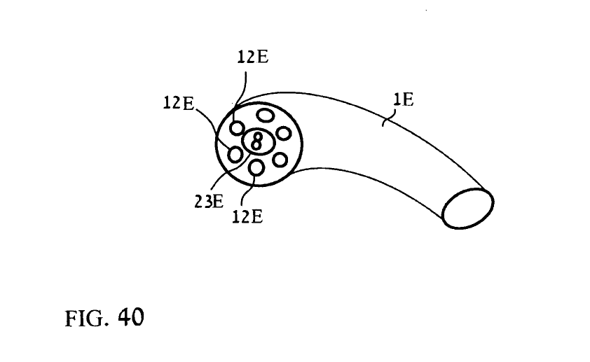

FIG. 40 depicts a pull-out faucet 1E with a central IR sensor 23E. The faucet 1 may have water outlet holes 12E around the sensor 23E, as illustrated.

FIG. 41 depicts a pull-out faucet 1E a peripheral IR sensors array 24E, surrounding the water outlet opening 13E in the faucet 1E.

FIG. 42 depicts a regular faucet 1E with a peripheral IR sensors array. In one embodiment, the IR sensors array may be implemented with an IR sensor array ring 25E as illustrated. The ring 25E may be mounted around the faucet 1E with the outlet opening 13E therein.

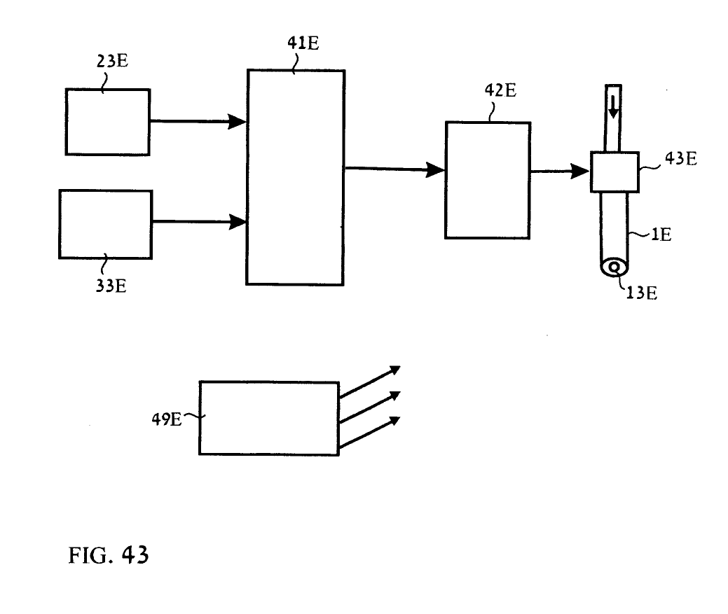

FIG. 43 is a block diagram of a dual sensor automatic faucet. The system includes an IR sensor 23E and a capacitive sensor 33E for detecting a user nearby requesting to open the faucet (turn water ON) or closing it. The controller 41E processes the sensors signals to decide whether to open the faucet or close it. If an activation decision is reached, the controller 41E will activate electro-mechanical means 42E to implement the decision. The electro-mechanical means 42E may include an electrical motor or a solenoid (not shown), for example. Either a DC motor, an AC motor or a stepper motor may be used. The electro-mechanical means 42E will open or close a valve 43E in the faucet 1E, to open or close the faucet for water flow. The valve 43E may either have two positions ON/OFF, or may allow for a variable degree of opening, for a desired flow rate.

Optional additions: For a variable flow rate, the controller 41E may store a programmable parameter indicating the desired flow rate. The user may change the flow rate using programming means as known in the art, for example using an infrared IR communication channel with non-volatile memory means in the controller 41E. Such a controller may be used with the high flow unit detailed elsewhere in the present disclosure. Alternatively, separate sensor means may be used to turn the water ON or OFF and for controlling the flow rate.

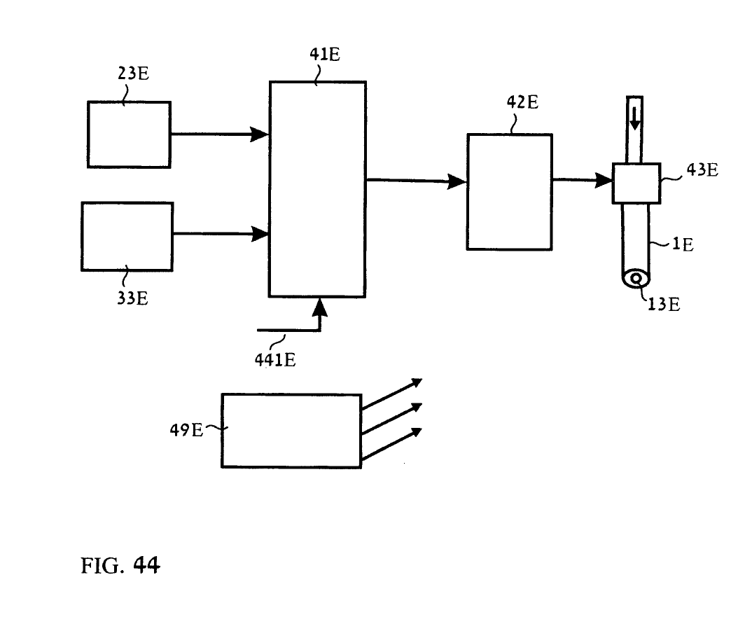

FIG. 44 is a block diagram of a dual sensor automatic faucet with manual override means. The system is similar to that illustrated in FIG. 43 and the related description, with the addition of a manual override input means 441E. The manual override input means 441E may include (not shown) a pair of electrical pushbuttons ON and OFF, connected to the controller 41E. Pushing one of the buttons will indicate a corresponding override command, and the controller 41E will act accordingly to cancel the previous automatic activation. That is, the valve 43E will be turned ON or OFF responsive to the manual pushbutton being pressed. Other embodiments of a manual override may be used. Thus, the manual override feature may be used to cancel an automatic opening or closing of the water at the faucet, in any given situation. An advantage of this embodiment is its simple and low cost implementation.

A possible disadvantage is that, in case of a failure of the controller 41E or the power supply 49E, the manual override will not have effect. A possible solution is to use manual override means, such as a manual valve, to close the water if necessary and/or for automatic adjustments. A manual valve may be installed before the mixer.

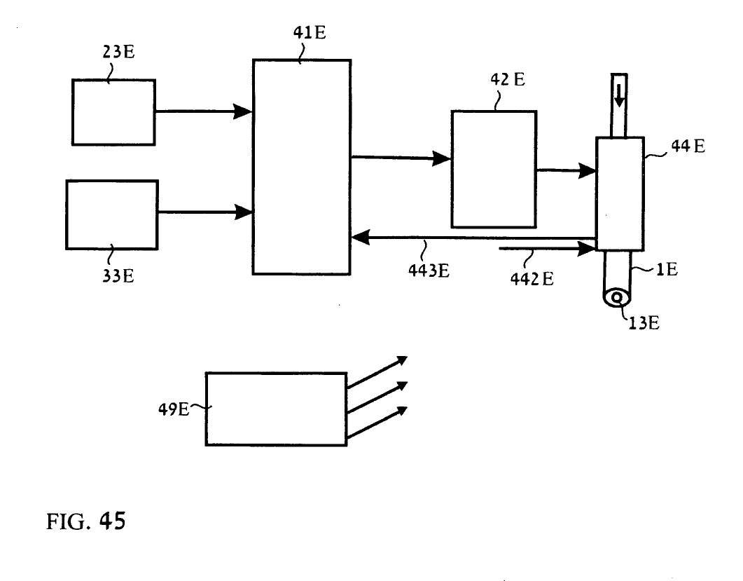

FIG. 45 is a block diagram of another embodiment of a dual sensor automatic faucet 1E with manual override means. Data from the IR sensor 23E and the capacitive sensor 33E are transferred to the controller 41E. According to activation decisions, the controller 41E will activate electro-mechanical means 42E such as an electrical motor. The system includes a dual activation valve 44E, which may be opened or closed by the electro-mechanical means 42E or by the manual override input 442E. In this case, the manual override input 442E will act directly on the valve 44E to open or close it. An advantage of this embodiment is its enhanced reliability—it will operate as required, even in case of a failure of the controller 41E or the power supply 49E.

A possible disadvantage is the more complex structure of the dual valve 44E. Preferably, the system will also include a manual override indication 443E connected from the valve 44E to controller 41E, so the controller 41E will be notified of a manual override. This information may be advantageously used to update the decision parameters and the activation history, as detailed elsewhere in the present disclosure. The signal 443E may be generated for example with a micro-switch installed in the valve 44E, which is activated by the manual override input 442E.

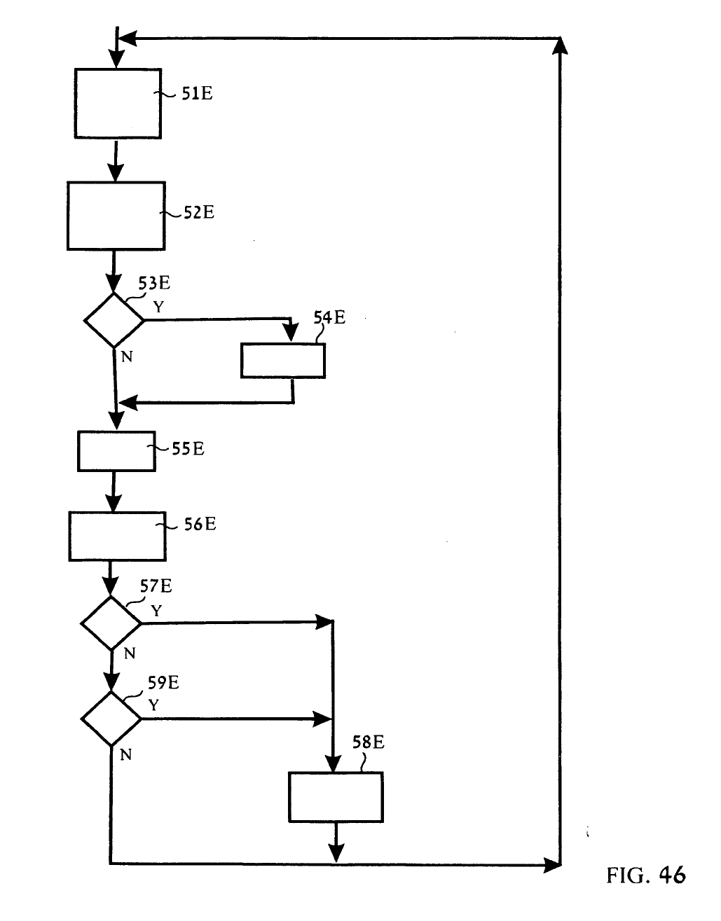

FIG. 46 is a flow chart of the dual sensor automatic faucet with separate ON/OFF criteria, and as detailed below. The automatic faucet activation method includes:

a. read sensors input 51E (dual sensor)—the signals from the two sensors (IR) and capacitive are being read continuously.

b. compute OPEN evaluation with criterion A 52E—the sensors readings will be evaluated according to a predefined algorithm, and using a first criterion A with related parameters.

c. to open valve? 53E if Yes, go to 54E, else go to 55E

d. open valve 54E commands to the electro-mechanical device 42E are issued, to open the water flow.

e. read sensors input 55E (dual sensor). The signals from the two sensors (IR and capacitive) are being read continuously.

f. compute CLOSE evaluation with criterion B 56E

The sensors reading will be evaluated according to a predefined algorithm, and using a second criterion B with different, related parameters.

g. to close valve? 57E, if Yes, go to 58E, else go to 59E

h. close valve 58E; commands to the electro-mechanical device 42E are issued, to close the water flow; go to 51E.

i. timeout? 58E; if Yes, go to 58E, else go to 51E

The optional Timeout feature measures the time since the last activation of water flow (entering ON state) and will close the water after a predetermined time today. For example, the user may set this parameter for 2 minutes or 5 minutes. The benefit of this feature is to save water—a failure to turn the faucet OFF will not cause water to flow indefinitely.

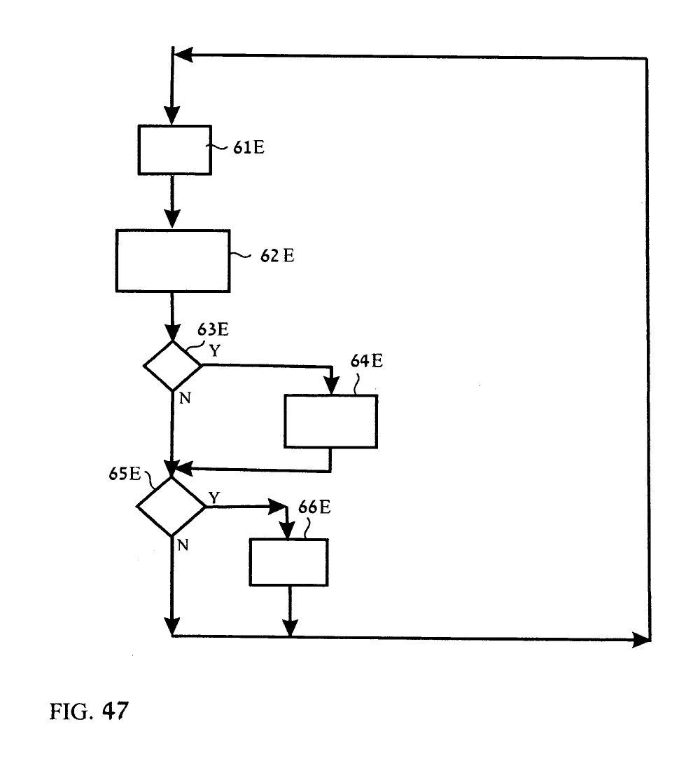

FIG. 47 is a flow chart of an adaptive automatic adaptive faucet with manual override, including:

a. read sensors input 61E (dual sensor)

The signals from the two sensors (IR and capacitive) are being read continuously.

b. compute OPEN/CLOSE evaluation with criterion A/B 62E and programmable parameters. The sensors readings will be evaluated according to a predefined algorithm, and using separate criteria A or B different, related parameters.

c. to open/close valve? 63E; if Yes, go to 64E, else go to 65E (in another embodiment: go to 62E)

d. open/close valve 64E

e. manual override? 65E; if Yes, go to 66e, else go to 61E

Note: the manual override may be activated asynchronously, anytime during the execution of this method.

f. change valve activation 66E; update OPEN/CLOSE parameters;

go to 61E.

Notes on the Faucet Activation Method:

1. Opening and closing the valve may use either symmetric or asymmetric criteria and parameters.

2. Different parameters may be used for opening and closing the valve. The flow of water itself may change the environment and/or the sensors readings, and this effects may be accounted for. It is possible measure, evaluate and/or estimate such effects and take them into account when implementing the above method.

3. Different criteria may be used for opening and closing the valve. For example, opening the valve may require the activation of both the infrared and capacitive sensors; closing the valve may be triggered by only one of the sensors.

Parameters Update Method

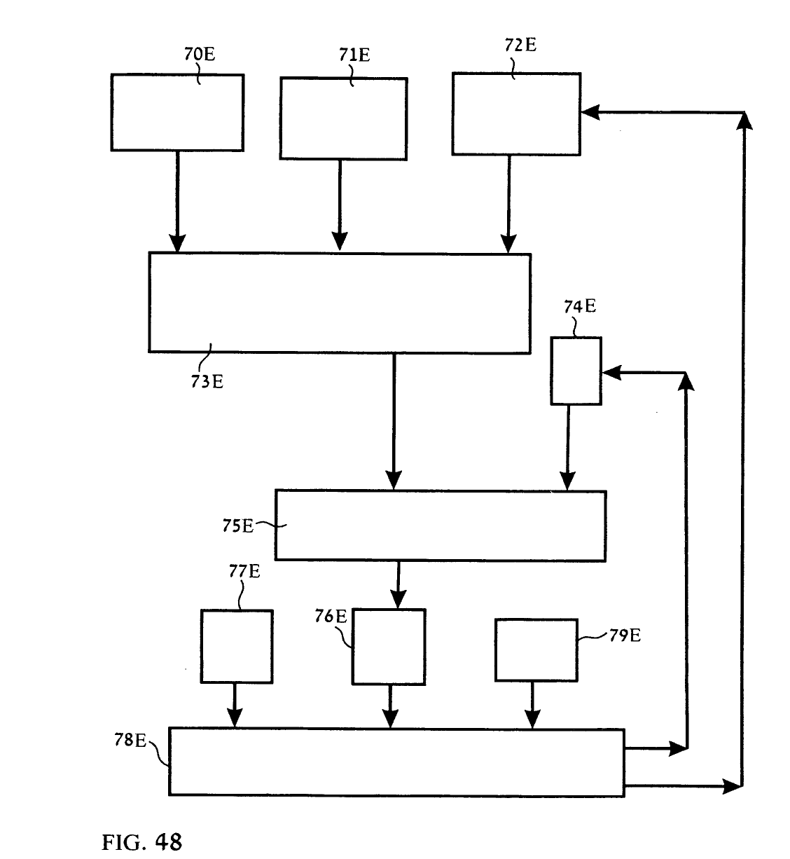

a. A mathematical algorithm may operate on sensors readings for a plurality of occurrences/events. For each event, the correct (activation to ON or OFF, or no activation) is also stored. The Correct Result (CR) is the output after step 65 (FIG. 47) or the output of module 78E (FIG. 48), which also includes the user's override command.

b. A best fit algorithm is implemented, to change the activation parameters or thresholds, to best fit the decision for the whole set of events, to the Correct Results there.

c. The decision parameters are updated to include the best fit parameters found in step (b).

d. Step a-c are repeated to improve the decision parameters of the automatic faucet, as the system gathers experience in the specific environment (each home, and each location therein, may result in a different set of decision parameters for the automatic faucet there).

FIG. 48 is a data flow diagram of an adaptive automatic faucet with a manual override:

a. Data from the capacitive sensor input 70E and the IR sensor input 71E are transferred to the decision to open/close faucet 73E.

b. The decision module 73E also takes into account the sensors evaluation parameters table 72E.

c. The output from decision module 73E, together with data from the faucet activation history table 74E, is transferred to the update decision to open/close faucet module 75E.

d. The result from module 75E is used in the activate faucet (open/close) 76E module.

e. The output from module 76E is processed with the manual override 77E command in the parameters update 78E module. The parameters update 78E activates, if required, updates in the parameters table 72E and the history table 74E.

f. Thus, if there was a manual override, this is an indication to the system that the present activation parameters are not adequate and should be corrected. For example, the decision threshold of one of the sensors (or both) should be increased or reduced. Or maybe more importance (an increased relative weight) should be accorded to one sensor versus the other.

g. The history table 74E may also include data from a time/date module 79E. This may be used to detect patterns of use of the faucet—the system learns the user's habits, and relies on these learned habits to improve the activation decision. For example, a user brushes her teeth night at 22.00. This information is stored in the history table 74E as a reliable habit, which occurred several times. The system will then activate the faucet at about that time every night, even if the sensors data is not so reliable, or below the usual decision threshold.

Optionally, the above system and method may be used to also control the temperature of the water. The user can then automatic control means to both open and close the valve, and to determine the temperature of the water supplied. For example, two outlets may be available, one for cold water and the other for warm water; the user may choose to activate either one of the outlets. In another embodiment, separate control means may be used to control the opening/closing of the water supply, and the temperature of the water.

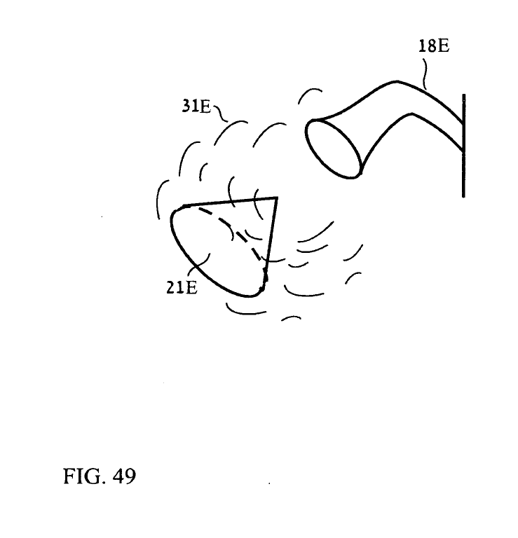

FIG. 49 shows a shower device 18E with dual sensor including capacitive (with electric field 31E) and IR cone (IR sensor cone 21E) sensors. The direction of the IR sensor and the capacitive sensors may be adjusted so as to best detect the presence of a person taking a shower there.

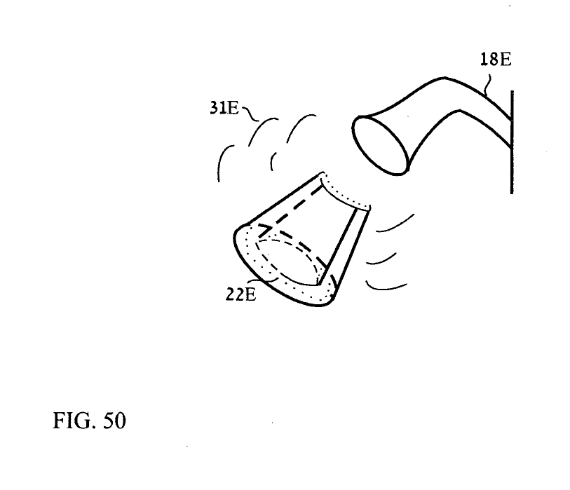

FIG. 50 illustrates a shower device 18E with dual sensor including a capacitive sensor field 31E around the shower device 18 and an IR sensor hollow cone 22E under the shower 18E. The IR sensor beam in this embodiment may be somewhat more difficult to implement, such as illustrated in FIGS. 41 and 42. It may be more effective in detecting a request to activate the faucet (turn water ON or OFF). Flowing water may interfere to a lesser extent with its operation.

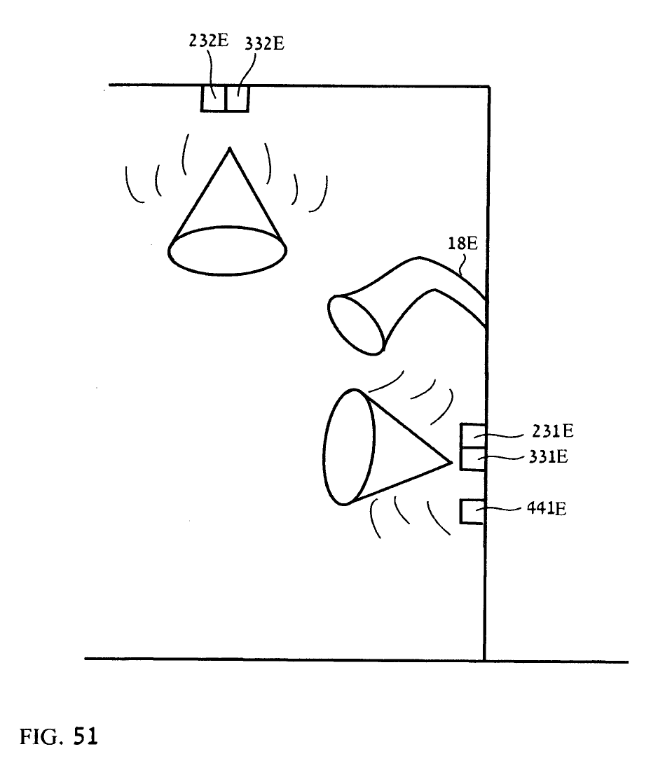

FIG. 51 illustrates a shower system with multiple sensor means including capacitive sensors 331. 332 and IR cone sensors 231E, 232E. These sensors may be installed in various locations to detect the presence of adults and children reliably. A manual override control 441E may be used to turn the water on and off while the person is taking a shower, as the need be.

Automatic Shower Activation Method

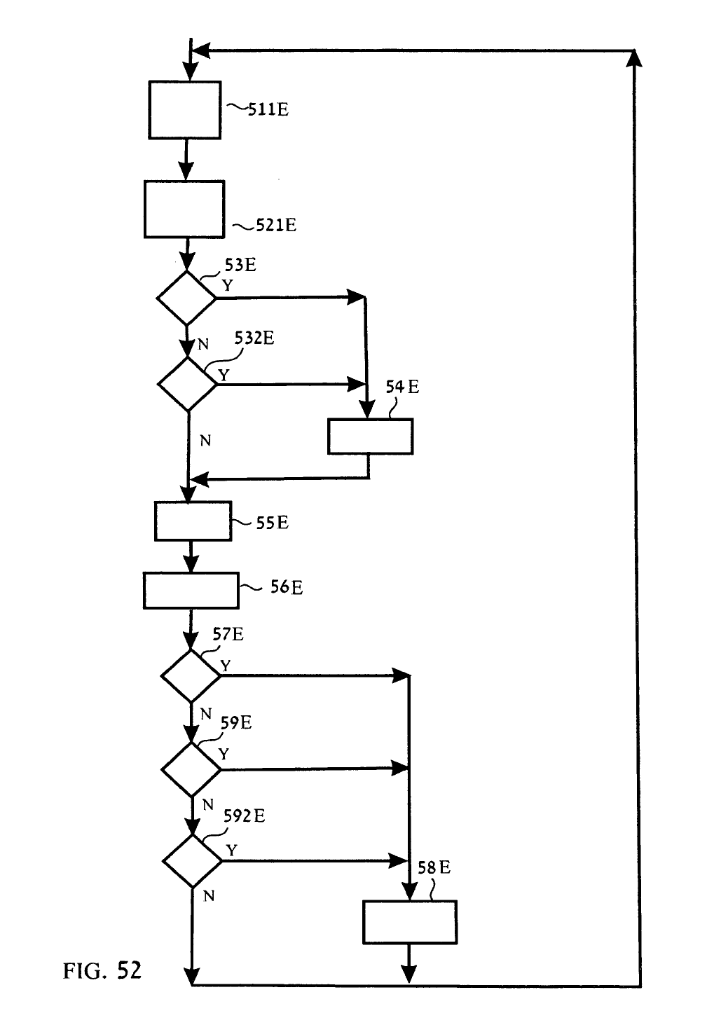

FIG. 52 is a flow chart of a dual/multiple sensor faucet with separate ON/OFF criteria and manual override, including:

a. read sensors input 511E

(dual or multiple sensor)

The signals from the two sensors (IR and capacitive) are being read continuously.

b. compute OPEN evaluation with criterion A 521E

The sensors readings will be evaluated according to a predefined algorithm, and using a first criterion A with related parameters.

c. to open valve? 53E

if Yes, go to 54E, else go to c2E

c2. to open valve (manual command)? 532E

if Yes, go to 54E, else go to 55E

d. open valve 54E, commands to the electro-mechanical device 42E are issued, to open the water flow.

e. read sensors input 55E (dual sensor); The signals from the two sensors (IR and capacitive) are being read continuously.

f. compute CLOSE evaluation with criterion B 56E

The sensors readings will be evaluated according to a predefined algorithm, and using a second criterion B with different, related parameters.

g. to close valve? 57E, if Yes, go to 58E, else go to h

h. close valve 58E, commands to the electro-mechanical device 42E are issued, to close the water flow; go to 51E.

i. timeout? 59E, if Yes, go to 58E, else go to i2

The optional Timeout feature the time since activation of water flow (entering ON state) and will close the water after a predetermined time delay. For example, the user may set this parameter for 2 minutes or 5 minutes.

i2. to close valve (manual command)? 592E

if Yes, go to 58E, else go to 59E

In other possible embodiments, more sensors may be used processed to further enhance a decision to turn the faucet ON or OFF.

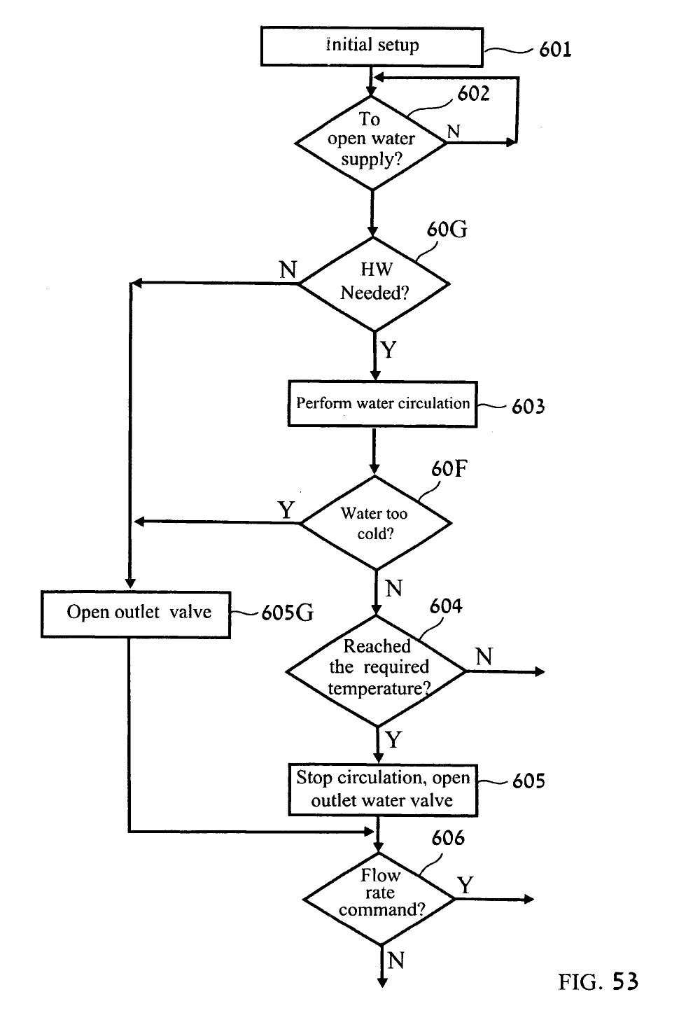

FIG. 53 illustrates a user interface method with hot water indication

Initial setup 601

default temperature, flow rate, water quantity or activation time to open water supply? 602

is hot water HW needed?

The system also checks whether the hot water temperature at that user's faucet (the user demanding hot water) is too cold. Maybe there is already hot water available there, possibly from a previous activation, in which case circulation may not be necessary at all.

Perform water circulation 603

Water too cold? 60 F if water in tank is too cold, it will not help to perform circulation, therefore this step is omitted

A short time after starting circulation (on the order of 2 seconds) the control unit may ascertain that indeed there are hot water in the boiler, so hot water may reach the desired location after some time; if there are no hot water in the boiler, circulation will not help and need not be done.

Rather, the user may be informed that hot water is regrettably not available right now. This may save water and energy and may leave the user less irritated, considering the circumstances.

open outlet valve 605G

reached the required temperature? 604

stop circulation 605

open outlet water valve

flow rate command? 606

the rest of the control method is as detailed elsewhere in the present disclosure, see for example FIG. 6 and related description.

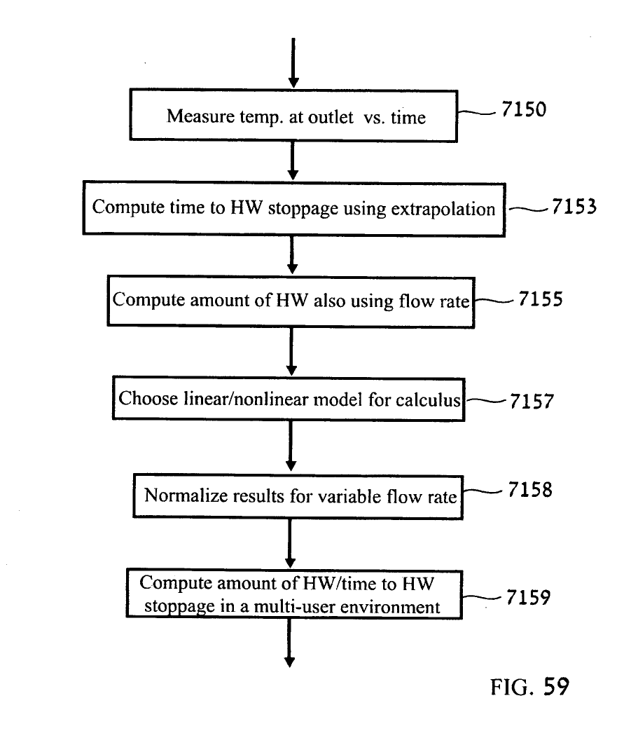

FIG. 59 depicts a Method for estimating the amount of remaining hot water in the boiler.

Measure temp. At outlet vs. Time 7150

compute time to HW stoppage using extrapolation 7153

compute amount of HW also using flow rate 7155

choose linear/nonlinear model for calculus 7157

normalize results for variable flow rate 7158

Compute amount of HW/time to HW stoppage in a

multi-user environment 7159

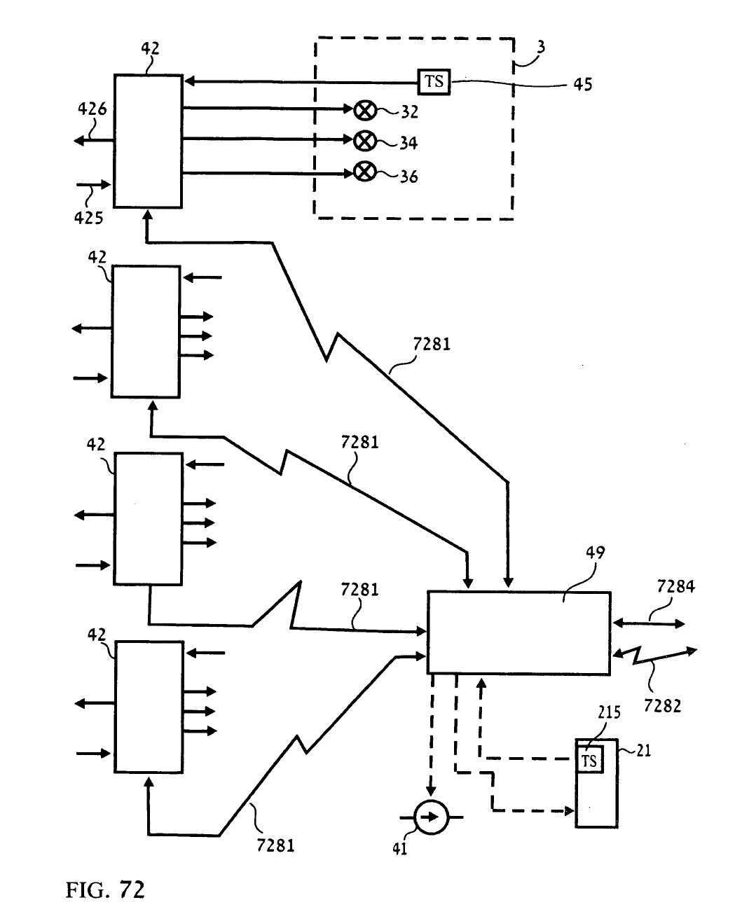

FIG. 72 is a block diagram of the present water control system illustrating two aspects of the invention:

1. a wirelessly connected system in the house

2. service using a remote center for diagnostics and monitoring

The above features may be used, separately or together, with the other aspects of the present invention.

The system includes the components 41, 42, 3 as detailed elsewhere in the present application, and in addition: wireless connections in the house 7281; wireless connection to remote center 7282; wired connection to remote center 7284, e.g. the Internet.

Benefits of the present system include, among others:

1. a wirelessly connected system in the house
easy, fast, low cost installation of the system; no wiring installation is required.
the wireless links may be used for commands transfer as well as the transfer of information, data, various signals.
identification preamble may be used to identify signals in each house or apartment in a multi-user environment, and prevent interference.

2. service using a remote center for diagnostics and monitoring
the operation of the system may be monitored from a maintenance center, using for example a computer running a suitable multi-user monitoring program.
valves and various other devices may be activated from a maintenance center as required for maintenance purposes.
faults can be immediately detected and located. Maintenance personnel may be dispatched to correct the problem. If necessary, that person may already bring along the required replacement parts and/or test equipment, according to the nature of the problem there.

This may achieve a more effective, faster and lower cost maintenance support. Such a support is important if people are to use smart, advanced technology systems where faults may be more difficult to detect and locate using conventional low-tech techniques.

FIG. 73 depicts a hot/cold water mains subsystem which may be used for example with the hot/cold water of FIG. 2. The addition here includes means for protection from scalding, by limiting the temperature of hot water to the house or apartment to that required by the standard in force. An integrated control unit may include the controller 49, communication means, the circulation pump 41 and optional valves 7293 and 7294, and optionally the temperature sensors 7291, 7292, 7295, all in one unit which can be installed in close proximity to the water boiler 21 for example.

The system limits the temperature of the hot water delivered to the users through pipe 22, using the following structure. The circulation pump 41 is installed, in this embodiment, in the hot water outlet from boiler 21. The temperature sensors (TS) 7291, 7292, 7295 measure the water temperature at several important locations, as indicated: inlet to boiler, outlet from boiler and hot water supply to the apartment, respectively.

According to the measured temperatures and with the aim of limiting the temperature of the hot water delivered to the apartment, the controller or computer 49 controls the computer-controlled valves 7293, 7294. This may be advantageously used to limit the hot water temperature to the house to that permitted by relevant standard. Preferably, the valves 7293, 7294 are capable of high flow rates and a wide dynamic range. Such valves are detailed below.

Another use of the system in FIG. 73 is to measure or estimate the amount of hot water in the boiler 21 by performing a local circulation. To achieve this effect, the valves 7293, 7294 are opened and the circulation pump 41 is activated, to circulate water directly back into the boiler 21 (from the hot water outlet to pump 41, thence to valve 7294, valve 7293 and back to the boiler 21 through cold water inlet). The temperature of the water is measured during this process; knowing the flow rate as set by the pump 41, the temperature profile (the measured temperature vs. time) may be used to compute the amount of hot water in the boiler 21.

A possible problem in the system and method is that, during the circulation and measurement session as detailed above, one or more users may desire to use hot water; then part of the hot water out of the boiler are not circulated back but are delivered to these users. A possible solution may use a flow meter 7297 to measure the amount of hot water detected from the boiler; the amount of hot water in the boiler can then be computed or estimated, taking data into consideration.

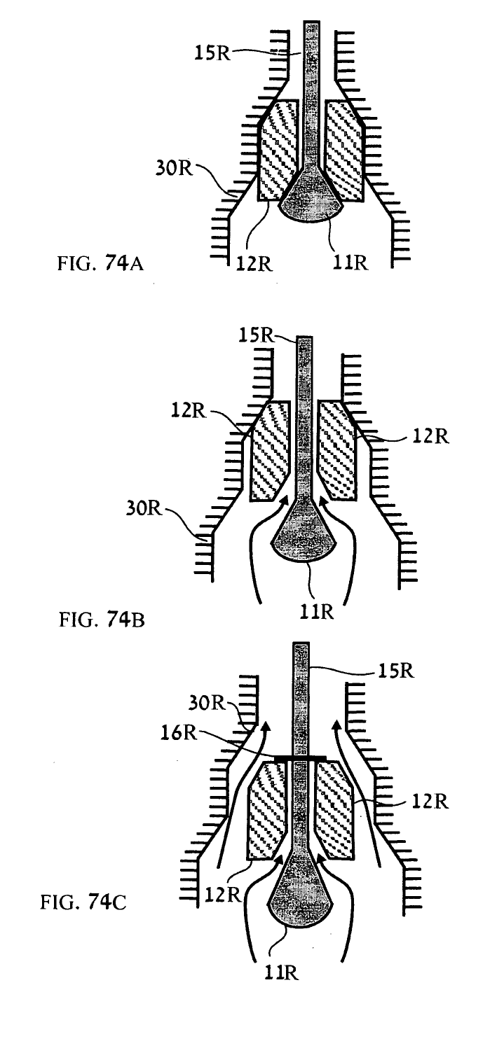

FIGS. 74A-74C show a high-flow large dynamic range valve device having two plungers within a faucet housing 30R. The water flows upwards and the two movable plungers 11R, 12R are controlling the size of the water flow area. By changing the water flow open area, the rate of water provided is controlled.

FIG. 74A depicts the high flow valve device (i.e. for a faucet) with the valve closed, where the two plungers block water flow. A low flow plunger 11R can be opened by moving its bar 15R towards the inlet (downwards, in the drawing as illustrated) and allowing water to flow, as shown in FIG. 74B. As a result of gradual movement of the low flow plunger 11R, the supply of low water flow can be controlled be the size of the small opened area between the two plungers. When the bar 15R is further moved toward the inlet (downwards in the figure as illustrated) as shown in FIG. 74C, a large open area is created, as a result of the movement of a high flow (HF) plunger 12R. A stop 16R prevents the HF plunger 12R from moving away from the inlet (up in the drawing). Thus by moving the bar 15R downwards, the open area between the HF plunger and the faucet hosing becomes larger, and the high water supply in controlled.

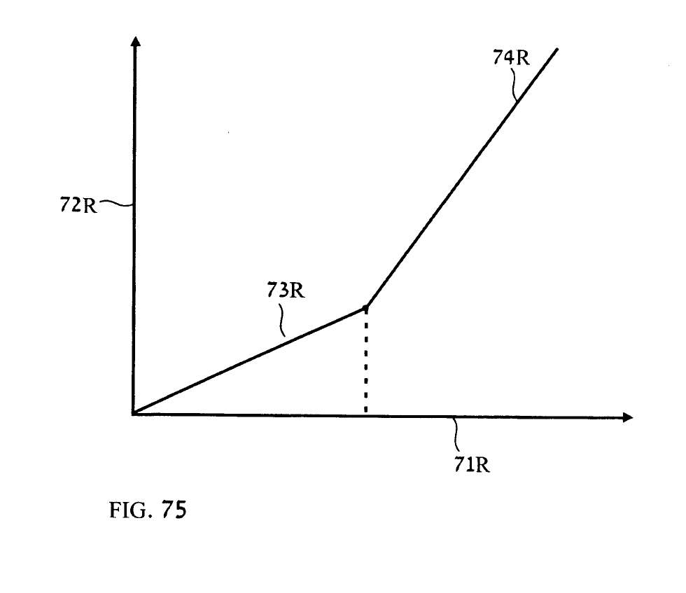

FIG. 75 illustrates controlling liquid flow rate be a valve device. Liquid flow rate 72R is a function of liquid flow area, which can be determined by an opening angle 71R set. For example, in an embodiment equivalent to that described in FIGS. 1A-1C, for a small opening area 73R, where only the LF plunger is moved, a small water flow supply can be set. After the HF plunger is moved to 74R, a larger opening area is made and higher water flow supply can be set. Thus, using a device such as the high flow faucet valve having two plungers, the dynamic range of the controlled flow can be effectively controlled, for both low flow 73R and high flow 74R ranges.

In addition, it may be possible to use more than two ranges, such as three, four or five ranges. This can be implemented, for example, by using three, four or five plungers respectively, one within each other, inside a faucet housing. The opening angle 71R, can be determined, for example by an electric stepper motor. In each of possibly additional range of the graph in FIG. 75, the slope would be higher—as a result of using the additional plungers, each controlling a bigger flow area difference as a function of the bar's (or motor, etc) movement.

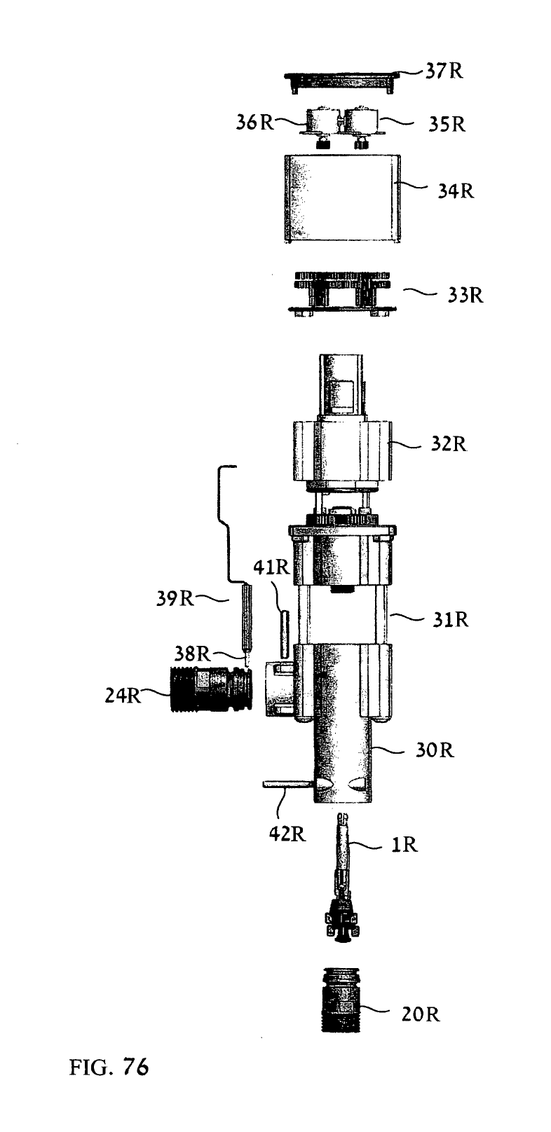

FIG. 76 depicts an exploded side view of a valve system. The device includes two plungers 1R (one in front of the other), for effectively controlling the ratio of hot and cold water, as well as the total water supply provided through an outlet 24R, which can be adapted to a certain type of pipe or spout. Two inlets 20R, one for each plunger, provide hot and cold water. The plungers 1R can vertically slide within the faucet housing 30R, in order to control the amount of water entered from each inlet 20R. Dowels 41R, 42R secure pipe components connected to the faucet hosing. Two electric motors 35R, 36R, such as stepper or DC motors, control each of the plungers through a gear 33R. The gear 33R is connected to worm wheels and sliders, placed within a worm wheels casing 32R and slider casing 31R, respectively. There is a pair of worm wheels and a pair of sliders—for each of the plungers. A cover 37R keeps the plunger device closed and protected. A temperature sensor 38R is integrated at the faucet housing near the outlet 24R, for measuring the temperature of the water flowing out. The temperature reading is provided through temperature sensor's wiring 39R, for controlling the motors accordingly, and setting the water temperature by an electronic controller.

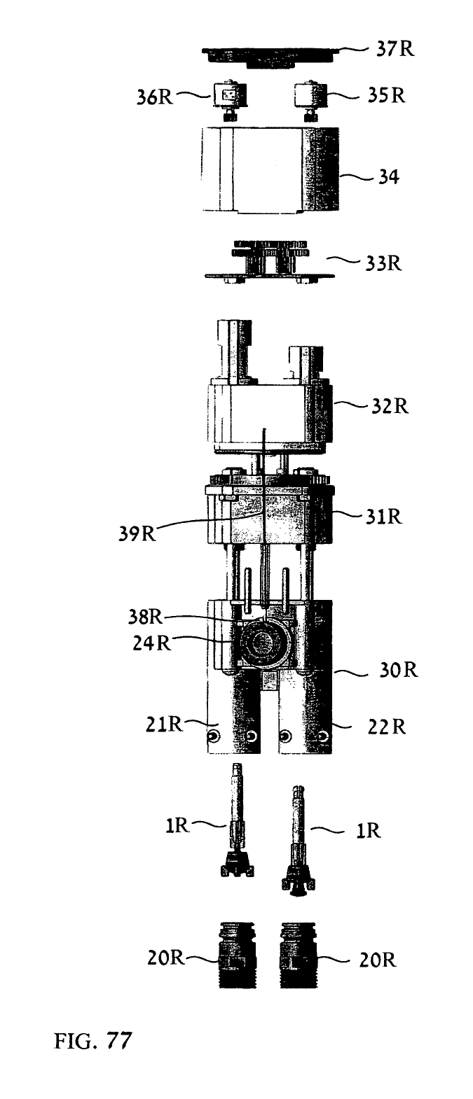

FIG. 77 depicts an exploded front view of a valve system. The two plungers can be placed one next to each other, each with its matching mechanism above it, which connects it to a motor. Each of the plungers can be placed at a different height—for setting the water supply provided. The device is preferably symmetrical, with one controller, which sets the position of each of them.

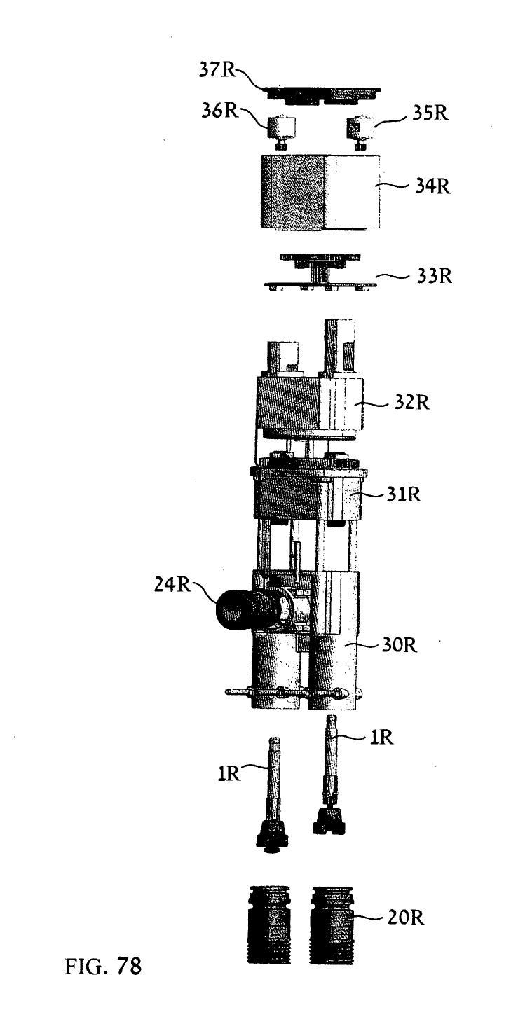

FIG. 78 depicts an exploded isometric view of a plunger device. The device includes two adjacent motors 35R, 36R, each controlling one of the plungers 1R through the gear 33R, a worm wheel and a slider, placed one above each other. The plungers 1R are symmetric, each placed within one housing 21R, 22R of the faucet housing 30R.

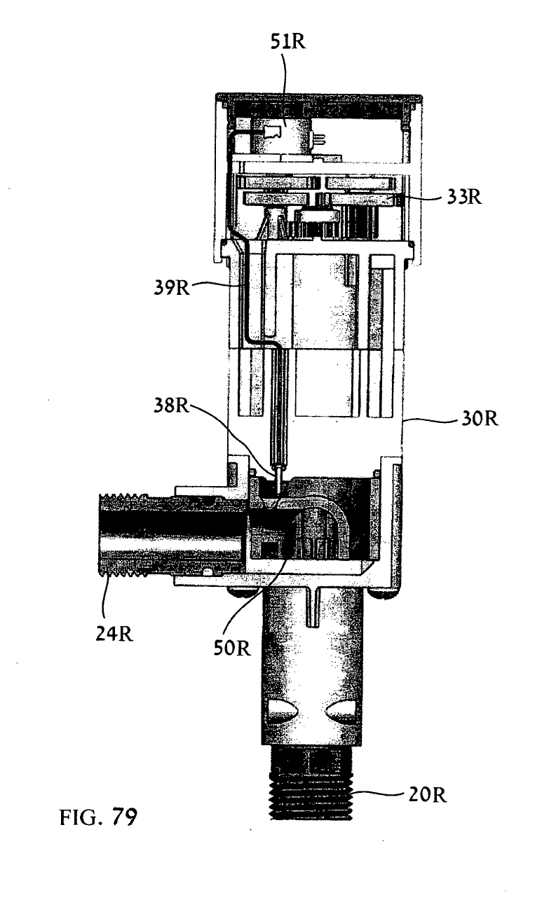

FIG. 79 shows the hot and cold water provided are mixed within a mixing chamber 50R, for effectively measuring the water's temperature by the temperature sensor 38R. The temperature reading provided by; the wiring 39R to a controller 51R, which can control the motors and/or the gear 33R, for moving the plungers 1R and thus changing water temperature and/or water supply rate. The fitting between the mixing chamber 50R and the outlet pipe or spout 24R, can be of different diameter, this may also be effective for mixing the hot and cold water provided. The controller 51R may comprise an electronic circuit, a chip a microcontroller and/or any other logic. The controller receives commands from external source, such as for the amount and temperature of the water supply, controls the engines and reads the temperature for complying with these demands.

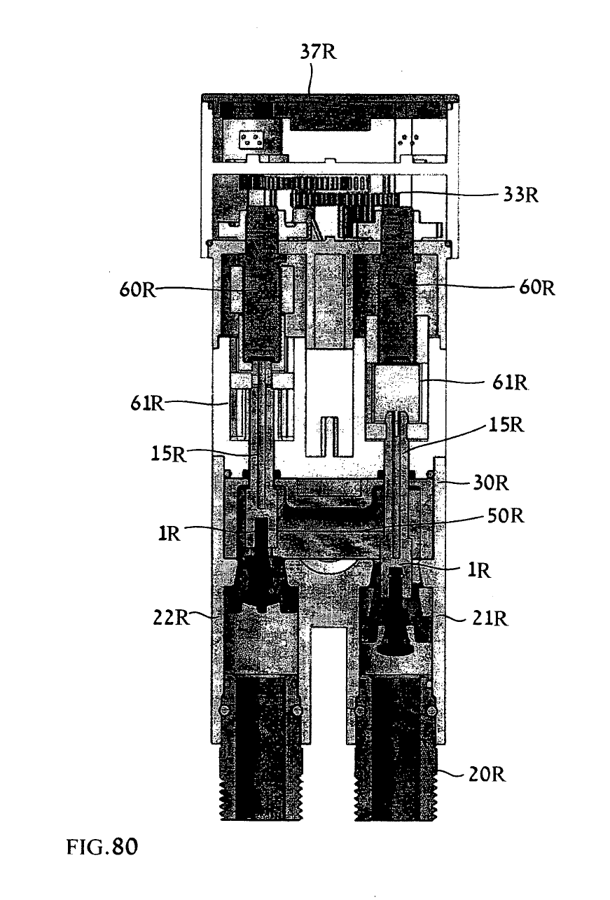

FIG. 80 shows a cross-sectional rear view of a valve system. The hot and cold water provided flow into the mixing chamber 50R. The internal top of the housings 21R, 22R may be cone-shaped to match the plunger 1R. As the plunger 1R is at the top, such as in housing 22R, the inlet is sealed and no water can enter. When the plunger 1R is at a lower position, such as in housing 21R, the inlet is gradually opened, and more water can flow.

The motors' and gears' rotational movement is converted to vertical movement by worm wheels 60R which rotate and move their sliders 61R upwards and downwards by their threads. Each slider is connected to one of the bars 15R of the plungers 1R. Thus, for example as the right worm wheel 60R is turned to a first direction, the right slider together with the right plunger are moved down wards and vice-versa. The same applies to the left worm wheel. Thus the vertical position of each plunger can be set and secured by its motor. The various components which are immersed or touch water can be isolated using O-rings.

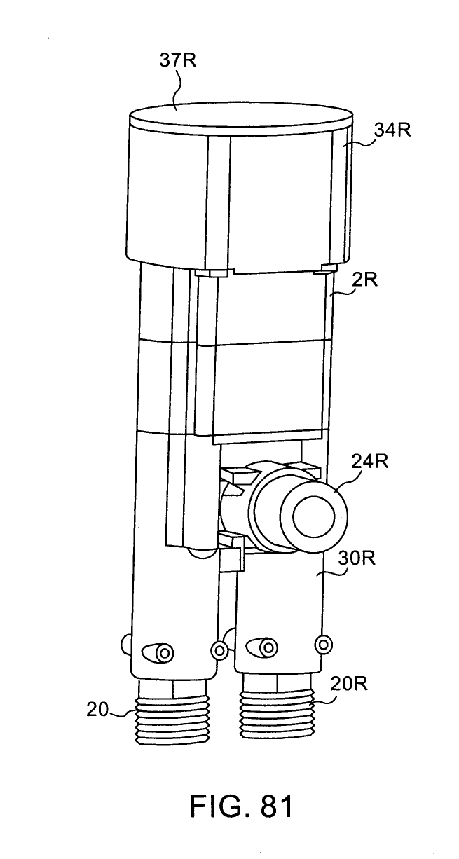

FIG. 81 shows an isometric view of valve system 2R. The device is preferably completely closed. In one embodiment the water are provided from the outlets placed below and provided by t perpendicular outlet 24R. Other embodiments of the device can be implemented, so that the outlet can be in other angle or pointing to another direction. A spout can be directly connected, thus providing a water supply of an accurate temperate with large dynamic range of supply rate. The device should be connected to an electric power source, such as through a socket (not shown) and through the same or additional socket to a control source—for selecting the water flow and temperature by an external source.

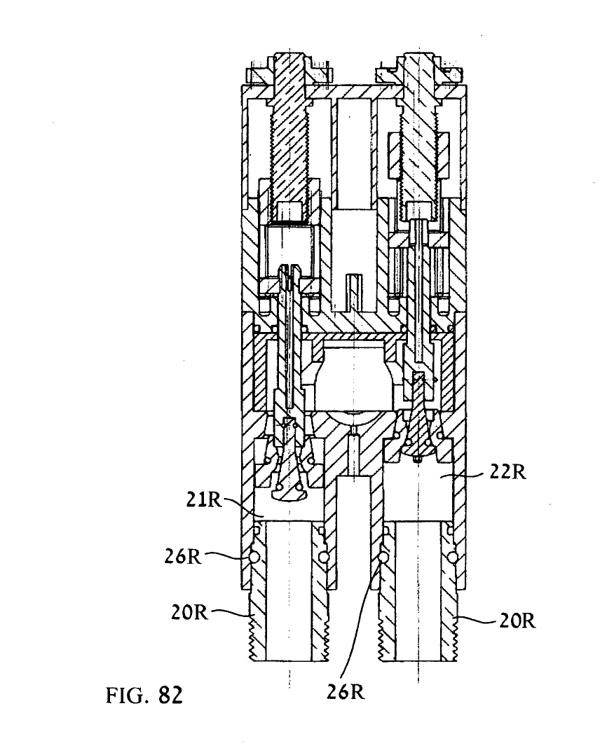

FIG. 82 depicts a cross-sectional front view of a valve system. O-rings 26R are placed between the pipes 20R and the fitting housings 21R, 22R for water isolation.

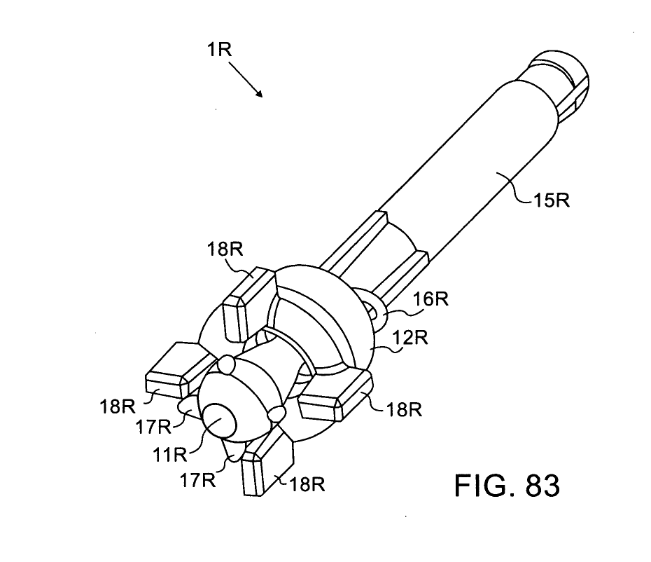

FIG. 83 depicts an isometric view of a plunger. The plunger 1 comprises a low flow (LF) plunger 11R and the high flow (HF) plunger 12R. The LF plunger placed within the HF plunger and includes the bar 15R. When the LF plunger is pulled upwards, the area between the two plungers is sealed and no water may flow there between. The LF plunger is such shaped that as it is moved downwards, the area between the two plungers becomes bigger and thus liquid flow upwards is increased.

When reaching a certain range, based on shape and setup of the plungers, the HF plungers, the HF plunger is moved downwards together with the LF plunger and the bar 15R. Then additional flow area is opened between the HF plunger and the faucet and the faucet housing which surrounds the plunger. Thus, the faucet housing is such shaped that it is wider towards the bottom—to allow setting higher flow rate as a result of a bigger open area, which the plunger less blocks as it is moved downwards. The faucet housing is narrower at its top, such as cone-shaped to fit the shape of the HF plunger when and block liquid when the HF plunger is placed at top, and gradually allow flow supply at higher supply rates, as it moved downwards.

The LF plunger may include blades 17R, such as the four symmetrical blades shown, enabling the LF plunger to move vertically into the HF plunger as it is pulled upwards by the bar 15R. The HF plunger may similarly include blades 18R, for vertically stabling it within the faucet housing. A stop 16R sets the place in which the bar would pull the HF plunger as it is moved downwards. The plunger and/or the faucet housing may be shaped in any other manner, such as to allow gradual increase in water supply as a function of the movement of the bar 15R. This can be similar to the graph with reference to FIG. 75, so that water flow is linear in each rage; or it can have any other form—such as to allowing more liquid in with smaller movement of the plungers. The faucet housing, may have a constant internal diameter in all of its length except for on its top where the plunger fits.

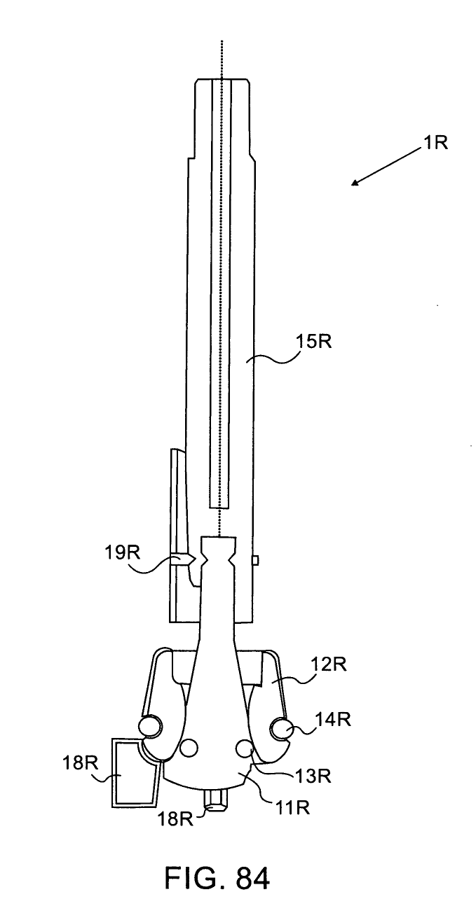

FIG. 84 shows LF plunger 11R connected to the bar 15R with a connector 19R. The LF plunger includes an O-ring 13R for isolating water between the LF plunger and the HF plunger when the LF plunger is at its upper position. The HF plunger 12R includes an O-ring 14R for isolating water between the HF plunger and the faucet housing when the HF plunger is at its upper position. The HF plunger may be such shaped that it has a recess on its top, into which the bar 15R may fit, as it moves downwards. This allows both better securing the bar to the HF plunger and better securing the HF plunger to the faucet housing by its blades 18R. The water may continue to flow between the two plungers, as the bar 15R may be C+I shaped or may be plate (from top view), so that water may flow all around it, and it does not capture much of the flowing area. In this figure the LF plunger (together with the HF plunger and the bar) is shown in its upper position, thus no flow is possible.

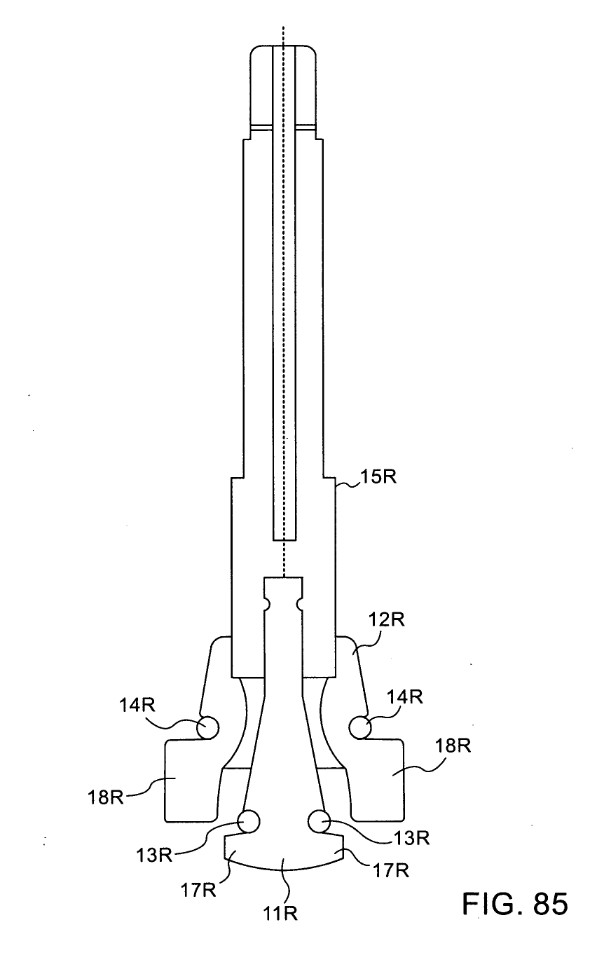

FIG. 85 is a cross-sectional side view of a plunger. In this figure the LF plunger is shown in a lowered position, thus a flow is possible between the LF plunger 11R and the HF plunger 12R, in addition the bar may move the HF plunger 12R downwards as well and then an additional flow is made between the HF plunger 12R and the faucet housing. The bar 15R secured within the HF plunger at its top recess. This embodiment allows implementing an effective faucet, which is compatible both for low and high flows, and can be controlled by vertical movement of one bar.

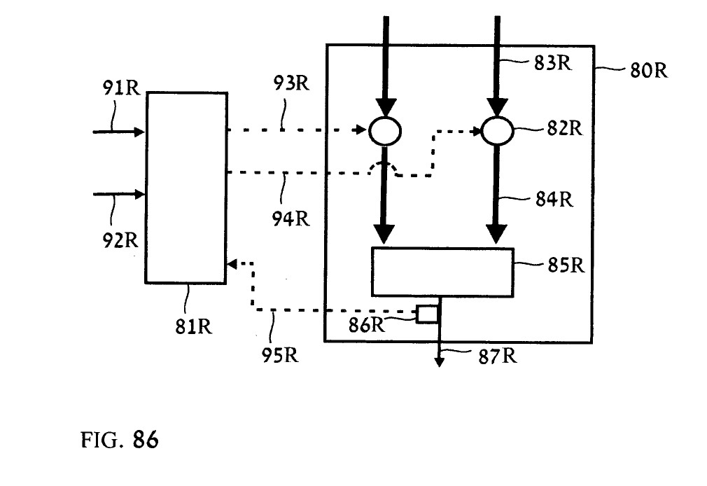

FIG. 86 is a block diagram of a high flow valve system with external controller 81R. A high flow faucet valve assembly 80R, may be similar to the high flow faucet valve described hereinbefore and/or may include two high flow faucets 82R, each compatible for supplying both high and low flows, such as using the plungers described. This high flow faucet valve assembly 80R, however, need not include the controller within. This may reduce costs and further simplify Implementation. The faucet assembly 80R has two water inlets 83R for hot and cold water, a water outlet 87R providing the water based on setup, and wirings. Each of the faucets 82R may be controlled by a separate motor, which is controlled through its wiring 93R or 94R. A temperature sensor 86R may include ADC and provide a digital or analog reading of the water temperature to the controller 81R, through wiring 25R.

The controller 81R receives commands or may read a mechanic setup of one more handles. For example, it may receive commands over wirings of desired water temperature 91R and water supply rate 92R. The controller 81R may comprise a microcontroller and/or may be implemented using any circuit, etc. The controller may also include digital memory, for saving commands, readings and current faucets' state.

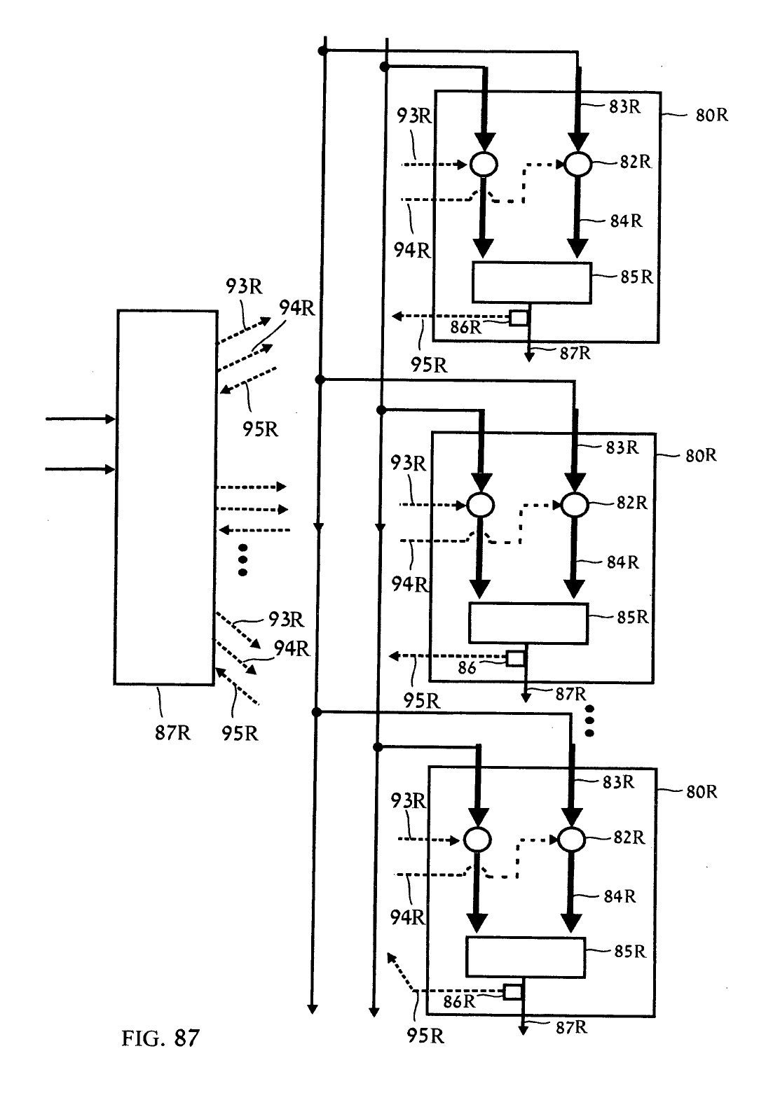

FIG. 87 is a block diagram of high flow valve system with external controller 81R. In this embodiment, the controller 81R may be similar to that described in FIG. 86, however it may support more than one faucet valve assembly 80R. Each of the faucets 82R within the high flow faucet valve assembly 80R can be connected to mail cold and hot water pipes 97R and 98R, respectively.

The controller 81R receives commands or may read a mechanic setup of one or more handles. For example, it may receive commands over several wirings of desired water temperatures 91R and the water supply rates 92R. The controller 81R may comprise a microcontroller and/or may be implemented using any circuit, etc. The controller may also include digital memory, for saving commands, readings and current faucet' state. The controller may receive digital and/or analog commands, and may read digital and/or analog measurements of water temperatures. The controller may have multiplexing means for separately reading and controlling each of the faucets, or it may control them in parallel, simultaneously. Each of the wirings 91R-95R may either be separate wirings of a bus of wires. Thus, all input and/or output commands may be provided over one or more common buses, for simplifying connection.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for supplying hot and cold water to users in a building, the system comprising:
a first mode for supplying water to users;
a second mode for preparing to supply water at a desired temperature by recycling water from the hot water pipe into the cold pipe;
a faucet having a mixing chamber;
a hot water inlet;
a cold water inlet;
an outlet; and
a mechanism for adapting the system to various types of users including humans and appliances.

2. The system according to claim 1, further including an adaptive system with means for learning users' habits, to anticipate the need for hot water and act accordingly to heat water in advance and bring hot water to users' faucet while circulation water into the cold water pipe.

3. The system according to claim 1, wherein said appliances include washing machines and dishwashers.

4. The system according to claim 1, further including a temperature sensor located in the mixing chamber in the faucet, to measure the temperature of the output water.

5. The system according to claim 1, further including a temperature sensor located at the hot water inlet.

6. The system according to claim 1, further including two temperature sensors, one located at the hot water inlet and the other at the cold water inlet.

7. The system according to claim 1, further including a temperature sensor in the mixing chamber.

8. The system according to claim 1, further including three temperature sensors, one located at the mixing chamber, one at the hot water inlet and one at the cold water inlet.

9. The system according to claim 3, wherein the temperature sensor comprises a solid state semiconductor sensor.

10. The system according to claim 4, wherein the appliance includes a local circulation pump.

11. The system according to claim 4, further including three electronically activated valves.

12. The system according to claim 4, further including a hot/cold water controller and programming using non-contact reliable means, using a dual sensor unit.

13. The system according to claim 12, further including an electronic interface between the hot/cold water controller and various appliances which need cold and/or hot water, and at a specific temperature.

14. The system according to claim 12, further including means for inputting commands from a user and for activating the appliance at a required temperature of water supply.

15. The system according to claim 12, further including means for requesting hot water at a required temperature responsive to received commands from a user.

16. The system according to claim 12, further including separate hot and cold water inlets for the appliance and a circulation valve between and hot and cold water inlets, and means for activating the valves responsive to received commands from a user.

17. The system according to claim 12, further including a system control for diagnostics for maintenance purposes including means for activating each valve and monitoring the status and performance of each valve.

18. The system according to claim 17, further including means for performing diagnostics under remote control and reporting to a remote location.
